(19) United States
(12) Patent Application Publication
(10) Pub. No.: US 2017/0269285 A1
(43) Pub. Date: Sep. 21, 2017

(54) ILLUMINATION DEVICE AND DISPLAY DEVICE

(71) Applicant: Sharp Kabushiki Kaisha, Osaka (JP)

(72) Inventors: Yoshinobu HIRAYAMA, Osaka (JP); Takao IMAOKU, Osaka (JP); Takeshi ISHIDA, Osaka (JP); Ryuzo YUKI, Osaka (JP); Shugo YAGI, Yonago-shi, Tottori (JP)

(73) Assignee: Sharp Kabushiki Kaisha, Osaka (JP)

(21) Appl. No.: 15/327,761

(22) PCT Filed: Jul. 22, 2015
(86) PCT No.: PCT/JP2015/070777

§ 371 Date: Jun. 2, 2017

(30) Foreign Application Priority Data
Jul. 29, 2014 (JP) 2014-153977

(51) Int. Cl. F21V 8/00

(52) U.S. Cl. CPC G02B 6/0061; G02B 6/0055; G02B 6/0038; G02B 6/0036; G02B 6/0053

(57) ABSTRACT

A backlight device includes: LEDs; a light guide plate that has a light-receiving face, a light-exiting surface, and an opposite surface; a reflective sheet disposed so as to face the opposite surface of the light guide plate; and an exiting-light reflecting part that facilitates the emission of light from the light-exiting surface by reflecting light that propagates within the light guide plate, and that is disposed on the light-exiting surface side of the light guide plate. The exiting-light reflecting part is formed of a reflective unit disposed in plurality with gaps therebetween along a first direction, which is along a pair of end faces that are among the peripheral end faces of the light guide plate, are on opposite sides of the light guide plate, and do not include the light-receiving face. The reflective unit extends along a second direction, which is along a pair of end faces that are among the peripheral end faces of the light guide plate and that include the light-receiving face.

### TECHNICAL FIELD

The present invention relates to an illumination device and a display device.

### BACKGROUND ART

In recent years, flat display panels such as liquid crystal panels and plasma display panels have been increasingly used as display elements for image display devices such as television receivers instead of conventional cathode-ray tubes, allowing for image display devices to be made thinner. In liquid crystal display devices, a liquid crystal panel used therein does not emit light, and therefore, it is necessary to separately provide a backlight device as an illumination device. Backlight devices are largely categorized into a direct-lit type and an edge-lit type, depending on the mechanism thereof. Edge-lit backlight devices include a light guide plate that guides light from a light source disposed along an edge thereof and an optical member that provides uniformly planar light to a liquid crystal panel by imparting an optical effect on light from the light guide plate. A well-known example of such a device is disclosed in Patent Document 1 mentioned below. In Patent Document 1, the light guide plate is caused to have a light-condensing effect as a result of a plurality of lens-shaped ridges being arranged in a row on a light-exiting surface of the light guide plate, leading to an increase in brightness without using a prism sheet.

### RELATED ART DOCUMENT

### Patent Document

Patent Document 1: Japanese Patent Application Laid-Open Publication No. 2005-71610

### Problems to be Solved by the Invention

In the above-mentioned Patent Document 1, a plurality of point light sources are arranged along the lengthwise direction of a light-receiving face of the light guide plate with gaps therebetween, while grooves that are parallel to the lengthwise direction of the light-receiving face are formed on the surface of the light guide plate opposite to the light-exiting surface. Light that enters the light-receiving face from the plurality of point light sources is emitted from the light-exiting surface as a result of being reflected by the grooves while travelling through the light guide plate. However, since the light that enters the light-receiving face from the plurality of light sources is reflected by the grooves, immediately oriented toward the light-exiting surface, and is then emitted from the light-exiting surface, it is unlikely that the light will be sufficiently diffused in the lengthwise direction of the light-receiving face. As a result, uneven brightness is likely to occur in the lengthwise direction for light emitted from the light-exiting surface.

### SUMMARY OF THE INVENTION

The present invention was developed with the above-mentioned situation in mind, and an aim thereof is to prevent the occurrence of uneven brightness.

### Means for Solving the Problems

An illumination device of the present invention includes: a light source; a light guide plate having a rectangular plate-like shape, at least one of a pair of end faces that are among peripheral end faces of the light guide plate and that are on opposite sides of the light guide plate being a light-receiving face that receives light emitted from the light source, one surface of the light guide plate being a light-exiting surface that emits light, and another surface of the light guide plate being an opposite surface; and a reflective member including a reflective surface that is disposed so as to face the opposite surface of the light guide plate and that reflects light, wherein the light guide plate has an exiting-light reflecting part for facilitating emission of light from the light-exiting surface by reflecting light that propagates within the light guide plate, the exiting-light reflecting part being disposed on a side of the light-exiting surface of the light guide plate and being formed of reflective units arranged in a plurality with gaps therebetween along a first direction that is along a pair of end faces that are among the peripheral end faces of the light guide plate, are on opposite sides of the light guide plate, and that do not include the light-receiving face, the reflective units extending along a second direction along the pair of end faces that are among the peripheral end faces of the light guide plate and that include the light-receiving face.

In such a configuration, the light emitted from the light sources enters the light-receiving face of the light guide plate, propagates within the light guide plate, and is reflected during this process by the exiting-light reflecting part disposed on the light-exiting surface side of the light guide plate. The reflective units that form the exiting-light reflecting part extend along the second direction and are disposed in a plurality along the first direction with gaps therebetween; thus, it is possible to reflect light propagating along the first direction within the light guide plate and orient this light toward the opposite surface. The light reflected toward the opposite surface by the exiting-light reflecting part is once again reflected by the reflective member disposed on the opposite surface side, resulting in the light being emitted from the light-exiting surface.

In conventional cases in which the exiting-light reflecting part is disposed on the opposite surface side, the light reflected by the exiting-light reflecting part is immediately directed toward and emitted from the light-exiting surface. In contrast, if the exiting-light reflecting part is disposed on the light-exiting surface side of the light guide plate as described above, it is possible to cause light reflected by the reflective units to be emitted from the light-exiting surface by initially orienting the light toward the opposite surface, and then once again orienting the light toward the light-exiting surface by reflecting the light via the reflective member disposed on the opposite surface side. In other words, the optical path from when light is reflected by the exiting-light reflecting part until the light is emitted from the light-exiting surface will become complex, and the light will be refracted on at least two particular occasions: when the light exits from the opposite surface toward the reflective member, and when the light exits from the reflective member toward the opposite surface. As a result of this refraction, light is more likely to be diffused in the second direction; thus light is well-mixed in the second direction and uneven brightness is unlikely to occur in the second direction for light emitted from the light-exiting surface.

The following configurations are preferred embodiments of the present invention.

(1) The light guide plate has an opposite surface anisotropic light-condensing part that is disposed on a side of the opposite surface of the light guide plate and is formed of opposite surface light-condensing parts that extend along the first direction and are arranged in a plurality along the second direction. In such a configuration, an anisotropic light-condensing effect is imparted, via the opposite surface anisotropic light-condensing part disposed on the opposite surface side of the light guide plate, on at least a portion of the light that is reflected by the exiting-light reflecting part and then reaches the opposite surface of the light guide plate. In other words, the opposite surface anisotropic light-condensing part is formed of an opposite surface light-condensing unit that extends along the first direction and is arranged in plurality along the second direction. Thus, the light emitted from the opposite surface light-condensing units includes light on which a light-condensing effect is selectively applied in the second direction, which is the alignment direction of the opposite surface light-condensing units. In addition, light that is reflected by the reflective member and then enters the opposite surface light-condensing units similarly contains light on which a light-condensing effect is selectively imparted in the second direction. Meanwhile, light that propagates along the first direction within the light guide plate without being reflected by the exiting-light reflecting part is totally reflected by the opposite surface light-condensing units, thereby being diffused in the second direction while propagating within the light guide plate.

Furthermore, since the opposite surface anisotropic light-condensing part is disposed on the opposite surface side of the light guide plate, there is likely to be a gap between the opposite surface and the reflective member. Therefore, of the light that is reflected by the exiting-light reflecting part and then emitted from the opposite surface, light on which a light-condensing effect is not imparted by the opposite surface anisotropic light-condensing part is likely to be diffused in the second direction by being refracted when being emitted toward the gap. Light emitted toward the gap while being diffused in the second direction is likely to be refracted and diffused in the second direction when the light is reflected by the reflective member and then re-enters the opposite surface. In this manner, light on which a light-condensing effect is not imparted by the opposite surface anisotropic light-condensing part is likely to be diffracted when entering and leaving the opposite surface via the gap; thus, this light is more likely to be further diffused in the second direction. As a result, light is even further well-mixed in the second direction, and uneven brightness is therefore even less likely to occur in the second direction for light emitted from the light-exiting surface.

(2) The light guide plate further has a light-exiting surface anisotropic light-condensing part that is disposed on the side of the light-exiting surface of the light guide plate and is formed of light-exiting surface light-condensing parts that extend along the first direction and are arranged in a plurality along the second direction. In such a configuration, an anisotropic light-condensing effect is imparted, via the light-exiting surface anisotropic light-condensing part disposed on the light-exiting surface side of the light guide plate, on at least a portion of the light that is reflected by the exiting-light reflecting part, is once again reflected by the reflective member, and then reaches the light-exiting surface of the light guide plate. In other words, since the light-exiting surface anisotropic light-condensing part is formed of a light-exiting surface light-condensing unit that extends along the first direction and is arranged in plurality along the second direction, the light emitted from the light-exiting surface light-condensing units includes light on which a light-condensing effect is selectively imparted in the second direction, which is the alignment direction of the light-exiting surface light-condensing units. Meanwhile, light that propagates along the first direction within the light guide plate without being reflected by the exiting-light reflecting part is totally reflected by the light-exiting surface light-condensing units, and is thereby diffused in the second direction while propagating within the light guide plate. As a result, light that propagates within the light guide plate is further well-mixed in the second direction, and uneven brightness is therefore less likely to occur in the second direction for light emitted from the light-exiting surface.

(3) Each of the reflective units of the exiting-light reflecting part is formed of a plurality of separate reflective unit segments that are arranged intermittently along the second direction with gaps therebetween. Since the amount of reflected light tends to be proportional to the size of the surface area of the reflective units, the size of this surface area must be set to a corresponding value in order to achieve the necessary amount of reflected light. When the reflective units are formed so as to extend along the entire length of the light guide plate in the second direction, in order to set the surface area of the reflective units to the above-mentioned value, the dimension of the reflective units in the direction normal to the surface of the light guide plate cannot be set to a value greater than or equal to a prescribed value. In contrast, if the reflective units are formed of a plurality of separated reflective units arranged intermittently in the second direction with gaps therebetween, it is possible to make the dimension of the reflective units in the direction normal to the surface of the light guide plate relatively larger when the surface area of the reflective units is set to the above-mentioned value. Therefore, when the light guide plate is manufactured using resin molding and the exiting-light reflecting part is integrally formed on the opposite surface of the light guide plate, it is easy to form the separated reflective units, which form the reflective units, in a designed shape on the opposite surface, for example. As a result, it is possible to cause the exiting-light reflecting part to exhibit the appropriate optical performance.

When the reflective units are formed so as to extend along the entire length of the light guide plate in the second direction, it is possible to adjust the total area constituted of the surface area of each of the reflective units by decreasing the number of reflective units aligned in the first direction. In such a case, however, the arrangement interval of the reflective units aligned in the first direction becomes larger, thus leading to concerns that uneven brightness may occur. On the other hand, if the reflective units are formed of a plurality of separated reflective units arranged intermittently in the second direction with gaps therebetween, it is not necessary to modify the number or arrangement interval of the reflective units aligned in the first direction. Thus, uneven brightness is unlikely to occur in light emitted from the illumination device.

(4) Each of the reflective units of the exiting-light reflecting part is formed by cutouts formed along the second direction by partially removing top parts of the light-exiting surface light-condensing parts forming the light-exiting surface anisotropic light-condensing part. If the reflective units are formed so as to not open along the second direction and so as to have a side face along the first direction, there is concern that the light-condensing capability of the light-exiting surface anisotropic light-condensing part may degrade as a result of light being refracted or reflected by the side face along the first direction. As a countermeasure, the exiting-light reflecting part is formed such that the reflective units are open along the second direction as a result of the top of the light-exiting surface light-condensing units being partially removed; thus, the light-condensing capability of the light-exiting surface anisotropic light-condensing part is satisfactorily exhibited, and it is thus possible to further increase the brightness of light emitted from the illumination device.

(5) The light guide plate has: a light-exiting surface anisotropic light-condensing part that is disposed on the side of the light-exiting surface of the light guide plate and is formed of light-exiting surface light-condensing parts that extend along the first direction and are arranged in a plurality along the second direction; and an opposite surface anisotropic light-condensing part that is disposed on a side of the opposite surface of the light guide plate and is formed of opposite surface light-condensing parts that extend along the first direction and are arranged in a plurality along the second direction, and the opposite surface light-condensing parts of the opposite surface anisotropic light-condensing part are opposite surface cylindrical lenses in which a surface thereof has an arc-like shape, while the light-exiting surface light-condensing parts of the light-exiting surface anisotropic light-condensing part are light-exiting surface unit prisms that have a substantially triangular cross-sectional shape and in which a vertex angle thereof is between 100° and 150°. In such a configuration, an anisotropic light-condensing effect is imparted, via the opposite surface anisotropic light-condensing part, on at least a portion of the light that is reflected by the exiting-light reflecting part and then reaches the opposite surface of the light guide plate, after which an anisotropic light-condensing effect is imparted, via the light-exiting surface anisotropic light-condensing part, on at least a portion of the light that has reached the light-exiting surface. In other words, since the light-exiting surface anisotropic light-condensing part and the opposite surface anisotropic light-condensing part are respectively formed of a light-exiting surface light-condensing unit and an opposite surface light-condensing unit that extend in the first direction and are arranged in plurality along the second direction, the light emitted from the opposite surface light-condensing units contains light upon which a light-condensing effect is selectively imparted in the second direction, which is the alignment direction of the opposite surface light-condensing units, and the light emitted from the light-exiting surface light-condensing units includes light upon which a light-condensing effect is selectively imparted in the second direction, which is the alignment direction of the light-exiting surface light-condensing units. In addition, light that is reflected by the reflective member and then enters the opposite surface light-condensing units similarly contains light upon which a light-condensing effect is selectively imparted in the second direction. Meanwhile, light that propagates along the first direction within the light guide plate without being reflected by the exiting-light reflecting part is totally reflected by the light-exiting surface light-condensing units and the opposite surface anisotropic light-condensing part, thereby being diffused in the second direction while propagating within the light guide plate. In particular, the opposite surface light-condensing units of the opposite surface anisotropic light-condensing part are opposite surface cylindrical lenses in which the surface thereof has an arc-like shape; thus, it is easier for the light totally reflected by these opposite surface cylindrical lenses to be more thoroughly diffused in the second direction.

Furthermore, since the opposite surface anisotropic light-condensing part is disposed on the opposite surface side of the light guide plate, there is likely to be a gap between the opposite surface and the reflective member. Therefore, of the light that is reflected by the exiting-light reflecting part and then emitted from the opposite surface, light on which a light-condensing effect is not imparted by the opposite surface anisotropic light-condensing part is likely to be diffused in the second direction by being refracted when being emitted toward the gap. Light emitted toward the gap while being diffused in the second direction is likely to be diffused in the second direction by being refracted when re-entering the opposite surface after being reflected by the reflective member. In this manner, light upon which a light-condensing effect is not imparted by the opposite surface anisotropic light-condensing part is likely to be refracted when entering and leaving the opposite surface via the gap; thus, this light is more likely to be further diffused in the second direction. As a result, light is even further well-mixed in the second direction, and uneven brightness is therefore even less likely to occur in the second direction for light emitted from the light-exiting surface.

In addition, since the light-exiting surface light-condensing units of the light-exiting surface anisotropic light-condensing part are light-exiting surface unit prisms that have a substantially triangular cross-sectional shape and the vertex angle thereof is between 100° and 150°, it is possible to further increase the brightness of light emitted from the light-exiting surface compared to a case in which the vertex angle of the light-exiting surface unit prisms is less than 100°. In other words, by setting the vertex angle of the light-exiting surface unit prisms within the angle range described above, there is an increase in the light-condensing effect of the light-exiting surface unit prisms.

(6) The vertex angle of the light-exiting surface light-condensing parts of the light-exiting surface anisotropic light-condensing part is between 135° and 150°. In such a configuration, it is possible to increase the brightness of light emitted from the light-exiting surface by at least 10% compared to a case in which the vertex angle of the light-exiting surface unit prisms is 90°.

(7) The vertex angle of the light-exiting surface light-condensing parts of the light-exiting surface anisotropic light-condensing part is between 140° and 150°. In such a configuration, it is possible to increase the brightness of light emitted from the light-exiting surface by at least 15% compared to a case in which the vertex angle of the light-exiting surface unit prisms is 90°.

(8) The light guide plate has: a light-exiting surface anisotropic light-condensing part that is disposed on the side of the light-exiting surface of the light guide plate and is formed of a light-exiting surface light-condensing parts that extend along the first direction and are arranged in a plurality along the second direction; and an opposite surface anisotropic light-condensing part that is disposed on a side of the opposite surface of the light guide plate and is formed of opposite surface light-condensing parts that extend along the first direction and are arranged in plurality along the second direction, and the light-exiting surface light-condensing parts and the opposite surface light-condensing parts of the light-exiting surface anisotropic light-condensing part and the opposite surface anisotropic light-condensing part, respectively, are light-exiting surface unit prisms and opposite surface unit prisms, respectively, that have a substantially triangular cross-sectional shape and in which vertex angles thereof are between 100° and 150°. In such a configuration, an anisotropic light-condensing effect is imparted, via the opposite surface anisotropic light-condensing part, on at least a portion of the light that is reflected by the exiting-light reflecting part and then reaches the opposite surface of the light guide plate, after which an anisotropic light-condensing effect is imparted, via the light-exiting surface anisotropic light-condensing part, on at least a portion of the light that has reached the light-exiting surface. In other words, since the light-exiting surface anisotropic light-condensing part and the opposite surface anisotropic light-condensing part are respectively formed of a light-exiting surface light-condensing unit and an opposite surface light-condensing unit that respectively extend in the first direction and are arranged in plurality along the second direction, the light emitted from the opposite surface light-condensing units contains light upon which a light-condensing effect is selectively imparted in the second direction, which is the alignment direction of the opposite surface light-condensing units, and the light emitted from the light-exiting surface light-condensing units includes light upon which a light-condensing effect is selectively imparted in the second direction, which is the alignment direction of the light-exiting surface light-condensing units. In addition, light that is reflected by the reflective member and then enters the opposite surface light-condensing units similarly contains light upon which a light-condensing effect is selectively imparted in the second direction. Meanwhile, light that propagates along the first direction within the light guide plate without being reflected by the exiting-light reflecting part is totally reflected by the light-exiting surface light-condensing units and the opposite surface anisotropic light-condensing part, thereby being diffused in the second direction while propagating within the light guide plate.

Furthermore, since the opposite surface anisotropic light-condensing part is disposed on the opposite surface side of the light guide plate, there is likely to be a gap between the opposite surface and the reflective member. Therefore, of the light that is reflected by the exiting-light reflecting part and then emitted from the opposite surface, light on which a light-condensing effect is not imparted by the opposite surface anisotropic light-condensing part is likely to be diffused in the second direction by being refracted when being emitted toward the gap. Light emitted toward the gap while being diffused in the second direction is likely to be diffused in the second direction by being refracted when re-entering the opposite surface after being reflected by the reflective member. In this manner, light upon which a light-condensing effect is not imparted by the opposite surface anisotropic light-condensing part is likely to be refracted when entering and leaving the opposite surface via the gap; thus, this light is more likely to be further diffused in the second direction. As a result, light is even further well-mixed in the second direction, and uneven brightness is therefore even less likely to occur in the second direction for light emitted from the light-exiting surface.

In addition, since the light-exiting surface light-condensing units and the opposite surface light-condensing units of the light-exiting surface anisotropic light-condensing part and the opposite surface anisotropic light-condensing part, respectively, are light-exiting surface unit prisms and opposite surface unit prisms that have a substantially triangular cross-sectional shape, it is possible for a larger light-condensing effect to be imparted upon light emitted from the light-exiting surface compared to a case in which either the light-exiting surface unit prisms or the opposite surface unit prisms are cylindrical lenses. In addition, since the vertex angles of the light-exiting surface unit prisms and the opposite surface unit prisms are respectively between 100° and 150°, it is possible to increase the brightness of light emitted from the light-exiting surface compared to a case in which the vertex angles of the light-exiting surface unit prisms and the opposite surface unit prisms are less than 100°. In other words, by setting the vertex angles of the light-exiting surface unit prisms and the opposite surface unit prisms within the angle range described above, there is an increase in the light-condensing effect of the light-exiting surface unit prisms and the opposite surface unit prisms.

(9) The vertex angle of the light-exiting surface unit prisms of the light-exiting surface anisotropic light-condensing part is relatively larger than the vertex angle of the opposite surface unit prisms, an angle range of the vertex angle of the light-exiting surface unit prisms being 130° to 150° while the vertex angle of the opposite surface unit prisms is between 100° and 140°. In such a configuration, it is possible to increase the brightness of light emitted from the light-exiting surface compared to: a case in which either the light-exiting surface unit prisms or the opposite surface unit prisms are cylindrical lenses, a case in which the vertex angle of the light-exiting surface unit prisms is smaller than the vertex angle of the opposite surface unit prisms, or a case in which the vertex angle of the light-exiting surface unit prisms and the vertex angle of the opposite surface unit prisms fall outside the angle ranges described above. Specifically, it is possible to increase the brightness of light emitted from the light-exiting surface by at least 3% compared to a case in which the opposite surface unit prisms are cylindrical lenses and the vertex angle of the light-exiting surface unit prisms is set to 140°, for example.

(10) In the opposite surface light-condensing parts, the vertex angle of the opposite surface unit prisms is between 110° and 130°. In such a configuration, it is possible to increase the brightness of light emitted from the light-exiting surface by at least 5% compared to a case in which the opposite surface unit prisms are cylindrical lenses and the vertex angle of the light-exiting surface unit prisms is set to 140°.

(11) The present invention further includes a light-emission side anisotropic light-condensing sheet that is disposed on a light-emission side of the light guide plate and is formed of a light-emission side light-condensing parts that extend along the first direction and are arranged in plurality along the second direction. In such a configuration, an anisotropic light-condensing effect is imparted, via the light-emission side anisotropic light-condensing part disposed on the light-emission side of the light guide plate, upon light emitted from the light-exiting surface of the light guide plate. In other words, since the light-emission side anisotropic light-condensing part is formed of a light-emission side unit condensing member that extends along the first direction and is arranged in plurality along the second direction, a light-condensing effect is selectively imparted in the second direction, which is the alignment direction of the light-emission side unit condensing members, upon light emitted from the light-emission side unit condensing members. Thus, it is possible to increase the brightness of light emitted from this illumination device.

(12) The light guide plate has: a light-exiting surface anisotropic light-condensing part that is disposed on the side of the light-exiting surface of the light guide plate and is formed of light-exiting surface unit prisms that extend along the first direction and are arranged in a plurality along the second direction; an opposite surface anisotropic light-condensing part that is disposed on a side of the opposite surface of the light guide plate and is formed of opposite surface cylindrical lenses that extend along the first direction and are arranged in a plurality along the second direction; and flat sections that are disposed on the side of the opposite surface of the light guide plate so as to be interposed between the opposite surface cylindrical lenses that are adjacent in the second direction, the flat sections being flat along the first direction and the second direction, and the illumination device further includes a light-emission side anisotropic light-condensing sheet that is disposed on a light-emission side of the light guide plate and is formed of a light-emission side light-condensing parts that extend along the first direction and are arranged in a plurality along the second direction, and the opposite surface anisotropic light-condensing part and the flat sections are provided such that, with respect to occupancy ratios as defined along the second direction on the opposite surface, the occupancy ratio of the opposite surface cylindrical lenses is relatively high and the occupancy ratio of the flat sections is relatively low on a side of the light guide plate near the light-receiving face in the first direction, while the occupancy ratio of the opposite surface light-condensing parts is relatively low and the occupancy ratio of the flat sections is relatively high on a side of the light guide plate furthest from the light-receiving face in the first direction. In such a configuration, an anisotropic light-condensing effect is imparted, via the opposite surface anisotropic light-condensing part, on at least a portion of the light that is reflected by the exiting-light reflecting part and then reaches the opposite surface of the light guide plate, after which an anisotropic light-condensing effect is imparted, via the light-exiting surface anisotropic light-condensing part, on at least a portion of the light that has reached the light-exiting surface. In other words, since the light-exiting surface anisotropic light-condensing part and the opposite surface anisotropic light-condensing part are respectively formed of a light-exiting surface light-condensing unit and an opposite surface light-condensing unit that respectively extend in the first direction and are arranged in plurality along the second direction, the light emitted from the opposite surface light-condensing units contains light upon which a light-condensing effect is selectively imparted in the second direction, which is the alignment direction of the opposite surface light-condensing units, and the light emitted from the light-exiting surface light-condensing units includes light upon which a light-condensing effect is selectively imparted in the second direction, which is the alignment direction of the light-exiting surface light-condensing units. In addition, light that is reflected by the reflective member and then enters the opposite surface light-condensing units similarly contains light upon which a light-condensing effect is selectively imparted in the second direction. Meanwhile, light that propagates along the first direction within the light guide plate without being reflected by the exiting-light reflecting part is totally reflected by the light-exiting surface anisotropic light-condensing part and the opposite surface anisotropic light-condensing part, thereby being diffused in the second direction while propagating within the light guide plate. In particular, the opposite surface light-condensing units of the opposite surface anisotropic light-condensing part are opposite surface cylindrical lenses in which the surface thereof has an arc-like shape; thus, it is easier for the light totally reflected by these opposite surface cylindrical lenses to be more thoroughly diffused in the second direction.

Furthermore, since the opposite surface anisotropic light-condensing part is disposed on the opposite surface side of the light guide plate, there is likely to be a gap between the opposite surface and the reflective member. Therefore, of the light that is reflected by the exiting-light reflecting part and then emitted from the opposite surface, light on which a light-condensing effect is not imparted by the opposite surface anisotropic light-condensing part is likely to be diffused in the second direction by being refracted when being emitted toward the gap. Light emitted toward the gap while being diffused in the second direction is likely to be diffused in the second direction by being refracted when re-entering the opposite surface after being reflected by the reflective member. In this manner, light upon which a light-condensing effect is not imparted by the opposite surface anisotropic light-condensing part is likely to be refracted when entering and leaving the opposite surface via the gap; thus, this light is more likely to be further diffused in the second direction. As a result, light is even further well-mixed in the second direction, and uneven brightness is therefore even less likely to occur in the second direction for light emitted from the light-exiting surface.

An anisotropic light-condensing effect is imparted upon light emitted from the light-exiting surface of the light guide plate via the light-emission side anisotropic light-condensing part disposed on the light-emission side of the light guide plate. In other words, since the light-emission side anisotropic light-condensing part is formed of a light-emission side unit condensing member that extends along the first direction and is arranged in a plurality along the second direction, a light-condensing effect is selectively imparted in the second direction, which is the alignment direction of the light-emission side unit condensing members, on light emitted from the light-emission side unit condensing members. Although the opposite surface cylindrical lenses forming the opposite surface anisotropic light-condensing part disposed on the opposite surface side of the light guide plate impart an anisotropic light-condensing effect as described above on light reflected by the exiting-light reflecting part, the light on which this anisotropic light-condensing effect is imparted is unlikely to be condensed in the second direction by the light-emission side anisotropic light-condensing part, and is instead likely to be diffused in the second direction. Meanwhile, the flat section disposed on the opposite surface side of the light guide plate imparts substantially no specific optical effects on the light reflected by the exiting-light reflecting part. Thus, the light emitted toward the light-emission side anisotropic light-condensing part via the flat section is light upon which the predominantly-imparted optical effect is the anisotropic light-condensing effect imparted by the light-exiting surface anisotropic light-condensing part, and as a result, this light is more likely to have a light-condensing effect imparted thereon in the second direction at the light-emission side anisotropic light-condensing part. Therefore, as the occupancy ratio of the opposite surface light-condensing units of the opposite surface anisotropic light-condensing part becomes larger on the opposite surface and the occupancy ratio of the flat section becomes smaller on the opposite surface, uneven brightness in the second direction decreases for light emitted from the light-emission side anisotropic light-condensing part, although the brightness also tends to decrease. In contrast, as the occupancy ratio of the flat section on the opposite surface increases and the occupancy ratio of the opposite surface light-condensing units on the opposite surface decreases, uneven brightness in the second direction is less likely to be mitigated for light emitted from the light-emission side anisotropic light-condensing part, although the brightness of this light tends to increase.

Thus, as mentioned above, the opposite surface anisotropic light-condensing part and the flat section are provided such that, for the occupancy ratio in the second direction on the opposite surface, the occupancy ratio of the opposite surface light-condensing units is relatively high and the occupancy ratio of the flat section is relatively low near the light-receiving face in the first direction, while the occupancy ratio of the opposite surface light-condensing units is relatively low and the occupancy ratio of the flat section is relatively high on the side furthest from the light-receiving face in the first direction. Thus, on the side near the light-receiving face in the first direction, where there is concern that uneven brightness may occur as a result of the light sources, uneven brightness is unlikely to occur in the second direction for light emitted from the light-emission side anisotropic light-condensing part as a result of the opposite surface anisotropic light-condensing part, which has a relatively high occupancy ratio near the light-receiving face. Meanwhile, on the side furthest from the light-receiving face in the first direction, where uneven brightness due to the light sources is fundamentally unlikely to occur, the brightness of light emitted from the light-emission side anisotropic light-condensing part is higher as a result of the flat section, which has a relatively high occupancy ratio on the side furthest from the light-receiving face. As a result, uneven brightness is mitigated and brightness is increased for light emitted from the light-emission side anisotropic light-condensing part.

(13) The reflective member is configured such that the reflective surface mirror reflects light. In such a configuration, light from the opposite surface of the light guide plate is mirror-reflected by the reflective surface of the reflective member; thus, light is less likely to be diffused in at least the first direction, and it is therefore possible to increase the brightness of light emitted from the light-exiting surface of the light guide plate.

Next, in order to resolve the above-mentioned problems, a display device of the present invention includes the above-mentioned illumination device and a display panel that performs display by utilizing light from the illumination device.

In a display device with such a configuration, uneven brightness is unlikely to occur in light emitted from the illumination device; thus, it is possible to achieve a display with excellent display quality.

### Effects of the Invention

According to the present invention, it is possible to prevent the occurrence of uneven brightness.

### BRIEF DESCRIPTION OF THE DRAWINGS

FIG. 1 is an exploded perspective view that shows a schematic configuration of a liquid crystal display device according to Embodiment 1 of the present invention.

FIG. 2 is an exploded perspective view that shows a schematic configuration of a backlight device forming a part of the liquid crystal display device.

FIG. 3 is a cross-sectional view that shows a cross-sectional configuration of the liquid crystal display device along the long-side direction (first direction, X axis direction) thereof.

FIG. 4 is a cross-sectional view that shows a cross-sectional configuration of the liquid crystal display device along the short-side direction (second direction, Y axis direction) thereof.

FIG. 5 is a cross-sectional view that enlarges the vicinity of the LEDs in FIG. 3. FIG. 6 is a plan view of a light guide plate. FIG. 7 is a plan view that enlarges the area at the end of the light guide plate next to the light-receiving face and the area at the end of the light guide plate next to the opposite end face.

FIG. 8 is a bottom view of the light guide plate. FIG. 9 is a cross-sectional view that shows a cross-sectional configuration of the backlight device that forms a part of the liquid crystal display device along the short-side direction (second direction, Y axis direction).

FIG. 10 is a cross-sectional view along a line A-A in FIG. 9.

FIG. 11 is a graph that illustrates the relationship between the angle of incidence of light reaching a prism sheet and the angle of emergence of light from the prism sheet.

FIG. 12 shows pictures taken during Comparative Experiment 1 of the respective light guide plates for Comparison Example 1 and Working Example 1 as taken from a light-exiting surface side of the light guide plate. FIG. 12 also shows the determination results for uneven brightness for Comparative Experiment 1.

FIG. 13 is a graph that illustrates for Comparative Experiment 2 the relationship between the vertex angle of a light-exiting surface unit prism and the relative brightness of light emitted from the prism sheet.

FIG. 14 is a graph that illustrates for Comparative Experiment 2 the angular distribution of brightness in the second direction for emitted light obtained by causing the light emitted from the respective light guide plates of Working Examples 2 and 3 to pass through a prism sheet.

FIG. 15 is a graph that illustrates for Comparative Experiment 3 the height dimension of the reflective units forming the exiting-light reflecting parts of the respective light guide plates of Comparison Example 2 and Working Example 1.

FIG. 16 is a table that shows for Comparative Experiment 3 the height dimension of the reflective units and the shape reproducibility of the reflective units from a first location to a fifth location on the respective light guide plates according to Comparison Example 2 and Working Example 1.

FIG. 17 is a cross-sectional view that shows a cross-sectional configuration of a backlight device according to Embodiment 2 of the present invention along the short-side direction (second direction, Y axis direction).

FIG. 18 is a table that shows for Comparative Experiment 4 the relative brightness of emitted light obtained by causing light emitted from the respective light guide plates according to Working Examples 4 to 12 to pass through a prism sheet.

FIG. 19 is a bottom view of a light guide plate according to Embodiment 3 of the present invention.

FIG. 20 is a cross-sectional view along a line B-B in FIG. 19.

FIG. 21 is a cross-sectional view along a line C-C in FIG. 19.

FIG. 22 is a cross-sectional view along a line D-D in FIG. 19.

FIG. 23 is a graph that illustrates for Comparative Experiment 5 the angular distribution of brightness in the second direction for emitted light obtained by causing the light emitted from the respective light guide plates according to Comparison Examples 3 and 4 to pass through a prism sheet.

FIG. 24 is a graph that illustrates for Comparative Experiment 6 the relationship between the vertex angle of a light-exiting surface unit prism and the relative brightness of light emitted from the prism sheet.

FIG. 25 is a graph that illustrates for Comparative Experiment 7 the angular distribution of brightness in the second direction for emitted light obtained by causing light emitted at a location closer in the first direction to the light-receiving face on the respective light guide plates of Comparison Example 3 and Working Example 13 to pass through a prism sheet.

FIG. 26 is a graph that illustrates for Comparative Experiment 7 the angular distribution of brightness in the second direction for emitted light obtained by causing light emitted at a location central in the first direction on the respective light guide plates of Comparison Example 3 and Working Example 13 to pass through a prism sheet.

FIG. 27 is a graph that illustrates for Comparative Experiment 7 the angular distribution of brightness in the second direction for emitted light obtained by causing light emitted at a location closer in the first direction to the opposite end face on the respective light guide plates of Comparison Example 3 and Working Example 13 to pass through a prism sheet.

FIG. 28 is a cross-sectional view that shows a cross-sectional configuration of a backlight device according to Embodiment 4 of the present invention along the long-side direction (first direction, X axis direction).

FIG. 29 shows pictures taken during Comparative Experiment 8 of the respective light guide plates for Working Examples 14 and 15 as taken from the light-exiting surface side of the light guide plate. FIG. 29 also shows the determination results for uneven brightness for Comparative Experiment 8.

FIG. 30 is a graph that illustrates for Comparative Experiment 9 the angular distribution of brightness in the second direction for emitted light obtained by causing the light emitted from the respective light guide plates of Working Examples 14 and 15 to pass through a prism sheet.

FIG. 31 is a graph that illustrates for Comparative Experiment 9 the angular distribution of brightness in the first direction for emitted light obtained by causing the light emitted from the respective light guide plates of Working Examples 14 and 15 to pass through a prism sheet.

FIG. 32 is a cross-sectional view that shows a cross-sectional configuration in which a light guide plate according to Embodiment 5 of the present invention has been cut along the short-side direction (second direction, Y axis direction) at a location closer to the light-receiving face in the first direction.

FIG. 33 is a cross-sectional view that shows a cross-sectional configuration in which the light guide plate has been cut along the short-side direction (second direction, Y axis direction) at a location that is central in the first direction.

FIG. 34 is a cross-sectional view that shows a cross-sectional configuration in which the light guide plate has been cut along the short-side direction (second direction, Y axis direction) at a location closer to the opposite end face in the first direction.

FIG. 35 is a bottom view of a light guide plate according to Embodiment 6 of the present invention.

FIG. 36 is a cross-sectional view that shows a cross-sectional configuration of a backlight device along the short-side direction (second direction, Y axis direction).

### DETAILED DESCRIPTION OF EMBODIMENTS

### Embodiment 1

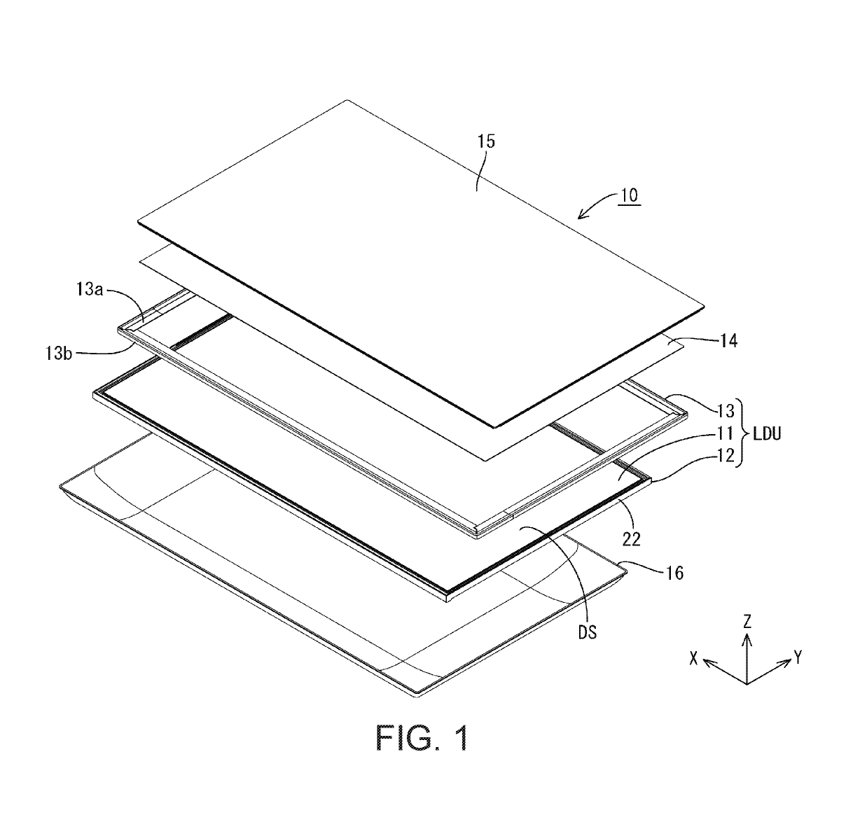

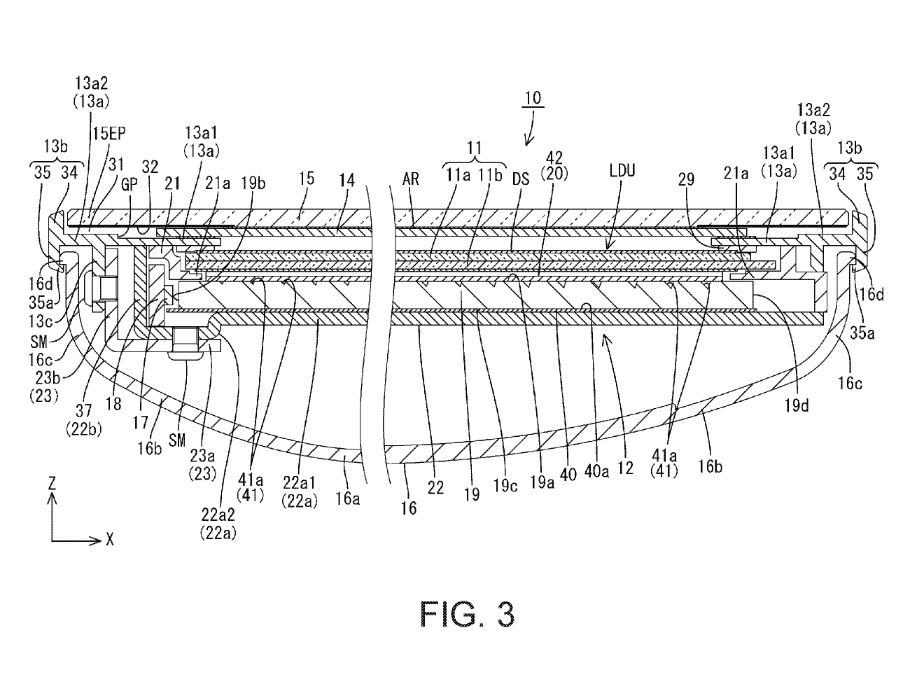

Embodiment 1 of the present invention will be described with reference to FIGS. 1 to 16. In the present embodiment, a liquid crystal display device 10 will be described as an example. The drawings indicate an X axis, a Y axis, and a Z axis in a portion of the drawings, and each of the axes indicates the same direction in the respective drawings. The up-down direction in the drawings is based on FIGS. 3 to 5. The upper side in the drawings represents the front side while the lower side thereof represents the rear side.

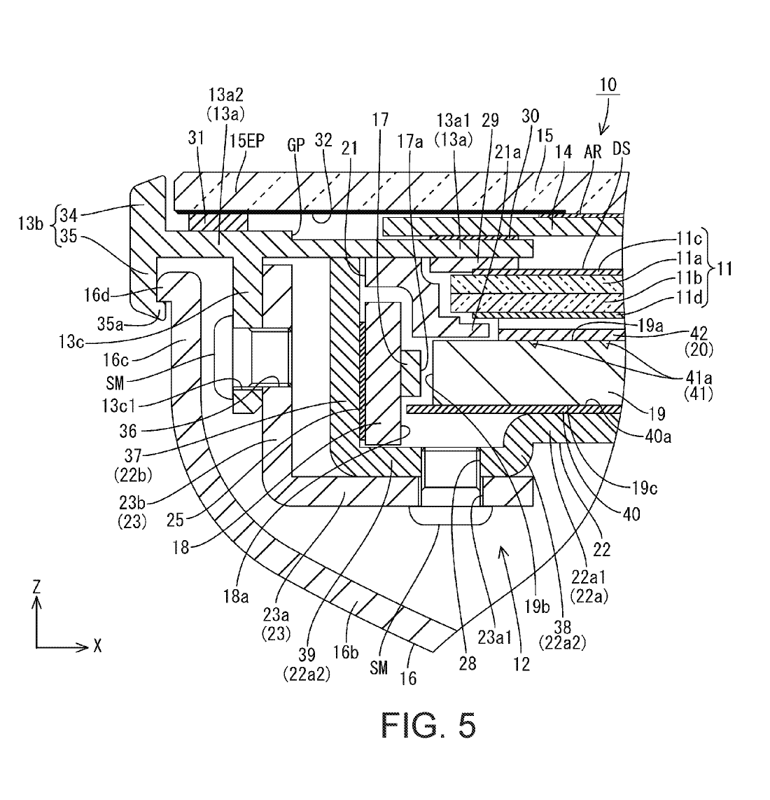

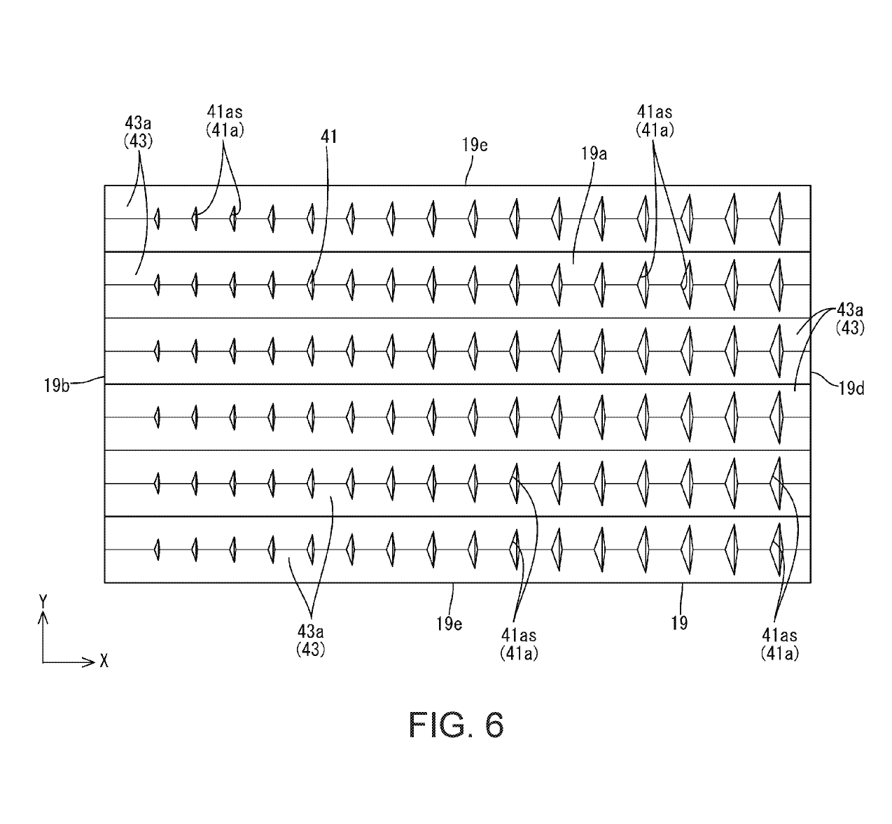

As shown in FIG. 1, the liquid crystal display device 10 has a rectangular shape as a whole in a plan view, and is formed by attaching a touch panel 14, a cover panel (protective panel, cover glass) 15, a casing 16, and the like to a liquid crystal display unit LDU, which is the main component. The liquid crystal display unit LDU includes: a liquid crystal panel (display panel) 11 that has a display surface DS that displays images on the front side; a backlight device (illumination device) 12 that is disposed to the rear of the liquid crystal panel 11 and that sends light toward the liquid crystal panel 11; and a frame (housing member) 13 that presses upon the liquid crystal panel 11 from the front, or in other words, from the side (the display surface DS side) opposite to the backlight device 12. The touch panel 14 and the cover panel 15 are both housed from the front within the frame 13, which forms a part of the liquid crystal display unit LDU, and the peripheral sections (including the peripheral edges) thereof are received from the rear by the frame 13. The touch panel 14 is disposed to the front of the liquid crystal panel 11 such that there is a prescribed gap therebetween, and the rear (inner) surface thereof is an opposing surface that faces the display surface DS. The cover panel 15 is disposed so as to overlap the front of the touch panel 14, and the rear (inner) surface thereof is an opposing surface that faces the front surface of the touch panel 14. An anti-reflective film AR is interposed between the touch panel 14 and the cover panel 15 (see FIG. 5). The casing 16 is attached to the frame 13 so as to cover the liquid crystal display unit LDU from the rear. Of the constituting components of the liquid crystal display device 10, a portion of the frame 13 (a loop section 13b, which will be described later), the cover panel 15, and the casing 16 constitute the exterior of the liquid crystal display device 10. Liquid crystal display devices 10 according to the present embodiment are used in electronic devices such as smartphones and the like. The size of the screen is approximately 5 inches, for example.

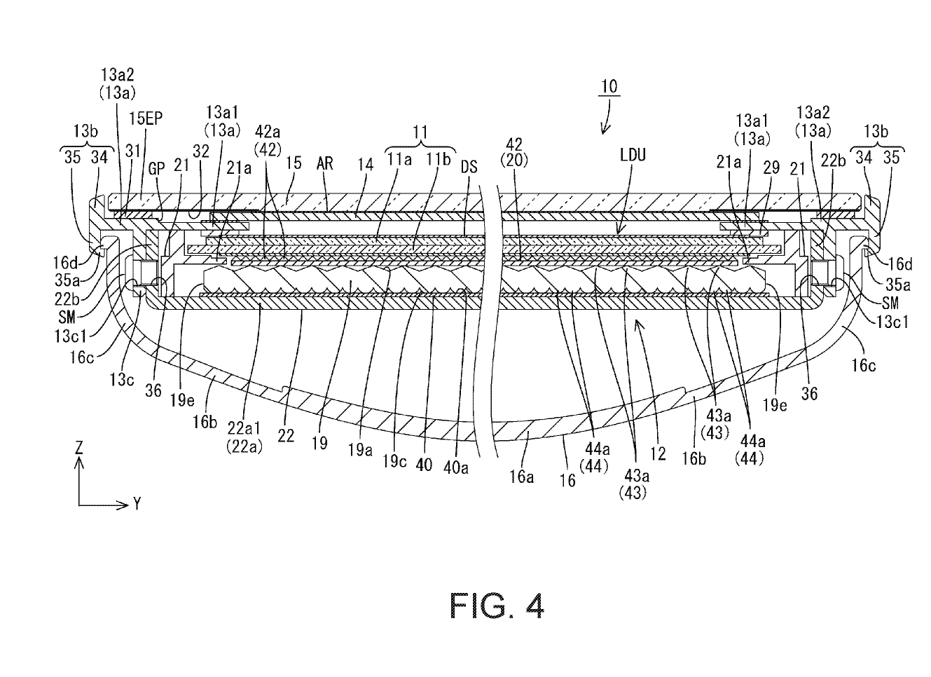

First, the liquid crystal panel 11 that forms a part of the liquid crystal display unit LDU will be described in detail. As shown in FIGS. 3 and 4, the liquid crystal panel 11 includes: a pair of glass substrates 11a, 11b that have a rectangular shape when viewed in a plan view and that are substantially transparent and have excellent light transmissivity; and a liquid crystal layer (not shown) that is interposed between the pair of substrates 11a, 11b and includes liquid crystal molecules made of a substance in which the optical properties change as an electric field is applied. The two substrates 11a, 11b are attached via a sealant (not shown) so as to maintain a gap that corresponds to the thickness of the liquid crystal layer. The liquid crystal panel 11 has a display region that displays images (a central region surrounded by a surface light-shielding layer 32, which will be described later) and a non-display region (a peripheral section that overlaps the surface light-shielding layer 32, which will be explained later) that has a frame-like shape so as to surround the display region and on which images are not displayed. The long-side direction of the liquid crystal panel 11 corresponds to the X axis direction, the short-side direction thereof corresponds to the Y axis direction, and the thickness direction thereof corresponds to the Z axis direction.

Of the two substrates 11a, 11b, the substrate on the front side (front surface side) is a CF substrate 11a, and the substrate on the rear side (rear surface side) is an array substrate 11b. A plurality of TFTs (thin film transistors), which are switching elements, and a plurality of pixel electrodes are arranged on the inner surface of the array substrate 11b (surface facing the liquid crystal layer and opposing the CF substrate 11a), and gate wiring lines and source wiring lines surround each of these TFTs and pixel electrodes in a grid pattern. Each of the wiring lines is provided with a prescribed image signal from a control circuit (not shown). The pixel electrodes, which are disposed in a rectangular region surrounded by the gate wiring lines and the source wiring lines, are transparent electrodes formed of ITO (indium tin oxide) or ZnO (zinc oxide).

Meanwhile, a plurality of color filters are provided on the CF substrate 11a in locations corresponding to the respective pixels. The color filters are arranged such that the three colors R, G, and B are alternately disposed. A light-shielding layer (black matrix) is formed between the respective color filters to prevent color mixing. Opposite electrodes, which oppose the pixel electrodes on the array substrate 11b, are provided on the respective surfaces of the color filters and the light-shielding layer. The CF substrate 11a is formed so as to be slightly smaller than the array substrate 11b. Alignment films for aligning the liquid crystal molecules included in the liquid crystal layer are respectively formed on the inner surfaces of the substrates 11a, 11b. Polarizing plates 11c, 11d are bonded to the respective outer surfaces of the two substrates 11a, 11b (see FIG. 5).

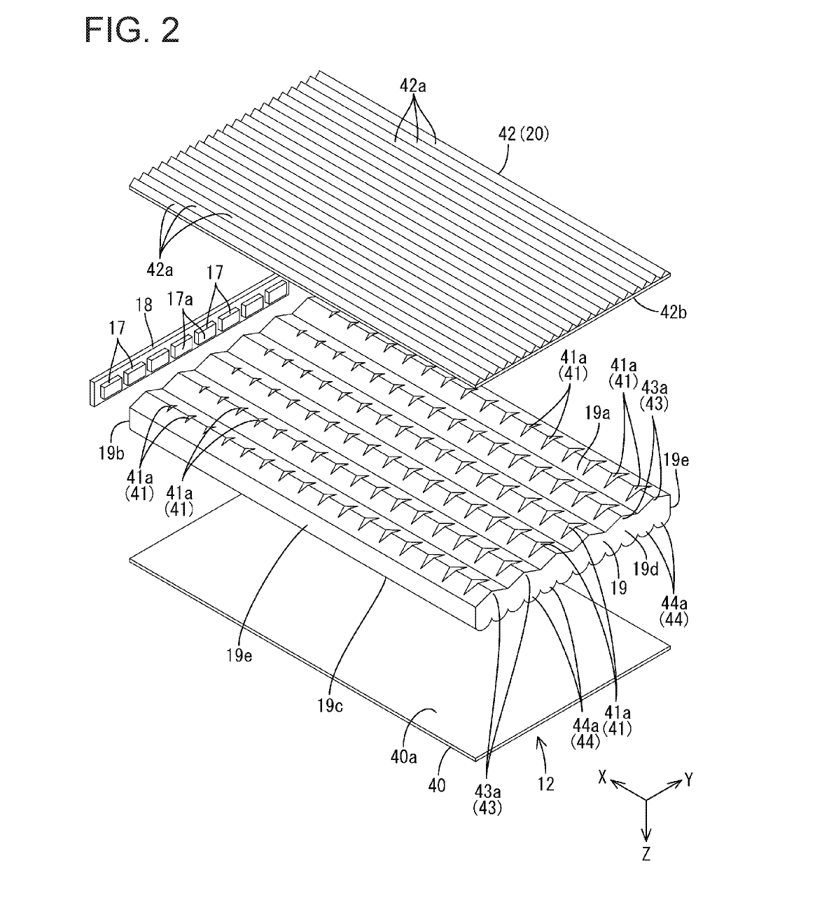

Next, the backlight device 12 that forms a part of the liquid crystal display unit LDU will be described in detail. As shown in FIG. 1, the backlight device 12, similar to the liquid crystal panel 11, has a substantially rectangular block shape as a whole in a plan view. As shown in FIGS. 2 to 4, the backlight device 12 includes: LEDs (light emitting diodes) 17, which are light sources; an LED substrate (light source substrate) 18 on which the LEDs 17 are mounted; a light guide plate 19 that guides light from the LEDs 17; a reflective sheet (reflective member) 40 that reflects light from the light guide plate 19; an optical sheet (light-emission side anisotropic light-condensing part, optical member) 20 stacked on the light guide plate 19; a light-shielding frame 21 that presses upon the light guide plate 19 from the front; a chassis 22 that houses the LED substrate 18, the light guide plate 19, the optical sheet 20, and the light-shielding frame 21; and a heat-dissipating member 23 that is attached so as to contact the outer surface of the chassis 22. The backlight device 12 is of a one side light-receiving edge-lit (side-lit) type in which the LEDs 17 (the LED substrate 18) are disposed on, from among the peripheral sections of the backlight device 12, one of the short-side edges thereof.

As shown in FIGS. 2, 3, and 5, each of the LEDs 17 has a configuration in which an LED chip is sealed by a resin material onto a substrate section that is bonded to the LED substrate 18. The LED chip mounted on the substrate section has one primary light-emitting wavelength, and specifically, emits only blue light. Meanwhile, a phosphor that emits a prescribed color when excited by blue light emitted from the LED chip is dispersed within the resin material that seals the LED chip. Thus, the LED as a whole emits light that is largely white. For the phosphor, a yellow phosphor that emits yellow light, a green phosphor that emits green light, and a red phosphor that emits red light can be appropriately combined, or only one of the phosphors can be used, for example. The LEDs 17 are of a so-called top-emitting type in which the side opposite to the mounting surface for the LED substrate 18 is a light-emitting surface 17a.

As shown in FIGS. 2, 3, and 5, the LED substrate 18 has a long plate-like shape that extends along the Y axis direction (the short-side direction of the light guide plate 19 and the chassis 22). The surface of the LED substrate 18 is housed within the chassis 22 so as to be parallel to the Y axis direction and the Z axis direction, or in other words, orthogonal to the respective surfaces of the liquid crystal panel 11 and the light guide plate 19. In other words, the long-side direction of the surface of the LED substrate 18 corresponds to the Y axis direction, the short-side direction thereof corresponds to the Z axis direction, and the thickness direction that is orthogonal to the surface corresponds to the X axis direction. The LED substrate 18 is disposed such that the inward-facing surface (a mounting surface 18a) faces one short-side end face (a light-receiving face 19b, a light source-facing end face) of the light guide plate 19 in the X axis direction with a prescribed gap therebetween. Therefore, the alignment direction of the LEDs 17, the LED substrate 18, and the light guide plate 19 substantially corresponds to the X axis direction. The length dimension of the LED substrate 18 is substantially identical to or larger than the short side dimension of the light guide plate 19, and the LED substrate 18 is attached to one of the short-side edges of the chassis 22, which will be explained later.

As shown in FIG. 5, the LEDs 17 having the configuration above are surface-mounted on the inner side of the LED substrate 18, or in other words, the surface facing the light guide plate 19 (the surface opposing the light guide plate 19), and this surface is the mounting surface 18a. On the mounting surface 18a of the LED substrate 18, a plurality of the LEDs 17 are disposed in a row (in a line) with a prescribed gap therebetween along the length direction (Y axis direction) thereof. In other words, a plurality of LEDs 17 are arranged with gaps therebetween along one short-side edge of the backlight device 12 along the short-side direction. The arrangement intervals (arrangement pitch) between adjacent LEDs 17 are substantially identical. Also, the mounting surface 18a of the LED substrate 18 has formed thereon a wiring pattern (not shown) made of a metal film (copper foil or the like) that extends along the Y axis direction across the group of LEDs 17 so as to connect adjacent LEDs 17 in series. Terminals formed at both ends of the wiring pattern are connected to an external LED driver circuit such that driving power can be supplied to the respective LEDs 17. In addition, the base material of the LED substrate 18 is made of metal like the chassis 22, and the previously-mentioned wiring pattern (not shown) is formed on the surface of the base material of the LED substrate 18 with an insulating layer therebetween. It is also possible to form the base material of the LED substrate 18 using an insulating material such as a ceramic.

The light guide plate 19 is made of a synthetic resin material (an acrylic resin such as PMMA or the like, for example) that has a sufficiently higher refractive index than air, is substantially transparent, and has excellent light transmissivity. As shown in FIGS. 2 and 6, the light guide plate 19, like the liquid crystal panel 11, has a substantially rectangular flat plate shape in a plan view, and the surface of the light guide plate 19 is parallel to the surface (the display surface DS) of the liquid crystal panel 11. The long-side direction on the surface of the light guide plate 19 corresponds to the X axis direction, the short-side direction thereof corresponds to the Y axis direction, and the thickness direction that is orthogonal to the plate surface thereof corresponds to the Z axis direction. As seen in FIGS. 3 and 4, the light guide plate 19 is disposed within the chassis 22 directly below the liquid crystal panel 11 and the optical sheet 20, and one of the short-side end faces from among the peripheral end faces of the light guide plate 19 faces the respective LEDs 17 on the LED substrate 18 that is disposed on one of the short side edges of the chassis 22. Thus, the alignment direction of the LEDs 17 (LED substrate 18) and the light guide plate 19 corresponds to the X axis direction, while the alignment direction (stacking direction) of the optical sheet 20 (liquid crystal panel 11) and the light guide plate 19 corresponds to the Z axis direction. These two alignment directions are orthogonal to each other. The light guide plate 19 has the function of receiving light emitted from the LEDs 17 towards the light guide plate 19 in the X axis direction (alignment direction of the LEDs 17 and the light guide plate 19) at a short-side end face thereof, and then propagating this light therein, orienting the light toward the optical sheet 20 (toward the front, toward the light-exiting side), and then emitting this light from the surface thereof.

Of the surfaces of the light guide plate 19 that has a flat plate-like shape, the surface (surface facing the liquid crystal panel 11 and the optical sheet 20) that faces toward the front (light-emission side) is, as shown in FIGS. 3 and 4, a light-exiting surface 19a from which internal light is emitted towards the optical sheet 20 and the liquid crystal panel 11. Of the peripheral end faces adjacent to the surface of the light guide plate 19, one (the left side shown in FIG. 3) of the pair of short-side end faces that have a rectangular shape along the Y axis direction (the alignment direction of the LEDs 17, the long-side direction of the LED substrate 18), as shown in FIG. 5, faces the LEDs 17 (the LED substrate 18) with a prescribed gap therebetween. This short-side end face is the light-receiving face 19b that receives light emitted by the LEDs 17, or in other words, is the LED-facing end face (the light source-facing end face) that faces the LEDs 17. The light-receiving face 19b is on a plane that is parallel to the Y axis direction and the Z axis direction and that is substantially orthogonal to the light-exiting surface 19a. The alignment direction of the LEDs 17 and the light-receiving face 19b (light guide plate 19) matches the X axis direction and is parallel to the light-exiting surface 19a. Of the pair of short-side end faces of the peripheral end faces of the light guide plate 19, the other end face on the opposite side of the light-receiving face 19b (the end face forming a pair with the light-receiving face 19b) is an opposite end face (non-light receiving opposite surface) 19d. The pair of long-side end faces that are adjacent to both the light-receiving face 19b and the opposite end face 19d (a pair of end faces that are on opposite sides and that do not include the light-receiving face 19b) are respectively side end faces 19e. The pair of side end faces 19e are on a plane parallel to the X axis direction (the alignment direction of the LEDs 17 and the light guide plate 19) and the Z axis direction. Three of the end faces from among the peripheral end faces of the light guide plate 19, excluding the light-receiving face 19b, or in other words, the opposite end face 19d and the pair of side end faces 19e, are, as shown in FIGS. 3 and 4, non-LED facing end faces (non-light source facing end faces) that do not respectively face the LEDs 17. Light that enters the light guide plate 19 from the LEDs 17 via the light-receiving face 19b, which is one of the peripheral end faces of the light guide plate 19, is efficiently transmitted within the light guide plate 19 by being reflected by the reflective sheet 40, which will be described later, and being totally reflected at the light-exiting surface 19a, an opposite surface 19c, and the other peripheral end faces (the opposite end face 19d and the respective side end faces 19e). When the material of the light guide plate 19 is an acrylic resin such as PMMA, the refractive index is approximately 1.49, leading to the critical angle being approximately 42°, for example. Hereafter, the direction (X axis direction) along the pair of end faces (the long-side end faces, the side end faces 19e) of the peripheral end faces of the light guide plate 19 that are on opposite sides and that do not include the light-receiving face 19b is referred to as a “first direction,” the direction along the pair of end faces (short-side end faces, the light-receiving face 19b and the opposite end face 19d) that are on opposite sides and that include the light-receiving face 19b is referred to as a “second direction,” and the direction normal to the surface of the light guide plate 19 (the direction orthogonal to both the first direction and the second direction) is referred to as a “third direction.”

Of the surfaces of the light guide plate 19, the surface (the surface facing the reflective sheet 40 and a bottom plate 22a of the chassis 22) facing toward the rear (the side opposite to which light is emitted), or in other words, the surface opposite to the light-exiting surface 19a, is, as shown in FIGS. 3 and 4, the opposite surface 19c. The reflective sheet 40, which is able to reflect light from the light guide plate 19 and then orient this light toward the front, or in other words, toward the light-exiting surface 19a, is provided on the opposite surface 19c so as to substantially cover the entire opposite surface 19c. In other words, the reflective sheet 40 is disposed so as to be sandwiched between the bottom plate 22a of the chassis 22 and the light guide plate 19. The reflective sheet 40 has a reflective surface (reflective mirror surface) 40a that faces the opposite surface 19c of the light guide plate 19 and reflects light. The reflective surface 40a of the reflective sheet 40 has a silver color and is able to mirror-reflect light. The reflective sheet 40 is formed by using vapor deposition to deposit a thin metal film (a thin silver film, for example) on the surface of a film base material made of a synthetic resin, for example. As shown in FIG. 5, an edge of this reflective sheet 40 that is on the light-receiving face 19b side of the light guide plate 19 extends further outward than the light-receiving face 19b, or in other words, extends toward the LEDs 17, and as a result of light from the LEDs 17 being reflected by this extended section, the incidence efficiency of light entering the light-receiving face 19b can be improved.

As shown in FIGS. 2 to 4, the optical sheet 20 has a rectangular shape in a plan view, similar to the liquid crystal panel 11 and the chassis 22. The optical sheet 20 is disposed so as to overlap the front (light-emission side) of the light-exiting surface 19a of the light guide plate 19. In other words, as a result of the optical sheet 20 being disposed so as to be interposed between the liquid crystal panel 11 and the light guide plate 19, the optical sheet 20 transmits light emitted from the light guide plate 19, imparts prescribed optical effects on this transmitted light, and then emits this light toward the liquid crystal panel 11. The optical sheet 20 will be described in detail below.

As shown in FIGS. 3 and 4, the light-shielding frame 21 is formed in a substantially frame-like shape that extends so as to correspond to the peripheral section (peripheral edges) of the light guide plate 19, and is able to press along substantially the entire peripheral section of the light guide plate 19 from the front. The light-shielding frame 21 is made of a synthetic resin, and as a result of the surface thereof being colored black, for example, the frame 21 has light-shielding properties. The light-shielding frame 21 is disposed such that an inner edge 21a thereof is interposed between the LEDs 17/the peripheral section of the light guide plate 19 and the respective peripheral sections (peripheral edges) of the liquid crystal panel 11 and the optical sheet 20 along the entire periphery thereof, and the light-shielding frame 21 partitions these components so as to be optically independent. As a result, it is possible to block light that was emitted from the LEDs 17 and does not enter the light-receiving face 19b of the light guide plate 19 and light that leaks from the opposite end face 19d and the side end faces 19e from directly entering the respective peripheral sections (particularly the end faces) of the liquid crystal panel 11 and the optical sheet 20. In addition, the three sides (the pair of long sides and the short side opposite to the LED substrate 18 side) of the light-shielding frame 21 that do not overlap the LEDs 17 and the LED substrate 18 in a plan view have a section that rises from the bottom plate 22a of the chassis 22 and a section that supports the frame 13 from the rear. The short side of the light-shielding frame 21 that overlaps the LEDs 17 and the LED substrate 18 in a plan view covers the edge of the light guide plate 19 and the LED substrate 18 (LEDs 17) from the front and forms a bridge between the pair of long sides. The light-shielding frame 21 is fixed to the chassis 22, which will be described next, using a fixing means such as a screw member (not shown).

The chassis 22 is formed of a metal plate, such as an aluminum plate, an electro galvanized steel sheet (SECC), or the like, that has excellent thermal conductivity. As shown in FIGS. 3 and 4, the chassis 22 is formed of the bottom plate 22a that has a rectangular shape similar to that of the liquid crystal panel 11 in a plan view, and side walls 22b that respectively rise toward the front side from the outer edges of the respective sides (the pair of long sides and the pair of short sides) of the bottom plate 22a. The long-side direction of the chassis 22 (bottom plate 22a) corresponds to the X axis direction, and the short-side direction thereof corresponds to the Y axis direction. A light guide plate supporting section 22a1, which supports the light guide plate 19 from the rear (the side opposite to the light-exiting surface 19a), constitutes a large portion of the bottom plate 22a, and the edge of the bottom plate 22a that faces the LED substrate 18 is a substrate housing section 22a2 that protrudes toward the rear in a step-like shape. As shown in FIG. 5, the substrate housing section 22a2 has a substantially L-like shape in cross section, and is formed of a rising section 38 that curves from the edge of the light guide plate supporting section 22a1 and rises toward the rear, and a housing bottom section 39 that curves from the rising tip of the rising section 38 and protrudes toward the side opposite of the light guide plate supporting section 22a1. The location of the rising section 38 that curves from the edge of the light guide plate supporting section 22a1 is located further away from the LEDs 17 (closer to the center of the light guide plate supporting section 22a1) than the light-receiving face 19b of the light guide plate 19. The long-side side wall 22b is curved so as to rise toward the front from the protruding edge of the housing bottom section 39. The LED substrate 18 is attached to the short-side side wall 22b that is continuous with the substrate housing section 22a2, and this side wall 22b constitutes a substrate attaching member 37. The substrate attaching member 37 is an opposing surface that faces the light-receiving face 19b of the light guide plate 19, and the LED substrate 18 is attached to this opposing surface. The surface of the LED substrate 18 opposite to the mounting surface 18a on which the LEDs 17 are mounted is fixed so as to contact the inner surface of the substrate attaching member 37 via a substrate fixing member 25, such as double-sided tape. There is a small gap between the attached LED substrate 18 and the inner surface of the housing bottom section 39 that forms a part of the substrate housing section 22a2. In addition, the following are attached to the rear surface of the bottom plate 22a of the chassis 22: a liquid crystal panel driver circuit substrate (not shown) for controlling the driving of the liquid crystal panel 11; an LED driver circuit substrate (not shown) that provides driving power to the LEDs 17; a touch panel driver circuit substrate (not shown) for controlling the driving of the touch panel 14; and the like.

The heat-dissipating member 23 is formed of a metal plate that has excellent thermal conductivity such as an aluminum plate, for example, and as shown in FIG. 3, extends along one short-side edge of the chassis 22, specifically the substrate housing section 22a2 that houses the LED substrate 18. As shown in FIG. 5, the heat-dissipating member 23 is substantially L-shaped in cross section, and is formed of a first heat-dissipating section 23a that is parallel to and contacts the exterior of the substrate housing section 22a2, and a second heat-dissipating section 23b that is parallel to the exterior of the side wall 22b (the substrate attaching member 37) that is continuous with the substrate housing section 22a2. The first heat-dissipating section 23a has a long and narrow plate-like shape that extends along the Y axis direction, with the surface that faces toward the front and is parallel to the X axis direction and the Y axis direction abutting substantially the entire exterior of the housing bottom section 39 of the substrate housing section 22a2. The first heat-dissipating section 23a is screwed to the housing bottom section 39 via a screw member SM, and has a screw insertion hole 23a1 in which the screw member SM is inserted. A screw hole 28, which engages the screw member SM, is formed in the housing bottom section 39. As a result, heat generated by the LEDs 17 is transferred to the first heat-dissipating section 23a via the LED substrate 18, the substrate attaching member 37, and the substrate housing section 22a2. A plurality of screw members SM are attached to the first heat-dissipating section 23a in a row with gaps therebetween along the extension direction thereof. The second heat-dissipating section 23b has a narrow and flat plate-like shape that extends along the Y axis direction, with the surface that faces inward and is parallel to the Y axis direction and the Z axis direction being disposed so as to face the outer surface of the substrate attaching member 37 with a prescribed gap therebetween.

Next, the frame 13 that forms a part of the liquid crystal display unit LDU will be described. The frame 13 is formed of a metal material with excellent thermal conductivity, such as aluminum, and as shown in FIG. 1, has an overall rectangular, substantially frame-like shape in a plan view that extends so as to correspond to the respective peripheral sections (peripheral edges) of the liquid crystal panel 11, the touch panel 14, and the cover panel 15. Stamping or the like, for example, can be used as the manufacturing method of the frame 13. As shown in FIGS. 3 and 4, the frame 13 presses from the front upon the peripheral section of the liquid crystal panel 11, and sandwiches and supports the liquid crystal panel 11, the optical sheet 20, and the light guide plate 19 that are stacked upon each other between the frame 13 and the chassis 22 that forms a part of the backlight device 12. Meanwhile, the frame 13 receives the respective peripheral sections of the touch panel 14 and the cover panel 15 from the rear, and is disposed so as to be interposed between the peripheral sections of the liquid crystal panel 11 and touch panel 14. As a result, a prescribed gap is ensured to exist between the liquid crystal panel 11 and the touch panel 14. Thus, even if the cover panel 15 and touch panel 14 deform so as to bend toward the liquid crystal panel 11 when an external force is applied to the cover panel 15, for example, it is unlikely that the bent touch panel 14 will interfere with the liquid crystal panel 11.

As shown in FIGS. 3 and 4, the frame 13 is formed of: a frame section (frame base, frame-like section) 13a that corresponds to the respective peripheral sections of the liquid crystal panel 11, the touch panel 14, and the cover panel 15; the loop section (cylindrical section) 13b that is continuous with the peripheral edges of the frame section 13a and that surrounds the touch panel 14, cover panel 15, and casing 16, respectively, from the periphery; and an attachment plate 13c that protrudes from the frame section 13a toward the rear and is attached to the chassis 22 and the heat-dissipating member 23. The frame section 13a has a substantially plate-like shape that has a surface that is parallel to the respective surfaces of the liquid crystal panel 11, the touch panel 14, and the cover panel 15, and is formed in a rectangular frame-like shape when seen in a plan view. A peripheral section 13a2 of the frame section 13a is relatively thicker than an inner section 13a1. Thus, a step (gap) GP is formed at the bundary of the inner section 13a1 and the peripheral section 13a2. The inner section 13a1 of the frame section 13a is interposed between the peripheral section of the liquid crystal panel 11 and the peripheral section of the touch panel 14, while the peripheral section 13a2 receives the peripheral section of the cover panel 15 from the rear. In this manner, since substantially the entire front surface of the frame section 13a is covered by the cover panel 15, very little of the front surface is exposed to the exterior. As a result, even if the temperature of the frame 13 increases due to heat from the LEDs 17 or the like, it is unlikely that the user of the liquid crystal display device 10 will come into direct contact with the exposed section of the frame 13, which makes the display device 10 very safe. As shown in FIG. 5, a cushioning material 29, which cushions and presses upon the peripheral sections of the liquid crystal panel 11 from the front, is fixed to the rear surface of the inner section 13a1 of the frame section 13a, while a first fixing member 30, which cushions and fixes the peripheral sections of the touch panel 14, is fixed to the front surface of the inner section 13a1. The cushioning material 29 and the first fixing member 30 are disposed at respective locations of the inner section 13a1 so as to overlap each other in a plan view. Meanwhile, a second fixing member 31, which cushions and fixes the peripheral sections of the cover panel 15, is fixed to the front surface of the peripheral section 13a2 of the frame section 13a. The cushioning material 29 and the fixing members 30, 31 are disposed so as to respectively extend along the respective sides of the frame section 13a, excluding the four corner sections. In addition, the respective fixing members 30, 31 are formed of double-sided tape that has a base material that provides cushioning, for example.

As shown in FIGS. 3 and 4, the loop section 13b has a rectangular short square cylinder shape as a whole in a plan view and includes: a first loop section 34 that protrudes toward the front from the periphery of the peripheral section 13a2 of the frame section 13a; and a second loop section 35 that protrudes toward the rear from the periphery of the peripheral section 13a2 of the frame section 13a. In other words, the entire periphery of the frame section 13a is continuous with the inner peripheral surface of the loop section 13b, which forms a short square cylinder shape, with the frame section 13a being located at the substantial center of the loop section 13b in the axial direction (Z axis direction) thereof. The first loop section 34 is disposed so as to surround all of the respective peripheral end faces of the touch panel 14 and cover panel 15, which are disposed to the front of the frame section 13a. The inner peripheral surface of the first loop section 34 faces the respective peripheral end faces of the touch panel 14 and cover panel 15, while the outer peripheral surface is exposed to the exterior of the liquid crystal display device 10 and forms a part of the exterior of the side face of the liquid crystal display device 10. Meanwhile, the second loop section 35 surrounds from the periphery the front end (an attaching section 16c) of the casing 16 disposed to the rear of the frame section 13a. The inner peripheral surface of the second loop section 35 faces the attaching section 16c of the casing 16, which will be explained later, while the outer peripheral surface thereof is exposed to the exterior of the liquid crystal display device 10 and forms a part of the exterior of the side face of the liquid crystal display device 10. Frame-side locking teeth 35a that form a hook-like shape in cross-section are formed at the protruding tip of the second loop section 35. As a result of the casing 16 interlocking with these frame-side locking teeth 35a, it is possible for the casing 16 to be held in place.

As shown in FIGS. 3 and 4, the attachment plate 13c protrudes toward the rear from the peripheral section 13a2 of the frame section 13a and has a plate-like shape that extends along the respective sides of the frame section 13a. The surface of the attachment plate 13c is substantially orthogonal to the surface of the frame section 13a. Attachment plates 13c are individually disposed on each of the sides of the frame section 13a. The inward-facing surface of the attachment plate 13c that is disposed on the short side of the frame section 13a near the LED substrate 18 is attached so as to contact the outer surface of the second heat-dissipating section 23b of the heat-dissipating member 23. The attachment plate 13c is screwed to the second heat-dissipating section 23b via a screw member SM, and has a screw insertion hole 13c1 in which the screw member SM is inserted. A screw hole 36, which engages the screw member SM, is formed in the second heat-dissipating section 23b. As a result, heat generated by the LEDs 17 that is transmitted from the first heat-dissipating section 23a to the second heat-dissipating section 23b is transmitted to the entire frame 13 after being transmitted to the attachment plate 13c, and is therefore efficiently dissipated. In addition, the attachment plate 13c is indirectly fixed to the chassis 22 via the heat-dissipating member 23. Meanwhile, the respective attachment plates 13c disposed on the short side of the frame section 13a opposite to the LED substrate 18 and the pair of long sides of the frame section 13a, respectively, are respectively screwed via the screw member SM such that the inward-facing surface thereof contacts the outer surface of the respective side walls 22b of the chassis 22. The screw insertion holes 13c1, in which the screw members SM are inserted, are formed in the attachment plate 13c, while the screw holes 36, in which the screw members SM are engaged, are formed in the respective side walls 22b. The screw members SM are attached to the respective attachment plates 13c so as to be arranged in plurality with gaps therebetween along the respective extension directions of the attachment plates 13c.

Next, the touch panel 14 that is attached to the frame 13 will be described. As shown in FIGS. 1, 3, and 4, the touch panel 14 is a position input device that allows a user to input position information on the plane of the display surface DS of the liquid crystal panel 11. The touch panel 14 has a rectangular shape, and in the touch panel 14, a prescribed touch panel pattern (not shown) is formed on a glass substrate that is substantially transparent and has excellent light transmissivity. Specifically, the touch panel 14 includes a glass substrate, which has a rectangular shape similar to that of the liquid crystal panel 11 in a plan view. Touch panel transparent electrodes (not shown), which form a so-called projection-type capacitive touch panel pattern, are formed on the surface of the glass substrate that faces toward the front. The touch panel transparent electrodes are arranged in a matrix within the plane of the substrate. A terminal (not shown), which is connected to an end of wiring drawn out from the touch panel transparent electrodes that form the touch panel pattern, is formed on one short-side end of the touch panel 14. Potential is provided from a touch panel driver circuit substrate to the touch panel transparent electrodes that form the touch panel pattern as a result of a flexible substrate (not shown) being connected to the terminal. As shown in FIG. 5, the inner surface of the peripheral section of the touch panel 14 is fixed so as to face the inner section 13a1 of the frame section 13a of the frame 13 via the first fixing member 30 described above.

Next, the cover panel 15 that is attached to the frame 13 will be described. As shown in FIGS. 1, 3, and 4, the cover panel 15 is disposed so as to cover the entire touch panel 14 from the front, thereby protecting the touch panel 14 and liquid crystal panel 11. The cover panel 15 covers the entire frame section 13a of the frame 13 from the front and forms part of the front exterior of the liquid crystal display device 10. The cover panel 15 has a substantially rectangular shape in a plan view and is formed of a plate-shaped base material that is made of glass that is substantially transparent and has excellent light transmissivity. It is preferable that tempered glass be used in the cover panel 15. It is preferable that the tempered glass used for the cover panel 15 be a chemically-strengthened glass that includes a chemically-strengthened layer on the surface thereof formed by performing a type of chemical strengthening treatment on the surface of the plate-shaped glass base material, for example. This chemical strengthening treatment uses ion exchange to strengthen the plate-shaped glass base material by substituting an alkali metal ion contained in the glass material, for example, with an alkali metal ion that has a larger ion radius. The chemically-strengthened layer resulting from this treatment is a compressive strength layer (ion exchange layer) that has residual compressive stress. As a result, the cover panel 15 has high mechanical strength and shock resistance, thereby more reliably preventing damage or scratches on the touch panel 14 and the liquid crystal panel 11 disposed to the rear thereof.

As shown in FIGS. 3 and 4, the cover panel 15 has a rectangular shape similar to that of the liquid crystal panel 11 and the touch panel 14 in a plan view. The size of the cover panel 15 in a plan view is slightly larger than that of the liquid crystal panel 11 and the touch panel 14. Therefore, the cover panel 15 has an overhang section 15EP that protrudes outward in an eave-like shape along the entire respective peripheries of the liquid crystal panel 11 and the touch panel 14. The overhang section 15EP has a rectangular, substantially frame-like shape that surrounds the liquid crystal panel 11 and the touch panel 14. As shown in FIG. 5, the inner surface of the overhang section 15EP is fixed via the second fixing member 31 described above so as to face the peripheral section 13a2 of the frame section 13a of the frame 13. Meanwhile, the center of the cover panel 15, which faces the touch panel 14, is stacked to the front of the touch panel 14 with the anti-reflective film AR interposed therebetween.

As shown in FIGS. 3 and 4, a surface light-shielding layer (light-shielding layer, surface light-shielding member) 32 that blocks light is formed on the inner (rear) surface (surface facing the touch panel 14) of the peripheral section of the cover panel 15 that includes the above-described overhang section 15EP. The surface light-shielding layer 32 is made of a light-shielding material such as a black paint, for example, and this light-shielding material is printed onto the inner surface of the cover panel 15, and is thus integrally provided on this inner surface. When providing the surface light-shielding layer 32, printing methods such as screen printing or inkjet printing can be used, for example. The surface light-shielding layer 32 is formed not only along the entire overhang section 15EP of the cover panel 15, but is also formed along a portion of the cover panel 15 that is located inward of the overhang section 15EP and overlaps the respective peripheral sections of the touch panel 14 and liquid crystal panel 11 in a plan view. Therefore, since the surface light-shielding layer 32 is disposed so as to surround the display region of the liquid crystal panel 11, it is possible to block light from outside the display region, making it possible to increase the display quality of images displayed in the display region.

Next, the casing 16 that is attached to the frame 13 will be described. The casing 16 is formed of a synthetic resin material or a metal material. As shown in FIGS. 1, 3 and 4, the casing has a substantially bowl-shaped structure that opens toward the front, covers members such as the frame section 13a of the frame 13, the attachment plate 13c, the chassis 22, and the heat-dissipating member 23 from the rear, and forms part of the rear exterior of the liquid crystal display device 10. The casing 16 is formed of: a substantially flat bottom section 16a; a curved section 16b that rises from the periphery of the bottom section 16a toward the front and has a curved shape in cross section; and the attaching section 16c that rises substantially straight toward the front from the periphery of the curved section 16b. Casing-side locking teeth 16d that have a hook-like shape in cross-section are formed on the attaching section 16c. As a result of the casing-side locking teeth 16d interlocking with the frame-side locking teeth 35a of the frame 13, it is possible for the casing 16 to be held in place with respect to the frame 13.

As shown in FIG. 3, an exiting-light reflecting part 41, which facilitates the emission of light from the light-exiting surface 19a by reflecting light propagating within the light guide plate 19, is provided in the light guide plate 19 included in the backlight device 12 with the configuration described above. A light-condensing effect is selectively applied in only the first direction to the light reflected by the exiting-light reflecting part 41, and the emission of light is facilitated as a result of the angle of incidence on the light-exiting surface 19a being likely to be less than or equal to the critical angle. The specific configuration and the like of the exiting-light reflecting part 41 will be described in detail later.

The backlight device 12 according to the present embodiment includes a configuration for condensing exiting light in the second direction (Y axis direction). The reason for this configuration, and the configuration itself, will be explained below. As shown in FIGS. 3 and 5, light that propagates within the light guide plate 19 is reflected by reflective units 41a that form the exiting-light reflecting part 41 while propagating through the light guide plate 19, resulting in the angle of incidence at the light-exiting surface 19a being less than or equal to the critical angle and the light therefore being emitted. Thus, in the first direction (X axis direction), light is reflected by the reflective units 41a, resulting in light being condensed toward the front along the front surface direction, or in other words, along the direction normal to the light-exiting surface 19a. However, while the exiting-light reflecting part 41 imparts a light-condensing effect on reflected light in the first direction, very little light-condensing effect is imparted on reflected light in the second direction; thus, there is a possibility of anisotropy occurring in the brightness of light emitted from the light-exiting surface 19a. To this end, light is condensed in the second direction in the present embodiment using the configuration which will be described next. In other words, as shown in FIG. 2, the optical sheet 20 is formed of one prism sheet (a light-emission side anisotropic light-condensing part) 42 that has light-condensing anisotropy in which a light-condensing effect is selectively imparted to transmitted light in the second direction, while a light-exiting surface prism unit (light-exiting surface anisotropic light-condensing part) 43, which has light-condensing anisotropy that selectively imparts a light-condensing effect in the second direction on light reflected by the exiting-light reflecting part 41, is provided on the light-exiting surface 19a of the light guide plate 19.

Meanwhile, since a plurality of LEDs 17 are arranged with gaps therebetween along the second direction, or in other words, along the lengthwise direction of the light-receiving face 19b of the light guide plate 19, light that enters the light-receiving face 19b from the respective LEDs 17 tends to be insufficiently mixed near the light-receiving face 19b in the first direction, resulting in an increased likelihood of uneven brightness in the second direction for light emitted from the light-exiting surface 19a. To this end, uneven brightness that may occur in emitted light is mitigated in the second direction in the present embodiment as a result of the configuration that will be described next. In other words, as shown in FIG. 2, the light-exiting surface prism unit 43, which totally reflects light that propagates within the light guide plate 19 so as to diffuse the light in the second direction, is provided on the light-exiting surface 19a of the light guide plate 19, while an opposite surface convex lenticular lens unit (opposite surface anisotropic light-condensing part) 44, which totally reflects light that propagates within the light guide plate 19 so as to diffuse the light in the second direction, is provided on the opposite surface 19c of the light guide plate 19. Next, the prism sheet 42, the light-exiting surface prism unit 43, and the opposite surface convex lenticular lens unit 44 will be described in detail.

As shown in FIGS. 2 and 9, the prism sheet 42 is formed of: a sheet-shaped sheet base material 42b; and light-emission side unit prisms (light-emission side unit condensing members) 42a that are formed on a light-emission surface 42b2 of the sheet base material 42b that is on the opposite side of a light-entering surface 42b1 (is on the light-emission side). At the light-entering surface 42b1, light emitted from the light guide plate 19 enters the prism sheet 42. The sheet base material 42b is formed of a substantially transparent synthetic resin, and is specifically made of a thermoplastic resin material such as PET, for example, with the refractive index thereof being approximately 1.667, for example. The light-emission side unit prisms 42a are integrally provided on the light-emission surface 42b2, which is the front (light-emission side) surface of the sheet base material 42b. The light-emission side unit prisms 42a are formed of a substantially transparent ultraviolet-curable resin material, which is one type of photocurable resin material. For example, when the prism sheet 42 is manufactured, a mold used in molding is filled with uncured ultraviolet-curable resin material, and the sheet base material 42b is attached to the open end of the mold, thereby disposing the uncured ultraviolet-curable resin material so as to contact the light-emission surface 42b2. By then irradiating the ultraviolet-curable resin material with ultraviolet radiation through the sheet base material 42b in this state, it is possible to cure the ultraviolet-curable resin material and integrally provide the light-emission side unit prisms 42a on the sheet base material 42b. The ultraviolet-curable resin material that forms the light-emission side unit prisms 42a is an acrylic resin such as PMMA, for example, with the refractive index thereof being approximately 1.59, for example. The light-emission side unit prisms 42a are provided so as to protrude from the light-emission surface 42b2 of the sheet base material 42b toward the front (the light-emission side) along the third direction (Z axis direction). These light-emission side unit prisms 42a have a substantially triangular shape (are substantially ridge-shaped) in a cross-section cut along the second direction (Y axis direction) and extend in a straight line along the first direction (X axis direction). A plurality of light-emission side unit prisms 42a are arranged along the second direction on the light-emission surface 42b2. The width dimension (the dimension in the second direction) of the light-emission side unit prisms 42a is fixed along the entire length in the first direction. The respective light-emission side unit prisms 42a have a substantially isosceles triangle shape in cross-section and include a pair of inclined surfaces 42a1. The vertex angle ζv1 of the inclined surfaces 42a1 is approximately and substantially that of a right angle (90°). For the plurality of light-emission side unit prisms 42a arranged in a row along the second direction, the vertex angles θv1, the width dimensions of bottom surfaces 42a2, and the height dimensions are all substantially identical. The arrangement interval between adjacent light-emission side unit prisms 42a is substantially fixed, with the light-emission side unit prisms 42a being arranged with equal gaps therebetween.

When light enters the prism sheet 42 with such a configuration from the light guide plate 19, this light, as shown in FIG. 9, enters the light-entering surface 42b1 of the sheet base material 42b from a layer of air located between the light-exiting surface 19a of the light guide plate 19 and the sheet base material 42b of the prism sheet 42; thus, the light is refracted at the interface thereof in accordance with the angle of incidence. Light is also refracted at an interface in accordance with an angle of incidence when light that has passed through the sheet base material 42b enters the light-emission side unit prisms 42a from the light-emission surface 42b2 of the sheet base material 42b. Then, when light that has passed through the light-emission side unit prisms 42a reaches the inclined surfaces 42a1 of the light-emission side unit prisms 42a, if the angle of incidence is greater than the critical angle, the light is totally reflected and is returned back (is retro-reflected) toward the sheet base material 42b. On the other hand, if the angle of incidence does not exceed the critical angle, the light is refracted at the interface and then emitted. Of the light emitted from the inclined surfaces 42a1 of the light-emission side unit prisms 42a, light that is oriented toward an adjacent light-emission side unit prism 42a enters that light-emission side unit prism 42a and is then returned toward the sheet base material 42b. As a result, light emitted from the light-emission side unit prisms 42a is restricted in the second direction such that the propagation direction approaches the front surface direction, resulting in a light-condensing effect being selectively imparted in the second direction.

Next, the light-exiting surface prism unit 43 disposed on the light-exiting surface 19a side of the light guide plate 19 will be described. The light-exiting surface prism unit 43 is integrally formed on the light guide plate 19. In order to integrally provide the light-exiting surface prism unit 43 on the light guide plate 19, the light guide plate 19 may be manufactured by injection molding, and a transfer shape for transferring the light-exiting surface prism unit 43 may be formed beforehand on the molding surface of the mold used to form the light-exiting surface 19a, for example. As shown in FIGS. 2, 6, and 9, the light-exiting surface prism unit 43 is formed of a light-exiting surface unit prism (light-exiting surface light-condensing unit) 43a that extends along the first direction (X axis direction) and is arranged in plurality along the second direction (Y axis direction) on the light-exiting surface 19a. The light-exiting surface unit prisms 43a are provided so as to protrude from the light-exiting surface 19a toward the front (the light-emission side) along the third direction (Z axis direction). The light-exiting surface unit prisms 43a have a substantially triangular shape (are substantially ridge-shaped) in a cross-section cut along the second direction and extend in a straight line along the first direction. The width dimension (the dimension in the second direction) of the light-exiting surface unit prisms 43a is fixed along the entire length in the first direction. The respective light-exiting surface unit prisms 43a have a substantially isosceles triangle shape in cross-section. The respective light-exiting surface unit prisms 43a include a pair of inclined surfaces 43a1, and it is preferable that a vertex angle θv2 thereof be obtuse (an angle greater than 90°), specifically between 100° and 150°, with approximately 140° being the most preferable. In other words, the vertex angle θv2 of the light-exiting surface unit prisms 43a is relatively larger than the vertex angle θv1 of the light-emission side unit prisms 42a. For the plurality of light-exiting surface unit prisms 43a arranged along the second direction, the vertex angles θv2, the width dimensions of the bottom surfaces, and the height dimensions are all substantially identical, and the arrangement interval between adjacent light-exiting surface unit prisms 43a is substantially fixed, with the light-exiting surface unit prisms 43a being arranged with equal gaps therebetween.

As shown in FIG. 9, the light-exiting surface prism unit 43 with such a configuration imparts an optical effect in the following manner on light that propagates within the light guide plate 19 and reaches the light-exiting surface 19a. That is, when light that has reached the light-exiting surface 19a enters the inclined surfaces 43a1 of the light-exiting surface unit prisms 43a at an angle of incidence that is less than or equal to the critical angle, that light is refracted by the inclined surfaces 43a1 and is then emitted, resulting in the light being selectively condensed in the second direction. In this manner, light to which a light-condensing effect has been imparted by the light-exiting surface prism unit 43 is more likely to become condensed in the second direction in the prism sheet 42, and as a result, the front surface brightness of light emitted from the prism sheet 42 is further improved. A portion of the light refracted by the inclined surfaces 43a1 of the light-exiting surface unit prisms 43a contains light on which the above-mentioned anisotropic light-condensing effect is not imparted, and there are instances in which an optical effect that diffuses this light in the second direction is imparted. Meanwhile, when light that has reached the light-exiting surface 19a enters the inclined surfaces 43a1 of the light-exiting surface unit prisms 43a at an angle of incidence that is greater than the critical angle, the light is totally reflected by the inclined surfaces 43a1, and is thus returned back (retro-reflected) toward the opposite surface 19c. Light that is totally reflected by the inclined surfaces 43a1 of the light-exiting surface unit prisms 43a propagates so as to diffuse in the second direction while being transmitted within the light guide plate 19; thus, uneven brightness is less likely to occur in the second direction for light that is thereafter reflected by the exiting-light reflecting part 41 and then emitted from the light-exiting surface 19a.

Next, the opposite surface convex lenticular lens unit 44 disposed on the opposite surface 19c side of the light guide plate 19 will be described. The opposite surface convex lenticular lens unit 44 is integrally formed on the light guide plate 19. In order to integrally provide the opposite surface convex lenticular lens unit 44 on the light guide plate 19, the light guide plate 19 may be manufactured using injection molding, and a transfer shape for transferring the opposite surface convex lenticular lens unit 44 may be formed beforehand on the molding surface of the mold used to form the opposite surface 19c, for example. As shown in FIGS. 2, 7, and 9, the opposite surface convex lenticular lens unit 44 is formed of an opposite surface convex cylindrical lens (opposite surface light-condensing unit, opposite surface cylindrical lens) 44a that extends along the first direction (X axis direction) and is arranged in a plurality along the second direction (Y axis direction) on the opposite surface 19c. The opposite surface convex cylindrical lenses 44a are provided so as to protrude from the opposite surface 19c toward the rear (the side opposite to the light-emission side) along the third direction (Z axis direction), and are thus convex lenses. The opposite surface convex cylindrical lenses 44a have a substantially semicircular column shape in which the axial direction thereof corresponds to the first direction, and the surface that faces toward the rear (toward the reflective sheet 40) has a convex curved surface 44a1 that has an arc-like shape. The opposite surface convex cylindrical lenses 44a have a substantially semicircular shape (semicylindrical shape) in a cross section cut along the alignment direction (second direction) that is orthogonal to the extension direction (first direction). The width dimension (the dimension in the second direction) of the opposite surface convex cylindrical lenses 44a is fixed along the entire length in the first direction. When an angle θt formed between the second direction and a tangent line Ta at a base section 44a2 of the curved surface 44a1 of the opposite surface convex cylindrical lens 44a is defined as a “tangential angle,” the tangential angle θt is approximately 70°, for example. For the plurality of opposite surface convex cylindrical lenses 44a arranged along the second direction, the tangential angles θt, the width dimensions of the bottom surfaces, and the height dimensions are all substantially identical, and the arrangement interval between adjacent opposite surface convex cylindrical lenses 44a is substantially fixed, with the opposite surface convex cylindrical lenses 44a being arranged with equal gaps therebetween. In this manner, the opposite surface 19c of the light guide plate 19 has protrusions and recesses as a result of the opposite surface convex lenticular lens unit 44 being provided. As a result, prescribed gaps C are provided between the reflective sheet 40 and the plurality of opposite surface convex cylindrical lenses 44a aligned along the second direction. The gap C is interposed between the opposite surface 19c of the light guide plate 19 and the reflective sheet 40, and is an air layer with a refractive index of approximately 1.0. In addition, the height dimension (the dimension along the third direction) of the gap C changes in accordance with the location in the second direction (X axis direction). Specifically, the height dimension decreases moving in the second direction from the center of the opposite surface convex cylindrical lens 44a toward both edges, and the rate of change depends on the curvature of the opposite surface convex cylindrical lens 44a.

As shown in FIG. 9, the opposite surface convex cylindrical lenses 44a with such a configuration impart an optical effect in the following manner on light that propagates within the light guide plate 19 and reaches the opposite surface 19c. That is, when light that has reached the opposite surface 19c enters the curved surface 44a1 of the opposite surface convex cylindrical lens 44a at an angle of incidence that is greater than the critical angle, the light is totally reflected by the curved surface 44a1, resulting in the light propagating so as to be diffused in the second direction while travelling through the light guide plate 19. Light that is totally reflected by the curved surface 44a1 of the curved surface 44a1 is diffused to a greater degree in the second direction compared to the light that is totally reflected by the inclined surface 43a1 of the light-exiting surface unit prism 43a. As a result, uneven brightness is less likely to occur in the second direction for light that is thereafter reflected by the exiting-light reflecting part 41 and then emitted from the light-exiting surface 19a. Meanwhile, when light that has reached the opposite surface 19c enters the curved surface 44a1 of the opposite surface convex cylindrical lens 44a at an angle of incidence that is less than or equal to the critical angle, the light is refracted by the curved surface 44a1 and emitted toward the gap C between the opposite surface convex cylindrical lens 44a and the reflective sheet 40. Light that is emitted toward the gap C is reflected by the reflective surface 40a of the reflective sheet 40, and then once again reaches the opposite surface 19c, after which the light enters the curved surface 44a1 of the opposite surface convex cylindrical lens 44a, and is once again refracted. In this manner, an anisotropic light-condensing effect, or in other words, a selective light-condensing effect in the second direction, is imparted by the opposite surface convex cylindrical lenses 44a to a portion of the light entering or leaving the opposite surface 19c via the gap C when the light enters or leaves the opposite surface 19c. Meanwhile, an optical effect that diffuses light in the second direction is imparted on the light upon which the anisotropic light-condensing effect is not imparted when the light enters or leaves the opposite surface 19c. It is unlikely that light upon which the anisotropic light-condensing effect has been imparted by the opposite surface convex cylindrical lenses 44a will become condensed in the second direction at the prism sheet 42, and is instead more likely to be diffused in the second direction. Thus, while there will be an improvement in uneven brightness in light emitted from the prism sheet 42, no contribution will be made toward improving the front surface brightness.

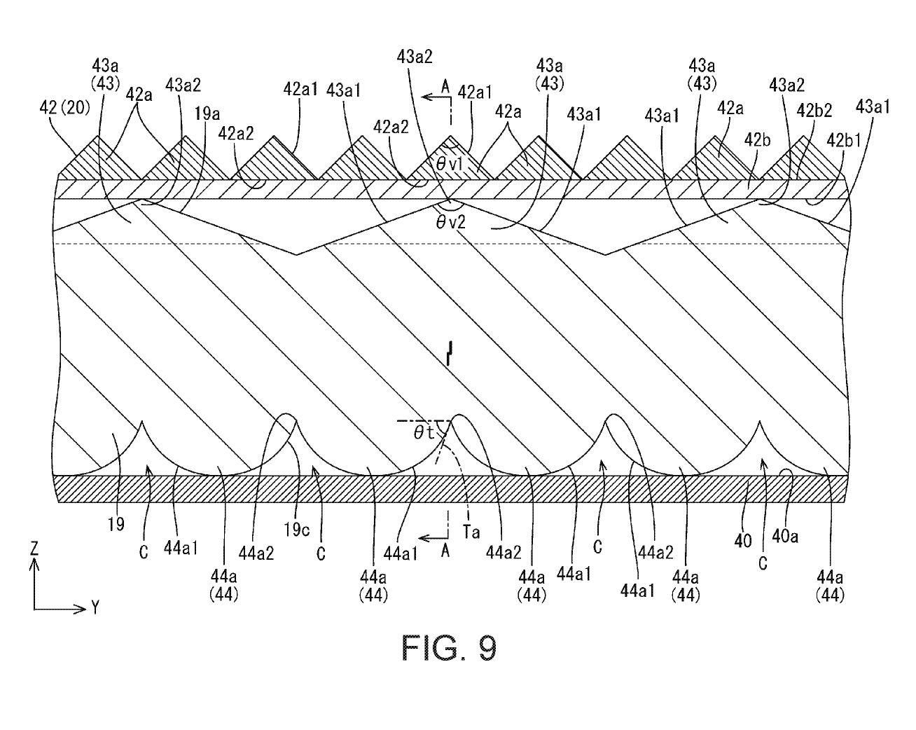

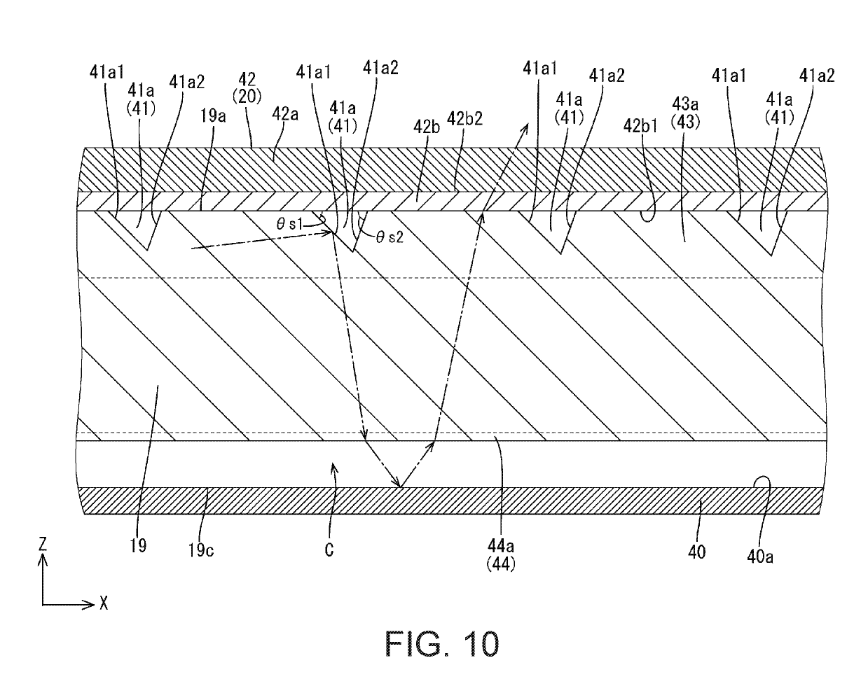

As described above, light that is emitted from the LEDs 17 and then enters the light-receiving face 19b of the light guide plate 19 is, as shown in FIGS. 9 and 10, totally reflected by the opposite surface convex lenticular lens unit 44 disposed on the opposite surface 19c and the light-exiting surface prism unit 43 disposed on the light-exiting surface 19a when the light travels through the light guide plate 19 while propagating toward the opposite end face 19d in the first direction. This light is therefore widely diffused in the second direction. As a result, light that travels within the light guide plate 19 is suitably mixed in the second direction, which is the alignment direction of the LEDs 17; thus, uneven brightness is less likely to occur in the second direction for light that is thereafter emitted from the light-exiting surface 19a. Meanwhile a light-condensing effect is selectively imparted in the second direction, via the light-exiting surface prism unit 43 and/or the opposite surface convex lenticular lens unit 44, upon at least a portion of the light that is reflected by the exiting-light reflecting part 41 while travelling within the light guide plate 19, after which the light is emitted from the light-exiting surface 19a. At such time, there is a possibility that the light upon which the anisotropic light-condensing effect was imparted by the opposite surface convex lenticular lens unit 44 may be unlikely to become condensed in the second direction at the prism sheet 42, while the light upon which the opposite surface convex lenticular lens unit 44 did not impart an anisotropic light-condensing effect and the light-exiting surface prism unit 43 did impart an anisotropic light-condensing effect is likely to become condensed in the second direction at the prism sheet 42. As a result, the front surface brightness for light emitted from the prism sheet 42 will be improved.

As shown in FIG. 9 and described above, the vertex angle θv1 of the light-emission side unit prisms 42a of the prism sheet 42 is smaller than the vertex angle θv2 of the light-exiting surface unit prisms 43a; thus, the prism sheet 42 will retro-reflect more light than the light-exiting surface prism unit 43, the angle range for the angle of emergence of the emitted light will be more narrow, and the prism sheet 42 will therefore have the strongest light-condensing effect. In contrast, the light provided to the prism sheet 42 has, at a minimum, received an anisotropic light-condensing effect by the light-exiting surface prism unit 43 at the light-exiting surface 19a of the light guide plate 19. Thus, the ratio of retro-reflection at the light-emission side unit prisms 42a forming a part of the prism sheet 42 is low, resulting in light being effectively emitted from the light-emission side unit prisms 42a. As a result, light usage efficiency is higher, and the brightness of the light emitted from the backlight device 12 suitably improves.

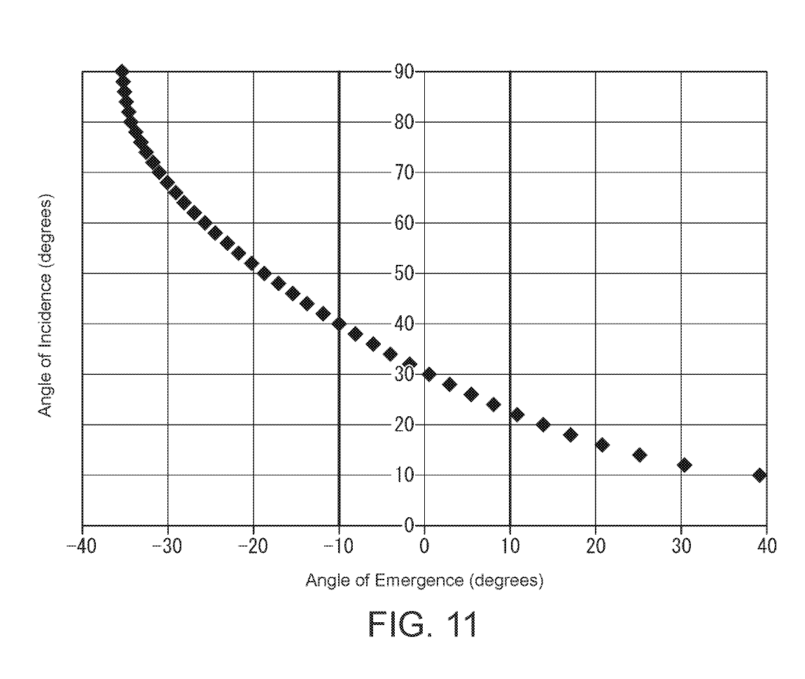

The following test was conducted in order to determine at what angles light provided to the prism sheet 42 would contribute toward improving the front surface brightness of the light emitted from the prism sheet 42. That is, the relationship between the angle of incidence of light entering the light-entering surface 42b1 of the sheet base material 42b of the prism sheet 42 and the angle of emergence of light emitted from the inclined surface 42a1 of the light-emission side unit prisms 42a was calculated in accordance with Snell's law, and the results are shown in FIG. 11. As the specific method of calculation, the angle of emergence of light from the light-entering surface 42b1 was obtained based on the angle of incidence of light at the light-entering surface 42b1. Next, the angles of emergence of light from the light-emission surface 42b2 and the bottom surface 42a2 of the light-emission side unit prisms 42a was obtained based on the fact that the angle of emergence of light from the light-entering surface 42b1 was identical to the angles of incidence of light at the light-emission surface 42b2 and the bottom surface 42a2 of the light-emission side unit prisms 42a (see FIG. 9). The angle of emergence of light from the inclined surfaces 42a1 of the light-emission side unit prisms 42a was then obtained based on the fact that the angle of emergence of light from the light-emission surface 42b2 and the bottom surface 42a2 of the light-emission side unit prisms 42a was identical to the angle of incidence of light at the inclined surfaces 42a1 of the light-emission side unit prisms 42a (see FIG. 9). The respective refractive indices of the sheet base material 42b and the light-emission side unit prisms 42a and the vertex angle θv1 of the light-emission side unit prisms 42a are as described above, and the calculations were conducted using a refractive index of “1.0” for the external air layer. In FIG. 11, the vertical axis indicates the angle of incidence (in degrees) of light at the light-entering surface 42b1 of the sheet base material 42b, and the horizontal axis is the angle of emergence (in degrees) of light from the inclined surfaces 42a1 of the light-emission side unit prisms 42a. An angle of emergence of 0° is the angle of emergence for light that is parallel to the front surface direction. According to FIG. 11, it can be seen that in order to set the angle of emergence of light from the inclined surfaces 42a1 of the light-emission side unit prisms 42a to a range of±10°, for example, the angle of incidence of light at the light-entering surface 42b1 of the sheet base material 42b should be set to between 23° and 40°. In other words, if the angle of emergence of the light provided to the prism sheet 42, or in other words, the light emitted from the light-exiting surface 19a of the light guide plate 19, is set to between 23° and 40°, the light emitted from the light-emission side unit prisms 42a of the prism sheet 42 will be emitted at an angle of emergence of±10° with respect to the front surface direction, which would be useful in improving the front surface brightness of emitted light. In the present embodiment, light upon which an anisotropic light-condensing effect has been imparted by the light-exiting surface prism unit 43 of the light guide plate 19 tends to include a large amount of light in which the angle of emergence when the light is emitted from the light-exiting surface 19a is between 23° and 40°. Meanwhile, light upon which an anisotropic light-condensing effect has been imparted by the opposite surface convex lenticular lens unit 44 also tends to include a large amount of light in which the angle of emergence when the light is emitted from the light-exiting surface 19a is between 23° and 40°.

As shown in FIG. 10, the light guide plate 19 according to the present embodiment is characterized by the exiting-light reflecting part 41, which facilitates the emission of light from the light-exiting surface 19a by reflecting light that travels within the light guide plate 19, being disposed on the light-exiting surface 19a. If the exiting-light reflecting part 41 is disposed on the light-exiting surface 19a side of the light guide plate 19 in such a manner, it is possible to cause light reflected by the exiting-light reflecting part 41 to be emitted from the light-exiting surface 19a by initially orienting the light toward the opposite surface 19c, reflecting the light via the reflective sheet 40 disposed on the opposite surface 19c side of the light guide plate 19, and then once again orienting the light toward the light-exiting surface 19a. In other words, the optical path from when light is reflected by the exiting-light reflecting part 41 until the light is emitted from the light-exiting surface 19a becomes complex, and the light will be refracted on at least two particular occasions: when the light is emitted from the opposite surface 19c toward the reflective sheet 40, and when the light enters the opposite surface 19c from the reflective sheet 40. As a result of this refraction, light is more likely to be diffused in the second direction; thus light is well-mixed in the second direction and uneven brightness is less likely to occur in the second direction for light emitted from the light-exiting surface 19a. In addition, the reflective sheet 40 mirror-reflects light from the opposite surface 19c of the light guide plate 19 via the reflective surface 40a; thus, light is more suitably diffused in the second direction via the refractive effect imparted when light enters and exits and the opposite surface 19c. In order to integrally provide the exiting-light reflecting part 41 on the light guide plate 19, the light guide plate 19 may be formed by injection molding, and a transfer shape for transferring the exiting-light reflecting part 41 may be formed beforehand on the molding surface of the mold used to form the light-exiting surface 19a, for example.

As shown in FIG. 10, the exiting-light reflecting part 41 is formed of the groove-shaped reflective unit (unit exiting-light reflecting member) 41a that is arranged (disposed intermittently) in plurality with gaps therebetween in a row along the first direction (X axis direction), extends along the second direction (Y axis direction), and has a substantially triangular (substantially V-like) shape in cross-section. A reflective unit 41a includes: a primary reflective surface 41a1 disposed on the LED 17 side (light-receiving face 19b side) in the first direction; and a re-receiving face 41a2 disposed on the side (the opposite end face 19d side) opposite of the LED 17 side in the first direction. The primary reflective surface 41a1 is an inclined surface that is inclined downward so as to gradually move away from the light-exiting surface 19a (approach the opposite surface 19c) moving toward the side (the opposite end face 19d side) opposite of the LED 17 side in the first direction. The re-receiving face 41a2 is an inclined surface that is inclined upward so as to gradually approach the light-exiting surface 19a (move away from the opposite surface 19c) moving toward the side opposite of the LED 17 side in the first direction. It is preferable that an angle of inclination θs1 of the primary reflective surface 41a1 with respect to the light-exiting surface 19a and the opposite surface 19c be between 40° and 50°, for example. In FIG. 10, the angle of inclination θs1 is approximately 45°. It is preferable that an angle of inclination θs2 of the re-receiving face 41a2 with respect to the light-exiting surface 19a and the opposite surface 19c be between 70° and 85°, for example. In FIG. 10, the angle of inclination θs2 is approximately 80°. In other words, the angle of inclination θs1 of the primary reflective surface 41a1 is smaller than the angle of inclination θs2 of the re-receiving face 41a2. The reflective units 41a reflect light at the primary reflective surface 41a1 disposed on the light-receiving face 19b side in the first direction, making it possible to create light in which the angle of incidence with respect to the light-exiting surface 19a does not exceed the critical angle, which facilitates the emission of light from the light-exiting surface 19a. In contrast, when light for which the angle of incidence with respect to the primary reflective surface 41a1 does not exceed the critical angle passes through the primary reflective surface 41a1, the re-receiving face 41a2 of the reflective unit 41a is able to cause the transmitted light to once again enter the light guide plate 19. The plurality of reflective units 41a aligned along the first direction are arranged such that, moving away from the light-receiving face 19b (the LEDs 17) in the first direction, the height dimension (dimension in the third direction) thereof gradually increases and the area (surface area) of the primary reflective surface 41a1 and the re-receiving face 41a2 gradually increases. As a result, the light emitted from the light-exiting surface 19a is controlled so as to have an even distribution within the plane of the light-exiting surface 19a. The reflective units 41a are disposed such that the arrangement interval (arrangement pitch) thereof in the first direction is substantially fixed irrespective of the distance from the LEDs 17.

Next, Comparative Experiment 1 was carried out in order to determine whether or not uneven brightness would occur in light emitted from the light-exiting surface in a case in which, as in the present embodiment, the exiting-light reflecting part 41 was provided on the light-exiting surface 19a of the light guide plate 19, and a case in which the exiting-light reflecting part was provided on the opposite surface of the light guide plate. In Comparative Experiment 1, Working Example 1 was the light guide plate 19 in which the exiting-light reflecting part 41 and the light-exiting surface prism unit 43 were provided on the light-exiting surface 19a and the opposite surface convex lenticular lens unit 44 was provided on the opposite surface 19c. Comparison Example 1 was a light guide plate in which the light-exiting surface prism unit was provided on the light-exiting surface and the exiting-light reflecting part and the opposite surface convex lenticular lens unit were provided on the opposite surface. The light guide plate 19 according to Working Example 1 is identical to that described above. The light guide plate according to Comparison Example 1 has a configuration identical to that of the light guide plate 19 according to Working Example 1, other than the placement of the exiting-light reflecting part.

In Comparative Experiment 1, for the respective backlight devices that utilized the respective light guide plates according to Comparison Example 1 and Working Example 1, pictures were taken from the light-exiting surface side when light from the LEDs was caused to enter the light-receiving face of the light guide plate and then exit from the light-exiting surface. In accordance with these pictures, a determination was made on whether or not there was uneven brightness, and these experiment results are shown in the table in FIG. 12. The backlight devices used in this experiment were identical to that described above, other than the differences between the respective light guide plates of Comparison Example 1 and Working Example 1. FIG. 12 shows pictures taken from the light-exiting surface side when light was emitted from the light-exiting surface of the respective light guide plates according to Comparison Example 1 and Working Example 1, and FIG. 12 also shows the determination results regarding uneven brightness that were based on the pictures. The pictures shown in FIG. 12 specifically captured the portion of the light-exiting surface of the light guide plate that was near the light-receiving face, and is arranged such that the LEDs are disposed at the bottom of the picture. According to FIG. 12, uneven brightness is visible for the light guide plate according to Comparison Example 1, while there is almost no uneven brightness visible for the light guide plate 19 according to Working Example 1. Specifically, since the light guide plate according to Comparison Example 1 has a configuration in which the exiting-light reflecting part is disposed on the opposite surface, the light reflected by this exiting-light reflecting part is immediately oriented toward and then emitted from the light-exiting surface. Thus, it is unlikely that light reflected by the exiting-light reflecting part will be diffused in the second direction, resulting in uneven brightness in the light emitted from the light-exiting surface 19a, with light sections and dark sections being alternately disposed in the second direction. In contrast, the light guide plate 19 according to Working Example 1 has a configuration in which the exiting-light reflecting part 41 is disposed on the light-exiting surface 19a. As a result, light reflected by the exiting-light reflecting part 41 is initially oriented toward the opposite surface 19c and is reflected by the reflective sheet 40 disposed near the opposite surface 19c, which makes it possible for the light to be emitted from the light-exiting surface 19a once the light has once again been oriented toward the light-exiting surface 19a. In other words, in the light guide plate 19 according to Working Example 1, the optical path from when light is reflected by the exiting-light reflecting part 41 until the light is emitted from the light-exiting surface 19a is more complex than in Comparison Example 1. Specifically, there are two opportunities for a refractive effect to be imparted on the light: when the light is emitted from the opposite surface 19c toward the reflective sheet 40, and when the light enters the opposite surface 19c from the reflective sheet 40. Thus, there are more opportunities for a refractive effect to be imparted compared to Comparison Example 1 (see FIG. 10). In this manner, in the light guide plate 19 according to Working Example 1, a refractive effect is imparted on light reflected by the exiting-light reflecting part 41 every time the light enters or exits the opposite surface 19c, making it easier for light to be diffused in the second direction, which results in the light being well-mixed in the second direction. Therefore, in the light guide plate 19 according to Working Example 1, light and dark sections are less likely to occur in the second direction for light emitted from the light-exiting surface 19a, and very little uneven brightness is visible.

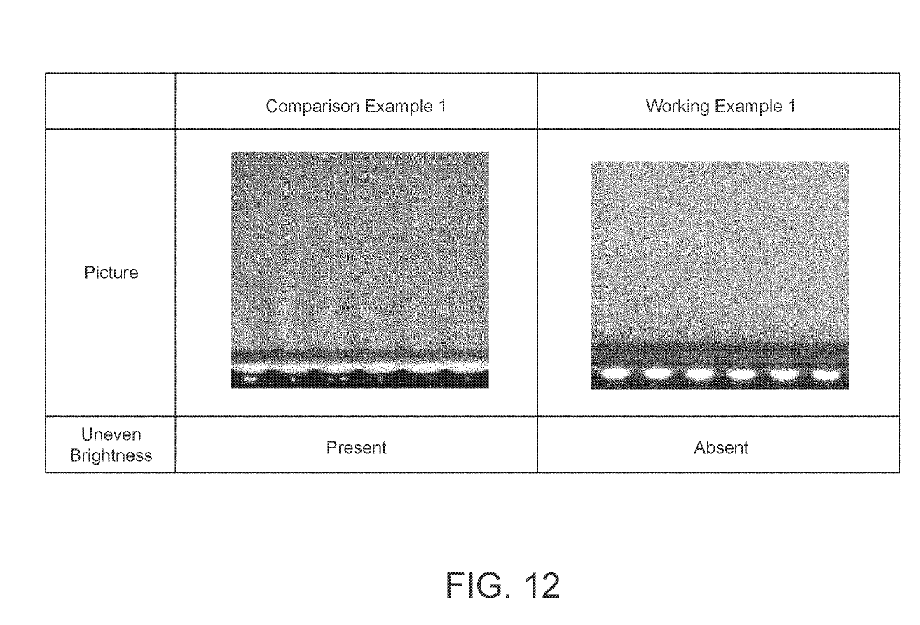

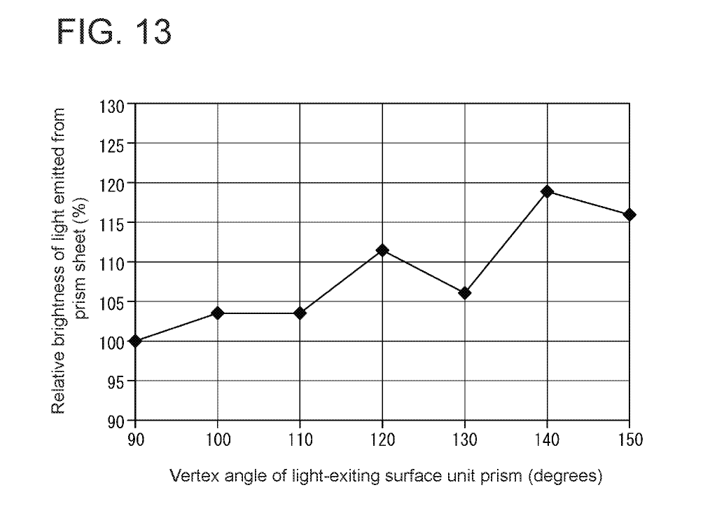

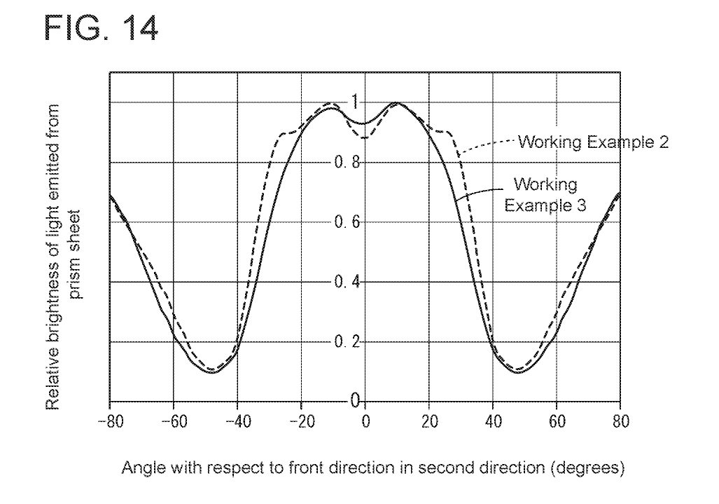

Next, Comparative Experiment 2 was carried out in order to determine how brightness would change when the vertex angle θv2 of the light-exiting surface unit prisms 43a forming the light-exiting surface prism unit 43 was changed in the light guide plate 19 in which, as in the present embodiment, the exiting-light reflecting part 41 and the light-exiting surface prism unit 43 were disposed on the light-exiting surface 19a and the opposite surface convex lenticular lens unit 44 was disposed on the opposite surface 19c. In Comparative Experiment 2, measurements were taken regarding how the brightness of emitted light obtained by causing the light emitted from the light-exiting surface 19a of the light guide plate 19 to pass through the prism sheet 42 stacked on the light-emission side of the light guide plate 19 changed as the vertex angle θv2 changed. In this experiment, the light guide plate 19 according to Working Example 1 described for Comparative Experiment 1 was used and the vertex angle θv2, which was the vertex angle of the light-exiting surface unit prisms 43a forming the light-exiting surface prism unit 43, was changed to various values between 90° and 150°. These results are shown in FIG. 13. The prism sheet 42 used in Comparative Experiment 2 is identical to that described above. In FIG. 13, the horizontal axis is the vertex angle θv2 (in degrees) of the light-exiting surface unit prisms 43a, and the vertical axis is the relative brightness (in %) of the light emitted from the prism sheet 42. The relative brightness of the emitted light indicated by the vertical axis in FIG. 13 is a relative value in which the brightness value when the vertex angle θv2 of the light-exiting surface unit prisms 43a is set to 90° is used as a baseline (100%). Furthermore, in Comparative Experiment 2, a case in which the vertex angle θv2 of the light-exiting surface unit prisms 43a was set to 90° was defined as Working Example 2, and a case in which the vertex angle θv2 of the light-exiting surface unit prisms 43a was set to 140° was defined as Working Example 3. The brightness distributions for emitted light obtained by causing the light emitted from the respective light guide plates 19 of Working Examples 2 and 3 to pass through the prism sheet 42 were measured, and these results are shown in FIG. 14. In FIG. 14, the vertical axis represents the relative brightness (no units) of the light emitted from the prism sheet 42, and the horizontal axis represents the angle (in degrees) in the second direction with respect to the front surface direction. The relative brightness indicated by the vertical axis in FIG. 14 is a relative value in which, for the respective light guide plates 19 of Working Examples 2 and 3, the brightness value in the front surface direction (an angle of 0°) is used as a baseline (1.0). In FIG. 14, the graph indicated by a dashed line represents Working Example 2, and the graph indicated by a solid line represents Working Example 3, respectively.

The experiment results of Comparative Experiment 2 will be explained. First, based on FIG. 13, it can be seen that the relative brightness tends to generally increase as the vertex angle θv2 of the light-exiting surface unit prisms 43a increases from 90° to 150°. Since the vertex angle θv1 of the light-emission side unit prisms 42a of the prism sheet 42 is 90°, the relative brightness tends to increase as the vertex angle θv2 of the light-exiting surface unit prisms 43a becomes larger than the vertex angle θv1. As mentioned above, the front surface brightness of light emitted from the prism sheet 42 tends to be proportional to the amount of light, from among the light emitted from the light guide plate 19, in which the angle of emergence falls within an angle range of ±23° to ±40°. Therefore, the reason that the relative brightness increases due to the vertex angle θv2 of the light-exiting surface unit prisms 43a being larger than the vertex angle θv1)(90°) is that when the vertex angle θv2 is approximately the same as the vertex angle θv1, the light-condensing effect imparted on the light emitted from the light-exiting surface unit prisms 43a is too strong, leading to the angle of emergence of the emitted light tending to be less than 23°, whereas when θv2 is larger than θv1, the light-condensing effect is appropriately imparted on the light emitted from the light-exiting surface unit prisms 43a and it is thus easier to keep the angle of emergence of the emitted light between 23° and 40°. More specifically, when the vertex angle θv2 of the light-exiting surface unit prisms 43a is between 100° and 150°, relative brightness increases by at least 3% compared to a case in which the vertex angle θv2 is 90°. It is more preferable that the vertex angle θv2 of the light-exiting surface unit prisms 43a be between 135° and 150°, which will lead to an increase in relative brightness of at least 10% compared to a case in which the vertex angle θv2 is 90°. It is most preferable that the vertex angle θv2 of the light-exiting surface unit prisms 43a be between 140° and 150°, which will lead to an increase in relative brightness of at least 15% compared to a case in which the vertex angle θv2 is 90°.

In addition, according to FIG. 14, Working Example 3 has a higher front surface brightness in the second direction for light emitted from the prism sheet 42 compared to Working Example 2. Specifically, it can be seen that, compared to emitted light obtained by causing light emitted from the light guide plate 19 according to Working Example 2 to pass through the prism sheet 42, emitted light obtained by causing light emitted from the light guide plate 19 according to Working Example 3 to pass through the prism sheet 42 contains a relatively larger amount of light in which the propagation direction falls within an angle range of ±10° with respect to the front surface direction and contains a relatively smaller amount of light in which the propagation direction falls within an angle range of ±20° to ±40° with respect to the front surface direction. In other words, emitted light obtained by causing light emitted from the light guide plate 19 according to Working Example 3 to pass through the prism sheet 42 is condensed in the front surface direction to a higher extent compared to Working Example 2. Thus, as shown in FIG. 13, Working Example 3, in which the vertex angle θv2 of the light-exiting surface unit prisms 43a is set to 140°, shows an approximate improvement of 18% or so in relative brightness compared to Working Example 2, in which the vertex angle θv2 of the light-exiting surface unit prisms 43a is set to 90°.

Next, the relationship between the light-exiting surface prism unit 43 and the exiting-light reflecting part 41 disposed on the light-exiting surface 19a side of the light guide plate 19 will be described in detail. As shown in FIGS. 7 and 9, the reflective units 41a forming the exiting-light reflecting part 41 are formed by removing a part of a top 43a2 side of the light-exiting surface unit prisms 43a forming the light-exiting surface prism unit 43. Thus, reflective units 41a are not cut out of the bottom portion, which is on the side opposite of the top 43a2 side, of the light-exiting surface unit prisms 43a, and this bottom portion is a reflective unit 41a non-formation area. The height dimension (dimension in the third direction) of the reflective units 41a is smaller than the height dimension of the light-exiting surface unit prisms 43a. As a result of this configuration, as shown in FIG. 6, while the reflective units 41a extend along the second direction, the reflective units 41a are not continuous along the entire length of the light guide plate 19 in the second direction and are disconnected at multiple points. In other words, the reflective units 41a are each formed of a plurality of separated reflective units 41aS that are arranged intermittently with gaps therebetween in the second direction. In addition, the reflective units 41a are formed so as to open to the side along the second direction by partially removing the top 43a2 side of the light-exiting surface unit prisms 43a. The number of separated reflective units 41aS forming a reflective unit 41a matches the total number of light-exiting surface unit prisms 43a that form the light-exiting surface prism unit 43. The center of the reflective unit 41a in the second direction substantially matches the location in the second direction of the top 43a2 of the light-exiting surface unit prism 43a. Furthermore, since the height dimension (depth dimension) of the respective reflective units 41a aligned in the first direction gradually increases moving away from the light-receiving face 19b (LEDs 17) in the first direction (see FIG. 3), the width dimension (the size in the second direction) gradually increases moving away from the light-receiving face 19b in the first direction. Therefore, as shown in FIG. 7, the width dimension and surface area of the reflective units 41a disposed near the light-receiving face 19b in the first direction are relatively small, while the width dimension and surface area of the reflective units 41a disposed near the opposite end face 19d in the first direction are relatively large.

Since the amount of reflected light tends to be proportional to the size of the surface area of the reflective unit 41a, the size of the surface area must be set to a corresponding value in order to achieve the necessary amount of reflected light. The same is also true for the exiting-light reflecting part 41, and in order to achieve the necessary amount of reflected light from the exiting-light reflecting part 41, it is necessary to set the size of the overall surface area (the total area of the surface areas of the respective reflective units 41a) of the exiting-light reflecting part 41 to a corresponding value. If the reflective units are formed so as to extend along the entire length of the light guide plate 19 in the second direction, in order to set the surface area of the reflective units to the above-mentioned value, the dimension of the reflective units in the third direction cannot be set to a value greater than or equal to a certain value. In contrast, if the reflective units 41a are formed of a plurality of separated reflective units 41aS arranged intermittently in the second direction with gaps therebetween, it is possible to make the dimension of the reflective units 41a in the third direction relatively larger when the surface area of the reflective units 41a is set to the above-mentioned value. Therefore, when the light guide plate 19 is manufactured using resin molding and the exiting-light reflecting part 41 is integrally formed on the light-exiting surface 19a of the light guide plate 19, it is easy to form the separated reflective units 41aS, which form the reflective units 41a, in a designed shape on the light-exiting surface 19a. As a result, it is possible to cause the exiting-light reflecting part 41 to exhibit the appropriate optical performance. If the reflective units are formed so as to extend along the entire length of the light guide plate 19 in the second direction, it is possible to adjust the total area, which is constituted of the surface area of each of the reflective units, by decreasing the number of reflective units aligned in the first direction. When this is done, however, the arrangement interval between the reflective units aligned in the first direction becomes larger, thus leading to concerns that uneven brightness may occur. On the other hand, if the reflective units 41a are formed of a plurality of the separated reflective units 41aS arranged intermittently in the second direction with gaps therebetween, it is not necessary to modify the number and arrangement interval of the reflective units 41a aligned in the first direction. Thus, uneven brightness is unlikely to occur in light emitted from the backlight device 12. In addition, since the reflective units 41a are formed so as to be open along the second direction by partially removing the top 43a2 side of the light-exiting surface unit prisms 43a, the light-condensing capability of the light-exiting surface prism unit 43 is appropriately exhibited. Specifically, if the reflective units are not open along the second direction and have side faces aligned in the first direction, there is concern that the light-condensing capability of the light-exiting surface prism unit may be degraded as a result of light being refracted or reflected by the side faces aligned in the first direction. However, since the reflective units 41a are formed so as to be open along the second direction as a result of the top 43a2 side of the light-exiting surface unit prisms 43a being partially removed, the light-condensing capability the light-exiting surface prism unit 43 is appropriately exhibited, and as a result, it is possible to further increase the brightness of light emitted from the backlight device 12.

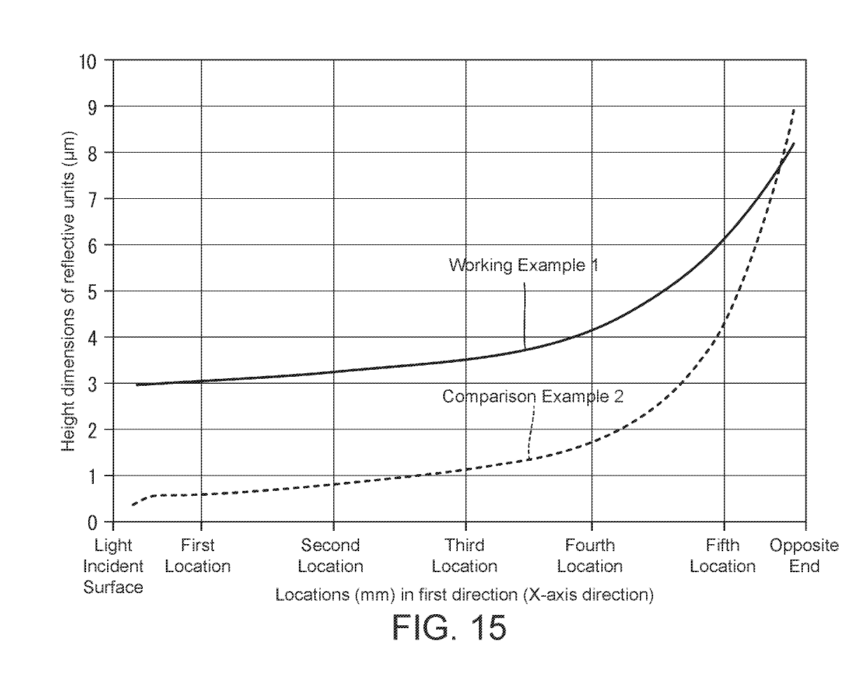

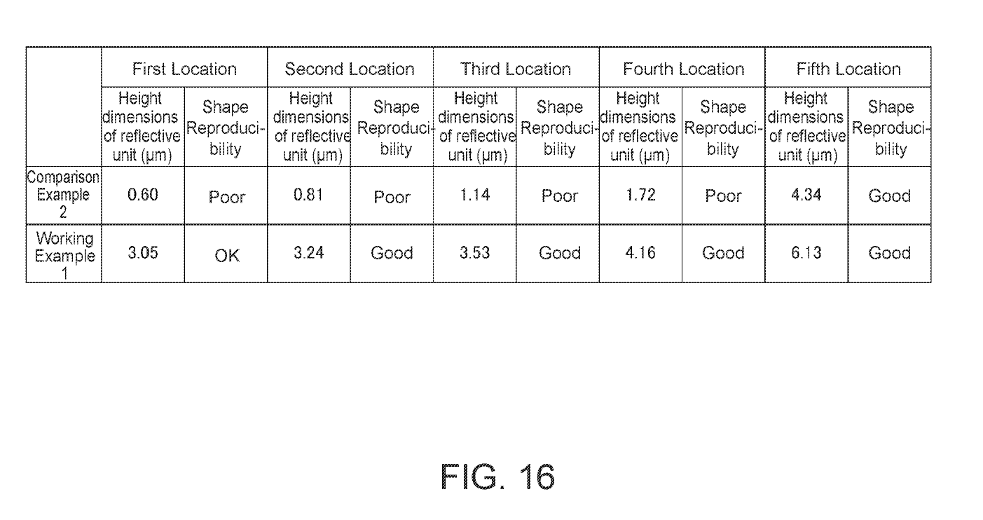

Next, Comparative Experiment 3 was carried out in order to determine what kind of changes would occur in the shape reproducibility of the reflective units 41a forming the exiting-light reflecting part 41 as a result of whether or not there was a light-exiting surface prism unit 43. In Comparative Experiment 3, Working Example 1 was defined as the light guide plate 19 in which the light-exiting surface prism unit 43 and the exiting-light reflecting part 41 were provided on the light-exiting surface 19a, and Comparison Example 2 was defined as a light guide plate in which an exiting-light reflecting part was provided on the light-exiting surface while a light-exiting surface prism unit was not provided. The light guide plate 19 according to Working Example 1 in Comparative Experiment 3 was identical to the light guide plate 19 according to Working Example 1 in the above-mentioned Comparative Experiments 1 and 2. Other than not having the light-exiting surface prism unit, the light guide plate according to Comparison Example 2 in Comparative Experiment 3 had the same structure as the light guide plate 19 according to Working Example 1. Thus, the reflective units provided on the light guide plate according to Comparison Example 2 were provided so as to extend continuously (without any discontinuities) along the entire length of the light guide plate in the second direction (Y axis direction), and the number of reflective units arranged in the first direction (X axis direction) thereof matched the number of reflective units 41a arranged on the light guide plate 19 according to Working Example 1. In Comparative Experiment 3, the height dimension of the reflective units forming the exiting-light reflecting part was measured in accordance with the location in the first direction on the light guide plate according to Comparison Example 2 and the light guide plate 19 according to Working Example 1. FIG. 15 shows these results. Furthermore, in Comparative Experiment 3, separate locations that were formed when the respective light guide plates according to Comparison Example 2 and Working Example 1 were divided into six substantially equal sections in the first direction were defined as a first location, a second location, a third location, a fourth location, a fifth location, and a sixth location, moving from the location closest to the light-receiving face. The quality of the shape reproducibility of the reflective units 41a at the respective locations was determined, and these results are shown in FIG. 16. In FIG. 15, the vertical axis represents the height dimension (in μm) of the reflective units, and the horizontal axis represents the location in the first direction on the respective light guide plates. For the locations in the first direction that are indicated by the horizontal axis in FIG. 15, the left edge in FIG. 15 represents the location of the light-receiving face of the respective light guide plates, and the right edge in FIG. 15 represents the location of the opposite end face of the respective light guide plates. FIG. 16 shows the height dimension of a reflective unit and the determination result for the shape reproducibility of the reflective unit from the first location to the fifth location. The shape reproducibility of the reflective unit was determined according to how much of a discrepancy there was between the light distribution for light emitted from a light guide plate that was obtained using an optical simulation (theoretical value), and the light distribution for light emitted from a light guide plate that was actually created using resin molding (actual value). If this discrepancy exceeded an acceptable standard, it was determined that “shape reproducibility is poor,” while if the discrepancy did not exceed the acceptable standard, it was determined that “shape reproducibility is good.”

The experiment results of Comparative Experiment 3 will be explained. It can be seen from FIG. 15 that the light guide plate 19 according to Working Example 1 and the light guide plate according to Comparison Example 2 are both formed such that the height dimension of the reflective units gradually increases moving from the light-receiving face side toward the opposite end face side of the light guide plate. Meanwhile, it can be seen from FIG. 15 that the reflective units 41a provided on the light guide plate 19 according to Working Example 1 are formed such that the height dimension thereof is generally larger than the height dimension of the reflective units provided on the light guide plate according to Comparison Example 2. This is due to the fact that, while the reflective units provided on the light guide plate according to Comparison Example 2 extend continuously along the entire length of the light guide plate in the second direction, the reflective units 41a provided on the light guide plate 19 according to Working Example 1 are formed of plurality of separated reflective units 41aS intermittently arranged in the second direction with gaps therebetween. The reason for this will be explained in detail below. First, since there is a proportional relationship between the surface area of the reflective units and the amount of light reflected by the reflective units, the size of the surface area of the reflective units must be set to a value corresponding to a target amount of reflected light in order to reflect the necessary amount of light. On the light guide plate according to Comparison Example 2, the reflective units continuously extend along the entire length of the light guide plate in the second direction; thus, in order to set the surface area of the reflective units to the above-mentioned value, the height dimension of the reflective units cannot be very large. In contrast, on the light guide plate according to Working Example 1, the reflective units 41a are formed of a plurality of separated reflective units 41aS intermittently arranged in the second direction with gaps therebetween; thus, it is possible to set the height dimension of the reflective units 41a to a relatively larger value when the surface area of the reflective units 41a is set to the above-mentioned value. Due to this reason, the reflective units 41a provided on the light guide plate 19 according to Working Example 1 are formed such that the height dimension thereof is generally larger than the height dimension of the reflective units provided on the light guide plate according to Comparison Example 2.

Next, it can be seen from FIG. 16 that when the height dimension of the reflective units exceeds approximately 3 μm, the shape reproducibility of the reflective units is good. In addition, for the light guide plate according to Comparison Example 2, the shape reproducibility of the reflective units is poor from the first location to the fourth location, while the shape reproducibility is good at the fifth location. In contrast, for the light guide plate 19 according to Working Example 1, the shape reproducibility of the reflective units 41a is good from the second location to the fifth location and is somewhat good at the first location. This is due to the fact that while the height dimension of most of the plurality the reflective units 41a provided on the light guide plate 19 according to Working Example 1 exceeds 3 μm, which is the reference value for determining the quality of shape reproducibility for the reflective units, the height dimension of most of the plurality of reflective units provided on the light guide plate according to Comparison Example 2 does not exceed the above-mentioned reference value (3 μm). Thus, as in Working Example 1, it is possible to make the height dimension of the reflective units 41a sufficiently large by providing the light-exiting surface prism unit 43 in addition to the exiting-light reflecting part 41 on the light-exiting surface 19a of the light guide plate 19 and by forming the reflective units 41a, which constitute the exiting-light reflecting part 41, using a plurality of separated reflective units 41aS. Thus, when the light guide plate 19 is manufactured using resin molding, it is easy to form the separated reflective units 41aS forming the reflective units 41a in a designed shape on the light-exiting surface 19a. As a result, it is possible to cause the exiting-light reflecting part 41 to exhibit the appropriate optical performance. In order to increase the height dimension of the reflective units on the light guide plate according to Comparison Example 2, it is possible to adjust the total area constituted of the surface area of each of the respective reflective units to the fixed value by decreasing the number of reflective units aligned along the first direction, for example. In such a case, however, the arrangement interval between the reflective units aligned in the first direction becomes larger, thus leading to concerns that uneven brightness may occur in the light emitted from the light guide plate. Meanwhile, if, as on the light guide plate 19 according to Working Example 1, the reflective units 41a are formed of a plurality of the separated reflective units 41aS arranged intermittently in the second direction with gaps therebetween, it is not necessary to modify the number or arrangement interval of the reflective units 41a aligned in the first direction. Thus, uneven brightness is unlikely to occur in light emitted from the light guide plate 19.

As described above, the backlight device (illumination device) 12 of the present embodiment includes: the LEDs (light sources) 17; the light guide plate 19 that has a rectangular shape, at least one of a pair of end faces, which are on opposite sides and are among the peripheral end faces of the light guide plate 19, thereof being the light-receiving face 19b that receives light emitted from the LEDs 17, a surface thereof being the light-exiting surface 19a that emits light, and another surface thereof being the opposite surface 19c; the reflective sheet (reflective member) 40 that has the reflective surface 40a that is disposed so as to face the opposite surface 19c of the light guide plate 19 and reflects light; and the exiting-light reflecting part 41 that facilitates the emission of light from the light-exiting surface 19a by reflecting light that propagates within the light guide plate 19, is disposed on the light-exiting surface 19a side of the light guide plate 19, and is formed of the reflective unit 41a being arranged in plurality with gaps therebetween along the first direction that is along a pair of end faces, from among the peripheral end faces of the light guide plate 19, that are on opposite sides and do not include the light-receiving face 19b. The reflective unit 41a extends along the second direction that is along a pair of end faces, from among the peripheral end faces of the light guide plate 19, that include the light-receiving face 19b.

In such a configuration, the light emitted from the LEDs 17 enters the light-receiving face 19b of the light guide plate 19, propagates within the light guide plate 19, and is reflected during this process by the exiting-light reflecting part 41 disposed on the light-exiting surface 19a side of the light guide plate 19. The reflective units 41a that form the exiting-light reflecting part 41 extend along the second direction and are arranged in plurality along the first direction with gaps therebetween; thus, it is possible to reflect light propagating along the first direction within the light guide plate 19 and orient this light toward the opposite surface 19c. The light reflected toward the opposite surface 19c by the exiting-light reflecting part 41 is reflected again by the reflective sheet 40 disposed on the opposite surface 19c side, resulting in the light being emitted from the light-exiting surface 19a.

In conventional cases in which the exiting-light reflecting part is disposed on the opposite surface 19c, the light reflected by the exiting-light reflecting part is immediately oriented toward and emitted from the light-exiting surface 19a. In contrast, if the exiting-light reflecting part 41 is, as described above, disposed on the light-exiting surface 19a side of the light guide plate 19, it is possible to cause light reflected by the reflective units 41a to be emitted from the light-exiting surface 19a by initially orienting the light toward the opposite surface 19c, reflecting the light via the reflective sheet 40 disposed on the opposite surface 19c, and then once again orienting the light toward the light-exiting surface 19a. In other words, the optical path from when light is reflected by the exiting-light reflecting part 41 until the light is emitted from the light-exiting surface 19a becomes complex, and the light will be refracted on at least two particular occasions: when the light is emitted from the opposite surface 19c toward the reflective sheet 40, and when the light enters the opposite surface 19c from the reflective sheet 40. As a result of this refraction, light is more likely to be diffused in the second direction; thus light is well-mixed in the second direction and uneven brightness is less likely to occur in the second direction for light emitted from the light-exiting surface 19a.

In addition, the present invention includes the opposite surface convex lenticular lens unit (opposite surface anisotropic light-condensing part) 44 disposed on the opposite surface 19c side of the light guide plate 19. The opposite surface convex lenticular lens unit 44 is formed of the opposite surface convex cylindrical lens (opposite surface light-condensing unit) 44a, which extends along the first direction, being arranged in plurality along the second direction. In such a configuration, an anisotropic light-condensing effect is imparted, via the opposite surface convex lenticular lens unit 44 disposed on the opposite surface 19c side of the light guide plate 19, on at least a portion of the light that is reflected by the exiting-light reflecting part 41 and then reaches the opposite surface 19c of the light guide plate 19. In other words, since the opposite surface convex cylindrical lens unit 44 is formed of opposite surface convex cylindrical lenses 44a, which extend along the first direction, being arranged in a plurality along the second direction, the light emitted from the opposite surface convex cylindrical lenses 44a includes light on which a light-condensing effect is selectively imparted in the second direction, which is the alignment direction of the opposite surface convex cylindrical lenses 44a. In addition, light that is reflected by the reflective sheet 40 and then enters the opposite surface convex cylindrical lenses 44a similarly contains light on which a light-condensing effect is selectively imparted in the second direction. Meanwhile, light that propagates along the first direction within the light guide plate 19 without being reflected by the exiting-light reflecting part 41 is totally reflected by the opposite surface convex cylindrical lenses 44a, thereby being diffused in the second direction while propagating within the light guide plate 19.

Furthermore, as a result of the opposite surface convex lenticular lens unit 44 being disposed on the opposite surface 19c side of the light guide plate 19, the gap C is likely to form between the opposite surface 19c and the reflective sheet 40. Therefore, of the light that is reflected by the exiting-light reflecting part 41 and then emitted from the opposite surface 19c, light on which a light-condensing effect is not imparted by the opposite surface convex lenticular lens unit 44 is more likely to be refracted and then diffused in the second direction when the light is emitted toward the gap C. Light emitted toward the gap C while being diffused in the second direction is more likely to be refracted and diffused in the second direction when the light is reflected by the reflective sheet 40 and then re-enters the opposite surface 19c. In this manner, light on which a light-condensing effect is not imparted by the opposite surface convex lenticular lens unit 44 is more likely to be refracted when entering and leaving the opposite surface 19c via the gap C; thus, this light is more likely to be further diffused in the second direction. As a result, light is even further well-mixed in the second direction, and uneven brightness is therefore even less likely to occur in the second direction for light emitted from the light-exiting surface 19a.

In addition, the present invention includes the light-exiting surface prism unit (light-exiting surface anisotropic light-condensing part) 43 disposed on the light-exiting surface 19a side of the light guide plate 19. The light-exiting surface prism unit 43 is formed of the light-exiting surface unit prism (light-exiting surface light-condensing unit) 43a, which extends along the first direction, being arranged in plurality along the second direction. In such a configuration, an anisotropic light-condensing effect is imparted, via the light-exiting surface prism unit 43 disposed on the light-exiting surface 19a side of the light guide plate 19, on at least a portion of the light that is reflected by the exiting-light reflecting part 41, is once again reflected by the reflective sheet 40, and then reaches the light-exiting surface 19a of the light guide plate 19. In other words, since the light-exiting surface prism unit 43 is formed of the light-exiting surface unit prism 43a, which extends along the first direction, being arranged in plurality along the second direction, the light emitted from the light-exiting surface unit prisms 43a includes light on which a light-condensing effect is selectively imparted in the second direction, which is the alignment direction of the light-exiting surface unit prisms 43a. Meanwhile, light that propagates along the first direction within the light guide plate 19 without being reflected by the exiting-light reflecting part 41 is totally reflected by the light-exiting surface unit prisms 43a, thereby being diffused in the second direction while propagating within the light guide plate 19. As a result, light that propagates within the light guide plate 19 is further well-mixed in the second direction, and uneven brightness is therefore even less likely to occur in the second direction for light emitted from the light-exiting surface 19a.

In addition, in the exiting-light reflecting part 41, the reflective units 41a are each formed of a plurality of separated reflective units 41aS that are arranged intermittently with gaps therebetween in the second direction. Since the amount of light reflected by the reflective unit 41a tends to be proportional to the size of the surface area thereof, the size of the surface area must be set to a corresponding value in order to achieve the required amount of reflected light. When the reflective units are formed so as to extend along the entire length of the light guide plate 19 in the second direction, in order to set the surface area of the reflective units to the above-mentioned value, the dimension of the reflective units in the direction normal to the surface of the light guide plate 19 cannot be set to a value greater than or equal to a fixed value. In contrast, if the reflective units 41a are formed of a plurality of separated reflective units 41aS arranged intermittently in the second direction with gaps therebetween, it is possible to make the dimension of the reflective units 41a in the direction normal to the surface of the light guide plate 19 relatively larger when the surface area of the reflective units 41a is set to the above-mentioned value. Therefore, if the light guide plate 19 is manufactured using resin molding, when the exiting-light reflecting part 41 is integrally formed on the opposite surface 19c of light guide plate 19, it is easy to form the separated reflective units 41aS, which constitute the reflective units 41a, in a designed shape on the opposite surface 19c, for example. As a result, it is possible to cause the exiting-light reflecting part 41 to exhibit the appropriate optical performance.

If the reflective units 41a are formed so as to extend along the entire length of the light guide plate 19 in the second direction, it is possible to adjust the total area constituted of the surface area of each of the reflective units 41a by decreasing the number of reflective units 41a aligned in the first direction. In such a case, however, the arrangement interval between the reflective units 41a aligned in the first direction becomes larger, thus leading to concerns that uneven brightness may occur. On the other hand, if the reflective units 41a are formed of a plurality of the separated reflective units 41aS arranged intermittently in the second direction with gaps therebetween, it is not necessary to modify the number and arrangement interval of the reflective units 41a aligned in the first direction. Thus, uneven brightness is unlikely to occur in light emitted from the backlight device 12.

In addition, the exiting-light reflecting part 41 is formed such that the reflective units 41a are open along the second direction as a result of the top 43a2 side of the light-exiting surface unit prisms 43a, which form the light-exiting surface prism unit 43, being partially removed. If the reflective units 41a are formed so as to not be open along the second direction and so as to have a side face along the first direction, there is concern that the light-condensing capability of the light-exiting surface prism unit 43 may be degraded as a result of light being refracted or reflected by the side face along the first direction. However, since the exiting-light reflecting part 41 is formed such that the reflective units 41a are open along the second direction as a result of the top 43a2 side of the light-exiting surface unit prisms 43a being partially removed, the light-condensing capability of the light-exiting surface prism unit 43 is appropriately exhibited, and as a result, it is possible to further increase the brightness of light emitted from the backlight device 12.

The present invention also includes: the light-exiting surface prism unit 43, which is disposed on the light-exiting surface 19a side of the light guide plate 19 and which is formed of the light-exiting surface unit prism 43a, which extends along the first direction, being arranged in plurality along the second direction; and the opposite surface convex lenticular lens unit 44, which is disposed on the opposite surface 19c side of the light guide plate 19 and which is formed of the opposite surface convex cylindrical lens 44a, which extends along the first direction, being arranged in plurality along the second direction. In the opposite surface convex lenticular lens unit 44, the surface of the opposite surface convex cylindrical lenses 44a has an arc-like shape, while in the light-exiting surface prism unit 43, the cross-sectional shape of the light-exiting surface unit prisms 43a is substantially triangular, with the vertex angle θv2 thereof being between 100° and 150°. In such a configuration, an anisotropic light-condensing effect is imparted by the opposite surface convex lenticular lens unit 44 on at least a portion of the light that is reflected by the exiting-light reflecting part 41 and then reaches the opposite surface 19c of the light guide plate 19, after which an anisotropic light-condensing effect is imparted by the light-exiting surface prism unit 43 on at least a portion of the light that reached the light-exiting surface 19a. In other words, since the light-exiting surface prism unit 43 and the opposite surface convex lenticular lens unit 44 are respectively formed of a light-exiting surface unit prism 43a and an opposite surface convex cylindrical lens 44a that respectively extend along the first direction and are arranged in plurality along the second direction, the light emitted from the opposite surface convex cylindrical lenses 44a contains light on which a light-condensing effect is selectively imparted in the second direction, which is the alignment direction of the opposite surface convex cylindrical lenses 44a, and the light emitted from the light-exiting surface unit prisms 43a includes light on which a light-condensing effect is selectively imparted in the second direction, which is the alignment direction of the light-exiting surface unit prisms 43a. In addition, light that is reflected by the reflective sheet 40 and then enters the opposite surface convex cylindrical lenses 44a similarly contains light on which a light-condensing effect is selectively imparted in the second direction. Meanwhile, light that propagates along the first direction within the light guide plate 19 without being reflected by the exiting-light reflecting part 41 is totally reflected by the light-exiting surface unit prisms 43a and the opposite surface convex lenticular lens unit 44, thereby being diffused in the second direction while propagating within the light guide plate 19. In particular, since the surface of the opposite surface convex cylindrical lenses 44a of the opposite surface convex lenticular lens unit 44 has an arc-like shape, the light reflected by the opposite surface convex cylindrical lenses 44a is more likely to be more widely diffused in the second direction.

Furthermore, as a result of the opposite surface convex lenticular lens unit 44 being disposed on the opposite surface 19c side of the light guide plate 19, the gap C is likely to form between the opposite surface 19c and the reflective sheet 40. Therefore, of the light that is reflected by the exiting-light reflecting part 41 and then emitted from the opposite surface 19c, light on which a light-condensing effect is not imparted by the opposite surface convex lenticular lens unit 44 is more likely to be refracted and then diffused in the second direction when the light is emitted toward the gap C. Light emitted toward the gap C while being diffused in the second direction is more likely to be refracted and diffused in the second direction when the light is reflected by the reflective sheet 40 and then re-enters the opposite surface 19c. In this manner, light on which a light-condensing effect is not imparted by the opposite surface convex lenticular lens unit 44 is more likely to be refracted when entering and leaving the opposite surface 19c via the gap C; thus, this light is more likely to be further diffused in the second direction. As a result, light is even further well-mixed in the second direction, and uneven brightness is therefore even less likely to occur in the second direction for light emitted from the light-exiting surface 19a.

In addition, since the light-exiting surface unit prisms 43a of the light-exiting surface prism unit 43 have a substantially triangular cross-sectional shape and the vertex angle θv2 thereof is between 100° and 150°, it is possible to further increase the brightness of light emitted from the light-exiting surface 19a compared to a case in which the vertex angle of the light-exiting surface unit prisms is less than 100°. In other words, by setting the vertex angle θv2 of the light-exiting surface unit prisms 43a to within the angle range described above, there is an increase in the light-condensing effect of the light-exiting surface unit prisms 43a.

More specifically, the vertex angle θv2 of the light-exiting surface unit prisms 43a of the light-exiting surface prism unit 43 is set to between 135° and 150°. In such a configuration, it is possible to increase the brightness of light emitted from the light-exiting surface 19a by at least 10% compared to a case in which the vertex angle of the light-exiting surface unit prisms is 90°.

Even more specifically, the vertex angle θv2 of the light-exiting surface unit prisms 43a of the light-exiting surface prism unit 43 is set to between 140° and 150°. In such a configuration, it is possible to increase the brightness of the light emitted from the light-exiting surface 19a by at least 15% compared to a case in which the vertex angle of the light-exiting surface unit prisms is 90°.

In addition, the present invention includes the prism sheet (light-emission side anisotropic light-condensing part) 42, which is disposed on the light-emission side of the light guide plate 19 and which is formed of the light-emission side unit prism (light-emission side unit condensing member) 42a, which extends along the first direction, being arranged in plurality along the second direction. In such a configuration, an anisotropic light-condensing effect is imparted on the light emitted from the light-exiting surface 19a of the light guide plate 19 by the prism sheet 42 disposed on the light-emission side of the light guide plate 19. In other words, since the prism sheet 42 is formed of the light-emission side unit prism 42a, which extends along the first direction, being arranged in plurality along the second direction, a light-condensing effect is selectively imparted in the second direction, which is the alignment direction of the light-emission side unit prisms 42a, on light emitted from the light-emission side unit prisms 42a. As a result, it is possible to increase the brightness of light emitted from the backlight device 12.

The reflective sheet 40 is configured such that the reflective surface 40a mirror-reflects light. In such a configuration, light from the opposite surface 19c of the light guide plate 19 is mirror-reflected by the reflective surface 40a of the reflective sheet 40; thus, light is less likely to be diffused in at least the first direction, and it is therefore possible to increase the brightness of light emitted from the light-exiting surface 19a of the light guide plate 19.

The liquid crystal display device (display device) 10 of the present embodiment includes: the above-described backlight device 12; and a liquid crystal panel (display panel) 11 that performs display by utilizing light from the backlight device 12. In a liquid crystal display device 10 with such a configuration, uneven brightness is unlikely to occur in light emitted from the backlight device 12; thus, it is possible to achieve a display with excellent display quality.

### Embodiment 2

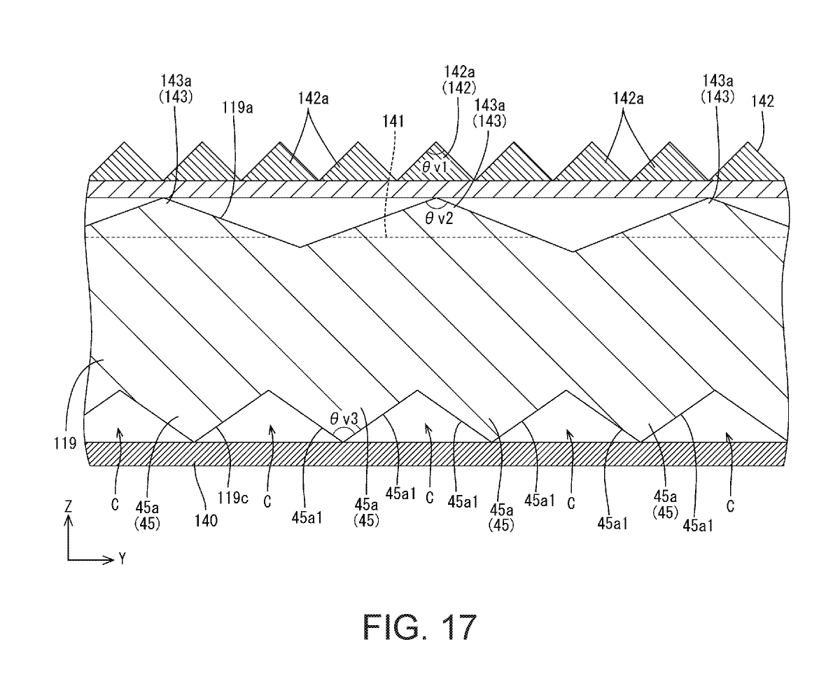

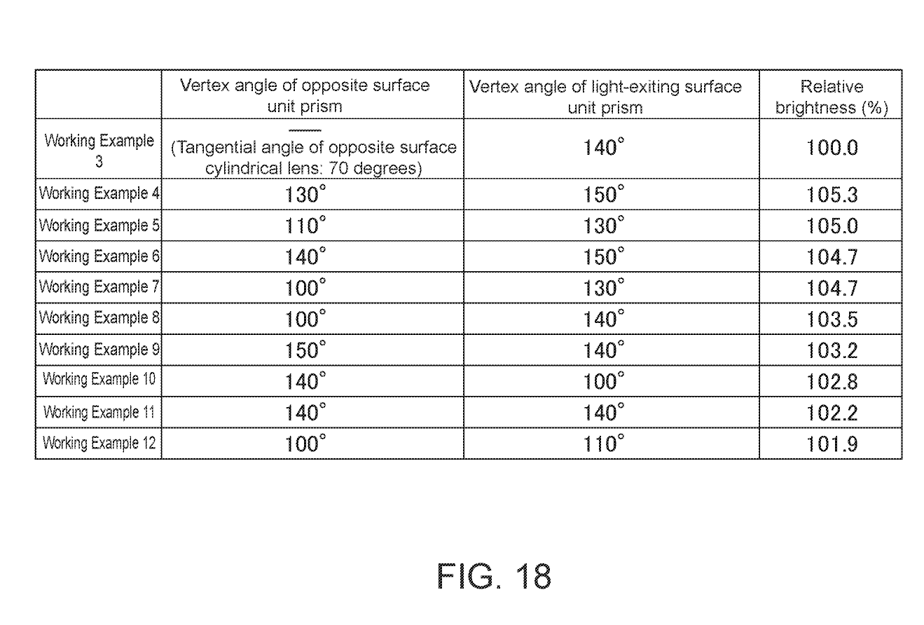

Embodiment 2 of the present invention will be described with reference to FIGS. 17 and 18. In Embodiment 2, an opposite surface prism unit 45 is provided in place of the opposite surface convex lenticular lens unit 44 described in Embodiment 1. Descriptions of structures, operations, and effects similar to those of Embodiment 1 will be omitted.

As shown in FIG. 17, the opposite surface prism unit (opposite surface anisotropic light-condensing part) 45 is integrally provided on an opposite surface 119 of a light guide plate 119 according to the present embodiment. In order to integrally provide the opposite surface prism unit 45 on the light guide plate 119, the light guide plate 119 may be manufactured using injection molding, and a transfer shape for transferring the opposite surface prism unit 45 may be formed beforehand on the molding surface of the mold used to form the opposite surface 119c, for example. The opposite surface prism unit 45 is formed of an opposite surface unit prism (opposite surface light-condensing unit) 45a, which extends along the first direction (X axis direction), being arranged in plurality along the second direction (Y axis direction) on the opposite surface 119c. The opposite surface unit prisms 45a are provided so as to protrude from the opposite surface 119c toward the rear (the side opposite of the light-emission side) along the third direction (Z axis direction). The opposite surface unit prisms 45a have a substantially triangular shape (substantial ridge shape) in a cross-section cut along the second direction and extend in a straight line along the first direction (X axis direction). The width dimension (the dimension in the second direction) of the opposite surface unit prisms 45a is fixed along the entire length in the first direction. The respective opposite surface unit prisms 45a have a substantial isosceles triangle shape in cross-section. The opposite surface unit prisms 45a each include a pair of inclined surfaces 45a1, and it is preferable that a vertex angle θv3 thereof is obtuse (an angle greater than)90°, specifically between 100° and 150°. It is more preferable that the vertex angle θv3 of the opposite surface unit prisms 45a be between 100° and 140°, with 110° to 130° being even more preferable. It is preferable that the vertex angle θv3 of the opposite surface unit prisms 45a be relatively smaller than the vertex angle θv2 of light-exiting surface unit prisms 143a of a light-exiting surface prism unit 143. In addition, the vertex angle θv3 of the opposite surface unit prisms 45a is relatively larger than the vertex angle θv1 of light-emission side unit prisms 142a of a light-emission side prism unit 142. For the plurality of opposite surface unit prisms 45a arranged in a row along the second direction, the vertex angles θv3, the height dimensions, and the width dimensions of the bottom surfaces are all substantially identical, and the arrangement interval between adjacent opposite surface unit prisms 45a is substantially fixed, with equal gaps being provided therebetween.

As shown in FIG. 17, the opposite surface unit prisms 45a with such a configuration impart an optical effect in the following manner on light that travels through the light guide plate 119 and reaches the opposite surface 119c. That is, when light that has reached the opposite surface 119c enters the inclined surface 45a1 of the opposite surface unit prism 45a at an angle of incidence that is greater than the critical angle, the light is totally reflected by the inclined surface 45a1, resulting in the light propagating so as to be diffused in the second direction while travelling within the light guide plate 119. As a result, uneven brightness is less likely to occur in the second direction for light that is thereafter reflected by an exiting-light reflecting part 141 and then emitted from a light-exiting surface 119a. Meanwhile, when light that has reached the opposite surface 119c enters the inclined surface 45a1 of the opposite surface unit prism 45a at an angle of incidence that is less than or equal to the critical angle, the light is refracted by the inclined surface 45a1 and emitted toward the gap C between the opposite surface unit prism 45a and a reflective sheet 140. Light that is emitted toward the gap C, reflected by a reflective surface 140a of the reflective sheet 140, and then once again reaches the opposite surface 119c enters the inclined surface 45a1 of the opposite surface unit prism 45a and is once again refracted. In this manner, an anisotropic light-condensing effect, or in other words, a selective light-condensing effect in the second direction, is imparted by the opposite surface unit prisms 45a on a portion of the light entering and leaving the opposite surface 119c via the gap C when the light enters or leaves the opposite surface 119c. Meanwhile, an optical effect that diffuses light in the second direction is imparted on the light upon which this anisotropic light-condensing effect is not imparted when that light enters or leaves the opposite surface 119c. As a result, light is well-mixed in the second direction, and uneven brightness is therefore unlikely to occur in the second direction for light emitted from the light-exiting surface 119a.

Next, Comparative Experiment 4 was carried out in order to determine how the brightness of emitted light would change when the respective vertex angles θv2 , θv3 of the light-exiting surface unit prisms 143a and the opposite surface unit prisms 45a were changed. Comparative Experiment 4 used the light guide plate 19 according to Working Example 3 described for Comparative Experiment 2 of Embodiment 1 for comparison. For the light guide plate 19 according to Working Example 3, the vertex angle θv2 of the light-exiting surface unit prisms 43a was set to 140° and the tangential angle θt of the opposite surface convex cylindrical lenses 44a was set to 70° (see FIG. 9). In Comparative Experiment 4, Working Example 4 was defined as the light guide plate 119 in which the vertex angle θv2 of the light-exiting surface unit prisms 143a was set to 150° and the vertex angle θv3 of the opposite surface unit prisms 45a was set to 130°, Working Example 5 was defined as the light guide plate 119 in which the vertex angle θv2 of the light-exiting surface unit prisms 143a was set to 130° and the vertex angle θv3 of the opposite surface unit prisms 45a was set to 110°, Working Example 6 was defined the light guide plate 119 in which the vertex angle θv2 of the light-exiting surface unit prisms 143a was set to 150° and the vertex angle θv3 of the opposite surface unit prisms 45a was set to 140°, Working Example 7 was defined as the light guide plate 119 in which the vertex angle θv2 of the light-exiting surface unit prisms 143a was set to 130° and the vertex angle θv3 of the opposite surface unit prisms 45a was set to 100°, Working Example 8 was defined as the light guide plate 119 in which the vertex angle θv2 of the light-exiting surface unit prisms 143a was set to 140° and the vertex angle θv3 of the opposite surface unit prisms 45a was set to 100°, Working Example 9 was defined as the light guide plate 119 in which the vertex angle θv2 of the light-exiting surface unit prisms 143a was set to 140° and the vertex angle θv3 of the opposite surface unit prisms 45a was set to 150°, Working Example 10 was defined as the light guide plate 119 in which the vertex angle θv2 of the light-exiting surface unit prisms 143a was set to 100° and the vertex angle θv3 of the opposite surface unit prisms 45a was set to 140°, Working Example 11 was defined as the light guide plate 119 in which the vertex angle θv2 of the light-exiting surface unit prisms 143a was set to 140° and the vertex angle θv3 of the opposite surface unit prisms 45a was set to 140°, and Working Example 12 was defined as the light guide plate 119 in which the vertex angle θv2 of the light-exiting surface unit prisms 143a was set to 110° and the vertex angle θv3 of the opposite surface unit prisms 45a was set to 100°. The respective prism sheets 42, 142 were stacked on the light-emission side of the respective light guide plates 19, 119 according to Working Examples 3 to 12. The brightness of the emitted light that passed through the prism sheet 42, 142 was measured, and these results are shown in FIG. 18. The prism sheet 42, 142 used in Comparative Experiment 4 is identical to that described above for Embodiment 1. FIG. 18 is a table that shows the relative brightness (in %) of emitted light obtained by causing light emitted from the respective light guide plates of Working Examples 3 to 12 to pass through the prism sheet 42, 142. The relative brightness shown in FIG. 18 is a relative value that uses as a baseline (100%) the brightness value when the light guide plate 19 according to Working Example 3 is used.

The experiment results of Comparative Experiment 4 will be explained. It can be seen from FIG. 18 that, compared to a case in which the light guide plate 19 according to Working Example 3 is used, the brightness of light emitted from the prism sheet 142 is relatively high when the light guide plate 119 according to Working Examples 4 to 12 is used. In other words, when the opposite surface prism unit 45 is provided on the opposite surface 119c of the light guide plate 119 as in Working Examples 4 to 12, the brightness of emitted light is further improved compared to a case in which, as in Working Example 3, the opposite surface convex lenticular lens unit 44 is provided on the opposite surface 19c of the light guide plate 19. In Working Examples 4 to 12, the vertex angle θv2 of the light-exiting surface unit prisms 143a of the light-exiting surface prism unit 143 is set between 100° and 150°, and the vertex angle θv3 of the opposite surface unit prisms 45a is set between 100° and 150°. If the vertex angles θv2 , θv3 fall at least within the range of values mentioned above, a higher brightness than that of the light guide plate 19 according to Working Example 3 can be achieved.

Comparing Working Examples 4 to 12 to each other, when, as in Working Examples 4 to 8, the vertex angle θv2 of the light-exiting surface unit prisms 143a of the light-exiting surface prism unit 143 is relatively larger than the vertex angle θv3 of the opposite surface unit prisms 45a, the vertex angle θv2 of the light-exiting surface unit prisms 143a of the light-exiting surface prism unit 143, which is the relatively larger value, is between 130° and 150°, and the vertex angle θv3 of the opposite surface unit prisms 45a, which is the relatively smaller value, is between 100° and 140°, brightness is improved by at least 3% compared to Working Example 3, and an even higher brightness is achieved compared to Working Examples 9 to 12. More specifically, when, as in Working Examples 4 and 5, the vertex angle θv2 of the light-exiting surface unit prisms 143a of the light-exiting surface prism unit 143 is between 130° and 150°, and the vertex angle θv3 of the opposite surface unit prisms 45a is between 110° and 130°, brightness is increased by at least 5% compared to Working Example 3, and an even higher brightness is achieved compared to Working Examples 6 to 12. Furthermore, when, as in Working Example 5, the vertex angle θv2 of the light-exiting surface unit prisms 143a of the light-exiting surface prism unit 143 is set to 150° and the vertex angle θv3 of the opposite surface unit prisms 45a is set to 130°, the highest brightness is achieved.

According to the present embodiment as described above, the present invention includes: the light-exiting surface prism unit 143, which is disposed on the light-exiting surface 119a side of the light guide plate 119 and which is formed of the light-exiting surface unit prism 143a, which extends along the first direction, being arranged in plurality along the second direction; and the opposite surface prism unit (opposite surface anisotropic light-condensing part) 45, which is disposed on the opposite surface 119c side of the light guide plate 119, and which is formed of the opposite surface unit prism (opposite surface light-condensing unit) 45a, which extends along the first direction, being arranged in plurality along the second direction. In the light-exiting surface prism unit 143 and the opposite surface prism unit 45, respectively, the light-exiting surface unit prisms 143a and the opposite surface unit prisms 45a have a substantially triangular cross-sectional shape, and the vertex angles θv2 , θv3 thereof are between 100° and 150°. In such a configuration, an anisotropic light-condensing effect is imparted by the opposite surface prism unit 45 on at least a portion of the light that is reflected by the exiting-light reflecting part 141 and then reaches the opposite surface 119c of the light guide plate 119, after which an anisotropic light-condensing effect is imparted by the light-exiting surface prism unit 143 on at least a portion of the light that has reached the light-exiting surface 119a. In other words, since the light-exiting surface prism unit 143 and the opposite surface prism unit 45 are respectively formed of the light-exiting surface unit prism 143a and the opposite surface unit prism 45a, which both extend in the first direction, being arranged in plurality along the second direction, the light emitted from the opposite surface unit prisms 45a contains light on which a light-condensing effect is selectively imparted in the second direction, which is the alignment direction of the opposite surface unit prisms 45a, and the light emitted from the light-exiting surface unit prisms 143a includes light on which a light-condensing effect is selectively imparted in the second direction, which is the alignment direction of the light-exiting surface unit prisms 143a. In addition, light that is reflected by the reflective sheet 140 and then enters the opposite surface unit prisms 45a similarly contains light upon which a light-condensing effect is selectively imparted in the second direction. Meanwhile, light that propagates along the first direction within the light guide plate 119 without being reflected by the exiting-light reflecting part 141 is totally reflected by the light-exiting surface unit prisms 143a and the opposite surface prism unit 45, thereby being diffused in the second direction while propagating within the light guide plate 119.

Furthermore, as a result of the opposite surface prism unit 45 being disposed on the opposite surface 119c of the light guide plate 119, the gap C is likely to form between the opposite surface 119c and the reflective sheet 140. Therefore, of the light that is reflected by the exiting-light reflecting part 141 and then emitted from the opposite surface 119c, light on which a light-condensing effect is not imparted by the opposite surface prism unit 45 is more likely to be refracted and then diffused in the second direction when emitted toward the gap C. Light emitted toward the gap C while being diffused in the second direction is more likely to be refracted and diffused in the second direction when the light is reflected by the reflective sheet 140 and then re-enters the opposite surface 119c. In this manner, light upon which a light-condensing effect is not imparted by the opposite surface prism unit 45 is more likely to be diffracted when entering and leaving the opposite surface 119c via the gap C; thus, this light is likely to be further diffused in the second direction. As a result, light is even further well-mixed in the second direction, and uneven brightness is therefore even less likely to occur in the second direction for light emitted from the light-exiting surface 119a.

In addition, since the light-exiting surface unit prisms 143a and the opposite surface unit prisms 45a of the light-exiting surface prism unit 143 and the opposite surface prism unit 45, respectively, have a substantially triangular cross-sectional shape, it is possible for a larger light-condensing effect to be imparted on light emitted from the light-exiting surface 119a compared to a case in which either the light-exiting surface unit prisms or the opposite surface unit prisms are cylindrical lenses. In addition, since the vertex angles θv2 , θv3 of the light-exiting surface unit prisms 143a and the opposite surface unit prisms 45a are respectively between 100° and 150°, it is possible to further increase the brightness of light emitted from the light-exiting surface 119a compared to a case in which the vertex angles of the light-exiting surface unit prisms and the opposite surface unit prisms are less than 100°. In other words, by setting the vertex angles θv2 , θv3 of the light-exiting surface unit prisms 143a and the opposite surface unit prisms 45a to within the angle range described above, there is an increase in the light-condensing effect of the light-exiting surface unit prisms 143a and the opposite surface unit prisms 45a.

In addition, the vertex angle θv2 of the light-exiting surface unit prisms 143a of the light-exiting surface prism unit 143 is relatively larger than the vertex angle θv3 of the opposite surface unit prisms 45a, with the angle range of the vertex angle θv2 being 130° to 150° and the vertex angle θv3 of the opposite surface unit prisms 45a of the opposite surface unit prisms 45a being between 100° and 140°. In such a configuration, it is possible to increase the brightness of light emitted from the light-exiting surface 119a compared to: a case in which either the light-exiting surface unit prisms or the opposite surface unit prisms are cylindrical lenses, a case in which the vertex angle of the light-exiting surface unit prisms is smaller than the vertex angle of the opposite surface unit prisms, or a case in which the vertex angle θv2 of the light-exiting surface unit prisms 143a and the vertex angle θv3 of the opposite surface unit prisms 45a fall outside the angle range described above. Specifically, it is possible to increase the brightness of light emitted from the light-exiting surface 119a by at least 3% compared to a case in which the opposite surface unit prisms are cylindrical lenses and the vertex angle of the light-exiting surface unit prisms is set to 140°, for example.

In addition, the vertex angle θv3 of the opposite surface unit prisms 45a of the opposite surface unit prisms 45a is between 110° and 130°. In such a configuration, it is possible to increase the brightness of light emitted from the light-exiting surface 119a by at least 5% compared to a case in which the opposite surface unit prisms are cylindrical lenses and the vertex angle of the light-exiting surface unit prisms is set to 140°.

### Embodiment 3

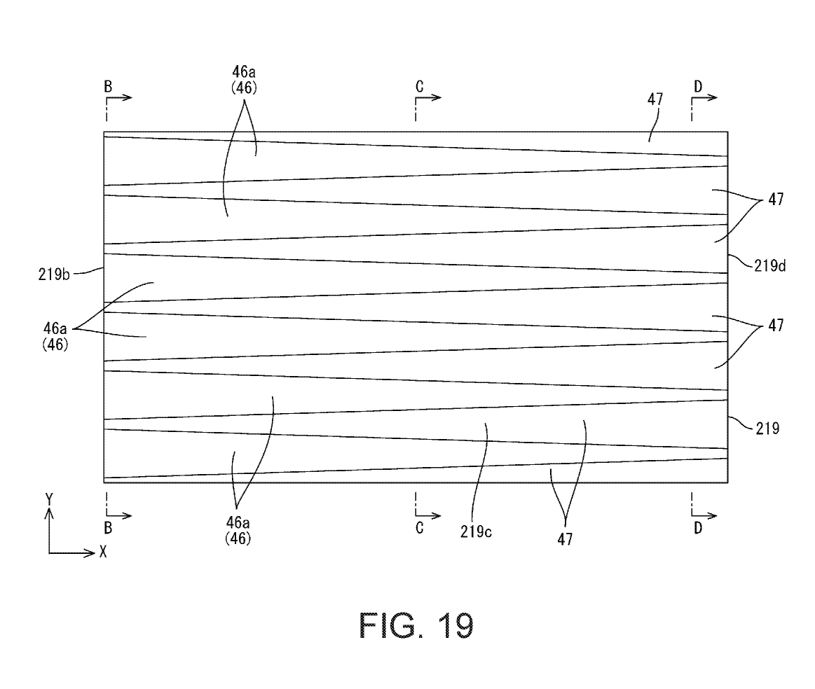

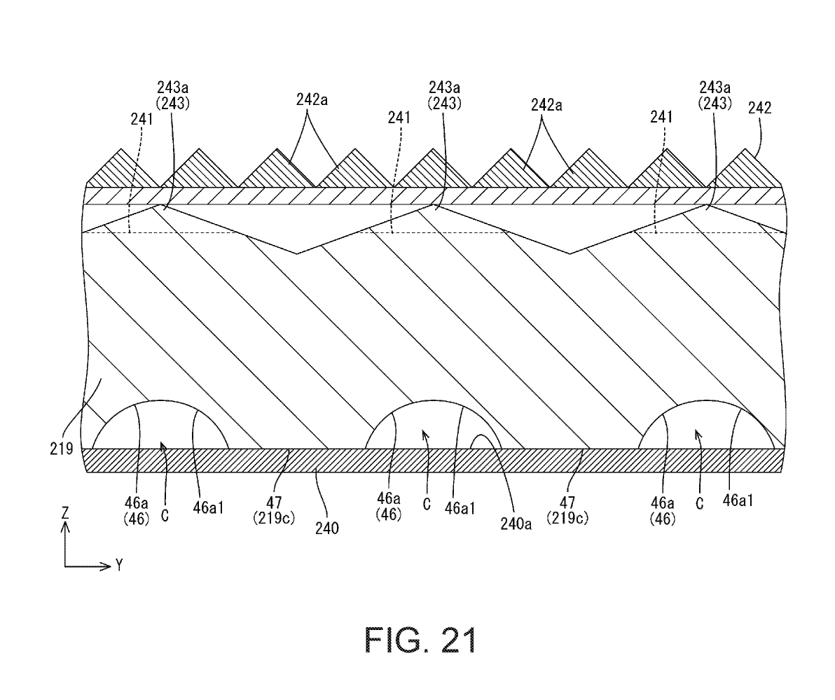

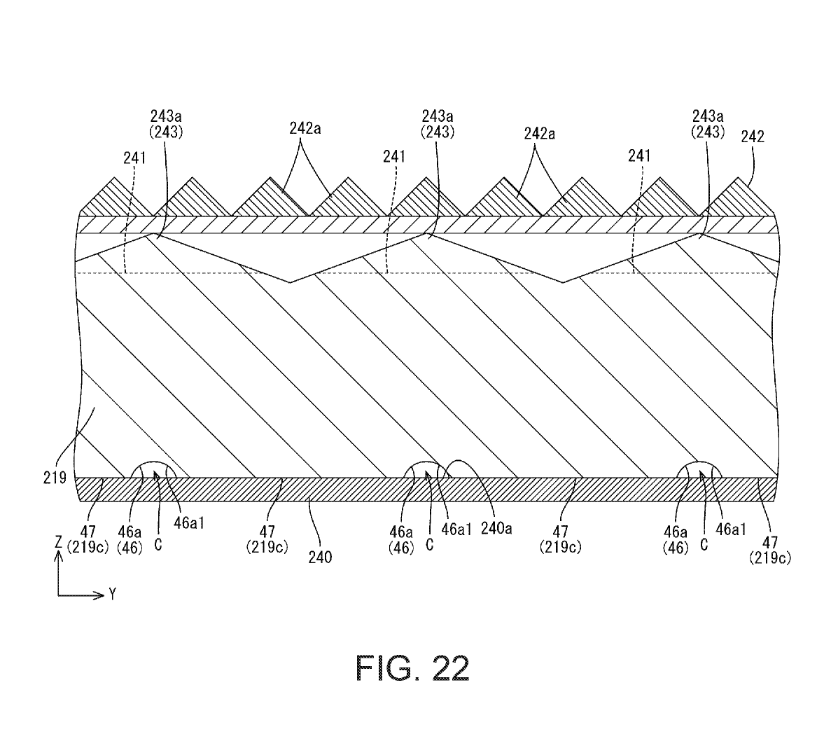

Embodiment 3 of the present invention will be described with reference to FIGS. 19 to 27. In Embodiment 3, an opposite surface concave lenticular lens unit 46 is provided in place of the opposite surface convex lenticular lens unit 44 described in Embodiment 1. Descriptions of structures, operations, and effects similar to those of Embodiment 1 will be omitted.

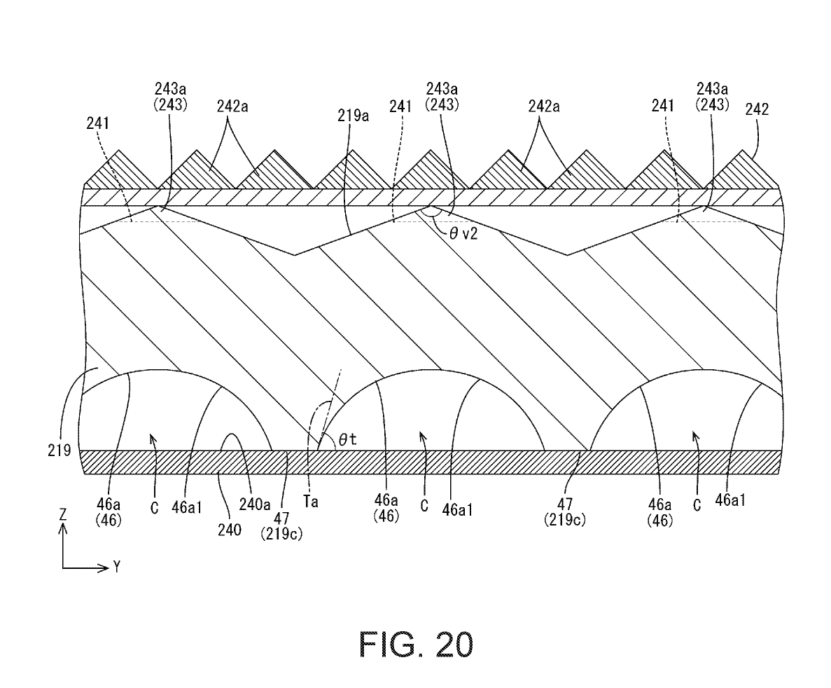

As shown in FIG. 20, the opposite surface concave lenticular lens unit (opposite surface anisotropic light-condensing part) 46 is integrally provided on an opposite surface 219c of a light guide plate 219 according to the present embodiment. The opposite surface concave lenticular lens unit 46 is formed of an opposite surface concave cylindrical lens (opposite surface light-condensing unit, opposite surface cylindrical lens) 46a, which extends along the first direction (X axis direction), being arranged in plurality along the second direction (Y axis direction) on the opposite surface 219c. The opposite surface concave cylindrical lenses 46a are provided so as to cause the opposite surface 219c to recess toward the front (the light-emission side) along the third direction (Z axis direction), and are concave lenses. The opposite surface concave cylindrical lenses 46a have a substantially semicircular shape in a cross-section taken along the second direction and have a groove-like shape that extends along the first direction, the surface thereof having a concave curved surface 46a1. When an angle θt formed between the second direction and a tangent line Ta on a base section 46a2 of the curved surface 46a1 of the opposite surface concave cylindrical lenses 46a is defined as a “tangential angle,” the tangential angle θt is approximately 70°, for example. The opposite surface concave cylindrical lenses 46a with such a configuration impart a substantially similar optical effect as the opposite surface convex cylindrical lenses 44a (see FIG. 9) described in Embodiment 1. That is, when light that has reached the opposite surface 219c enters the curved surface 46a1 of the opposite surface concave cylindrical lenses 46a at an angle of incidence that is greater than the critical angle, the light is totally reflected by the curved surface 46a1, resulting in the light propagating so as to be widely diffused in the second direction while travelling through the light guide plate 219. Compared to the opposite surface convex cylindrical lenses 44a, there is a higher likelihood that the angle of incidence of light at the curved surface 46a1 of the opposite surface concave cylindrical lenses 46a will be higher than the critical angle; thus, light is more likely to be totally reflected, and it is possible to more suitably diffuse light in the second direction. Meanwhile, when light that has reached the opposite surface 219c enters the curved surface 46a1 of the opposite surface concave cylindrical lenses 46a at an angle of incidence that is less than or equal to the critical angle, the light is refracted by the curved surface 46a1 and then emitted toward the gap C between the opposite surface concave cylindrical lenses 46a and a reflective sheet 240. Light that is emitted toward the gap C is reflected at a reflective surface 240a of the reflective sheet 240, once again reaches the opposite surface 219c, enters the curved surface 46a1 of the opposite surface concave cylindrical lenses 46a, and is once again refracted. In this manner, an anisotropic light-condensing effect, or in other words, a selective light-condensing effect in the second direction, is imparted by the opposite surface concave cylindrical lenses 46a on a portion of the light entering and leaving the opposite surface 219c via the gap C when the light enters or leaves the opposite surface 219c. Meanwhile, an optical effect that diffuses light in the second direction is imparted on the light upon which the anisotropic light-condensing effect is not imparted when this light enters or leaves the opposite surface 219c. It is unlikely that the light upon which the anisotropic light-condensing effect was imparted by the opposite surface concave cylindrical lenses 46a will become condensed in the second direction at a prism sheet 242, and is instead more likely to be diffused in the second direction. Thus, while there will be improvement in uneven brightness in light emitted from the prism sheet 242, no contribution will be made toward improving the front surface brightness.

As shown in FIGS. 19 to 22, the opposite surface concave cylindrical lenses 46a are formed such that the width dimension (dimension in the second direction) thereof changes in accordance with the location in the first direction. Specifically, the width dimension, or in other words, the occupancy ratio in the second direction on the opposite surface 219c, of the opposite surface concave cylindrical lenses 46a gradually and continuously decreases moving away from a light-receiving face 219b and approaching an opposite end face 219d in the first direction, and conversely, gradually and continuously increases moving away from the opposite end face 219d and approaching the light-receiving face 219b in the first direction. The occupancy ratio of the opposite surface concave cylindrical lenses 46a is largest at the end (end location) of the light guide plate 219 near the light-receiving face 219b in the first direction, and is approximately 70% to 90% at this location, for example. Conversely, the occupancy ratio is smallest at the end near the opposite end face 219d at approximately 10% to 30%, for example. In the center of the light guide plate 219 in the first direction the occupancy ratio is approximately 50%, for example. Moreover, the opposite surface concave cylindrical lenses 46a are formed such that the height dimension (dimension in the third direction) thereof changes in accordance with the location in the first direction. Specifically, the height dimension, or in other words, the depth of the recess from the opposite surface 219c, of the opposite surface concave cylindrical lenses 46a gradually and continuously decreases moving away from the light-receiving face 219b and approaching the opposite end face 219d in the first direction, and conversely, gradually and continuously increases moving away from the opposite end face 219d and approaching the light-receiving face 219b in the first direction. In other words, the height dimension of the opposite surface concave cylindrical lenses 46a changes in a similar manner to the width dimension in accordance with the location in the first direction. Therefore, the surface area (area of the curved surface 46a1) of the opposite surface concave cylindrical lenses 46a changes in a similar manner to the width dimension and the height dimension in accordance with the location in the first direction. In addition, the height dimension of the gap C between the opposite surface concave cylindrical lenses 46a and the reflective sheet 240 is identical to the height dimension of the opposite surface concave cylindrical lenses 46a, and thus also changes in a similar manner to the height dimension of the opposite surface concave cylindrical lenses 46a in accordance with the location in the first direction.

As shown in FIGS. 19 to 22, a flat section 47 that is flat along the first direction (X axis direction) and the second direction (Y axis direction) is formed in a region of the opposite surface 219c of the light guide plate 219 in which the opposite surface concave lenticular lens unit 46 (opposite surface concave cylindrical lenses 46a) is not formed. The flat section 47 is disposed in plurality so as to be adjacent to the opposite surface concave cylindrical lenses 46a in the second direction. In other words, the opposite surface concave cylindrical lenses 46a and the flat sections 47 are alternately arranged along the second direction on the opposite surface 219c of the light guide plate 219. Moreover, the flat sections 47 are formed such that the width dimension (dimension in the second direction) thereof changes in accordance with the location in the first direction. Specifically, the width dimension, or in other words, the occupancy ratio in the second direction on the opposite surface 219c, of the flat sections 47 gradually and continuously decreases approaching the light-receiving face 219b and moving away from the opposite end face 219d in the first direction, and conversely, gradually and continuously increases approaching the opposite end face 219d and moving away from the light-receiving face 219b in the first direction. The occupancy ratio of the flat sections 47 is smallest at the end (end location) of the light guide plate 219 next to the light-receiving face 219b in the first direction, and is approximately 10% to 30% at this location, for example. Conversely, the occupancy ratio is largest at the end next to the opposite end face 219d at approximately 70% to 90%, for example. In the center of the light guide plate 219 in the first direction the occupancy ratio is approximately 50%, for example. In this manner, in the center of the opposite surface 219d in the first direction, the occupancy ratio of the opposite surface concave cylindrical lenses 46a in the second direction and the occupancy ratio of the flat sections 47 in the second direction are substantially identical to each other.

As described above, while the opposite surface concave lenticular lenses 46a forming the opposite surface concave lenticular lens unit 46 impart an anisotropic light-condensing effect on light reflected by an exiting-light reflecting part 241, the light upon which this anisotropic light-condensing effect has been imparted is unlikely to become condensed in the second direction at the prism sheet 242, and is instead likely to become diffused in the second direction. Meanwhile, the flat sections 47 impart substantially no specific optical effects on the light reflected by the exiting-light reflecting part 241. Thus, the light emitted toward the prism sheet 242 via the flat sections 47 is light upon which the predominantly-imparted effect is the anisotropic light-condensing effect imparted by the light-exiting surface prism unit 243, and as a result, this light is more likely to have a light-condensing effect imparted thereon in the second direction at the prism sheet 242. Therefore, as the occupancy ratio on the opposite surface 219c of the light guide plate 219 for the opposite surface concave cylindrical lenses 46a of the opposite surface concave lenticular lens unit 46 becomes larger and the occupancy ratio of the flat sections 47 on the opposite surface 219c becomes smaller, uneven brightness decreases in the second direction for light emitted from the prism sheet 242 but the brightness also tends to decrease. In contrast, as the occupancy ratio of the flat sections 47 on the opposite surface 219c increases and the occupancy ratio of the opposite surface concave cylindrical lenses 46a on the opposite surface 219c decreases, uneven brightness in the second direction is less likely to be mitigated for light emitted from the prism sheet 242, although the brightness tends to increase.

As mentioned above, the opposite surface concave lenticular lens unit 46 and the flat sections 47 are provided such that, for the occupancy ratio in the second direction on the opposite surface 219c of the light guide plate 219, the occupancy ratio of the opposite surface concave cylindrical lenses 46a is relatively high and the occupancy ratio of the flat sections 47 is relatively low near the light-receiving face 219b in the first direction, while the occupancy ratio of the opposite surface concave cylindrical lenses 46a is relatively low and the occupancy ratio of the flat sections 47 is relatively high on the side furthest from the light-receiving face 219b in the first direction. Thus, on the side near the light-receiving face 219b in the first direction, where there is concern that uneven brightness may occur as a result of the LEDs (not shown), uneven brightness is unlikely to occur in the second direction for light emitted from the prism sheet 242 due to the opposite surface concave cylindrical lenses 46a, which have a relatively high occupancy ratio near the light-receiving face 219b, while on the side furthest from the light-receiving face 219b in the first direction, where uneven brightness due to the LEDs is fundamentally unlikely to occur, the brightness of light emitted from the prism sheet 242 is higher due to the flat sections 47, which have a relatively high occupancy ratio on the side furthest from the light-receiving face 219b. As a result, uneven brightness is mitigated and brightness is increased for light emitted from the prism sheet 242.

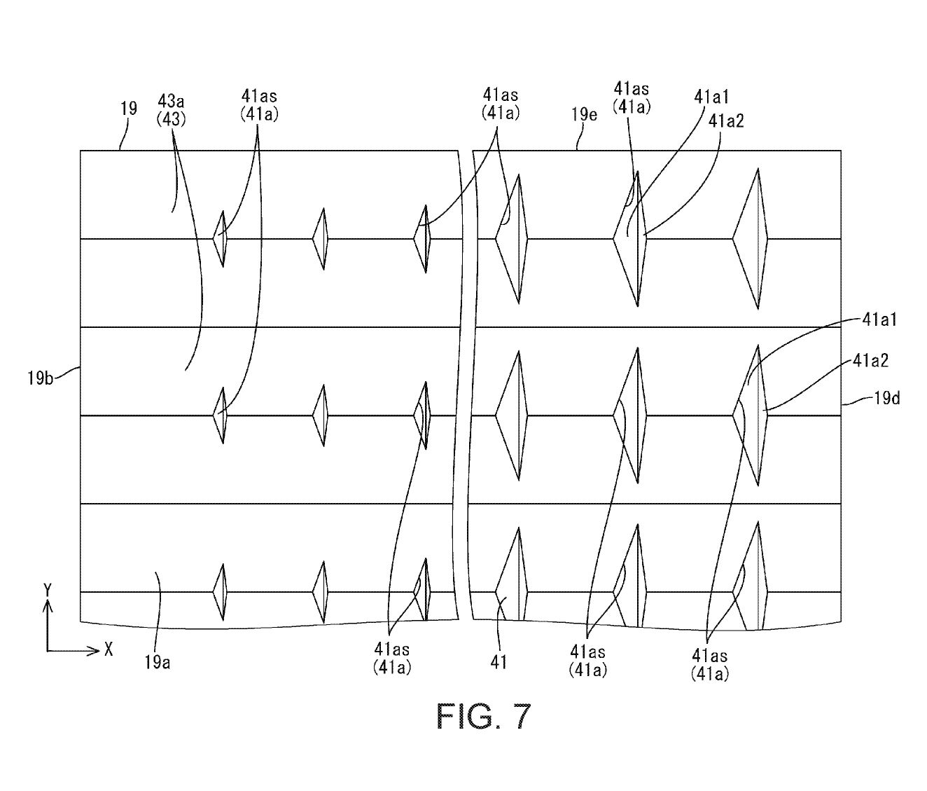

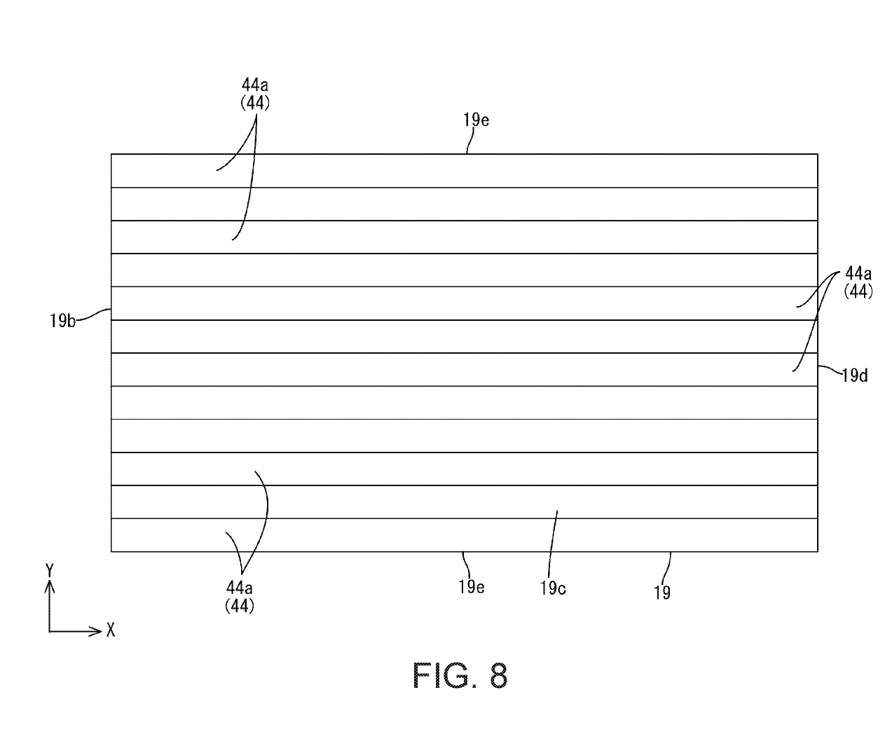

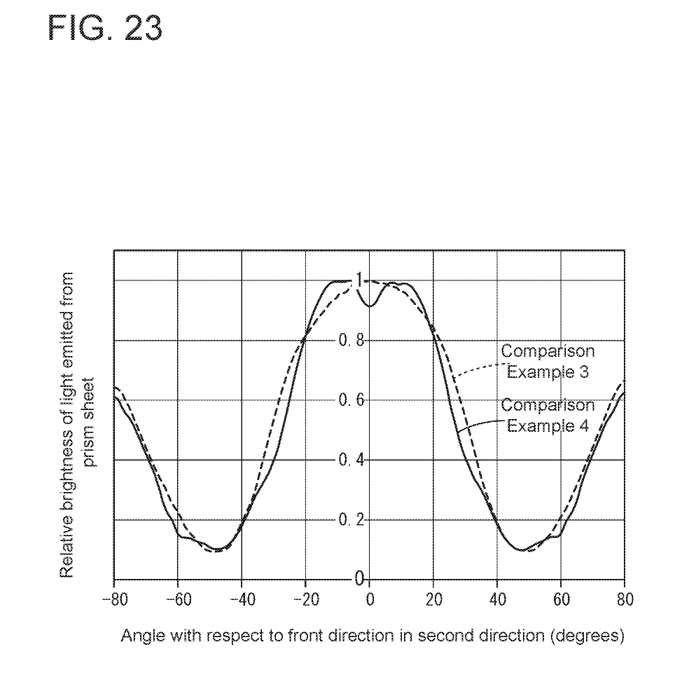

Next, Comparative Experiment 5 was carried out in order to determine how brightness distribution for light emitted from the prism sheet would differ for a case in which the entire opposite surface of the light guide plate was an opposite surface concave lenticular lens unit and a case in which the entire opposite surface of the light guide plate was a flat section. In Comparative Experiment 5, a light guide plate in which the entire opposite surface was an opposite surface concave lenticular lens unit was defined as Comparison Example 3, and a light guide plate in which the entire opposite surface was a flat section was defined as Comparison Example 4. The brightness distributions for emitted light obtained by causing the light emitted from the respective light guide plates of Comparison Examples 3 and 4 to pass through a prism sheet were measured, and these results are shown in FIG. 23. On the light guide plate according to Comparison Example 3, the opposite surface concave cylindrical lenses forming the opposite surface concave lenticular lens unit had a fixed width dimension along the entire length thereof in the first direction, and the configuration thereof was identical to that of the opposite surface convex cylindrical lenses 44a (see FIG. 8) described in Embodiment 1, other than the lenses being concave instead of convex. In addition, the vertex angle of the light-exiting surface unit prisms forming the light-exiting surface prism unit disposed on the light-exiting surface of the respective light guide plates according to Comparison Examples 3 and 4 was set to 140°. The respective light guide plates according to Comparison Examples 3 and 4 had a configuration identical to that of the light guide plate 19 described in Embodiment 1, other than the configuration of the opposite surface and the light-exiting surface prism unit. The configuration of the prism sheet is also identical to that described in Embodiment 1. In FIG. 23, the vertical axis represents the relative brightness (no units) of the light emitted from the prism sheet, and the horizontal axis represents the angle (in degrees) in the second direction with respect to the front surface direction. The relative brightness indicated by the vertical axis in FIG. 23 is a relative value in which, for the respective light guide plates of Comparison Examples 3 and 4, the brightness value in the front surface direction (an angle of 0°) is used as a baseline (1.0). In FIG. 23, the graph indicated by a dashed line represents Comparison Example 3, and the graph indicated by a solid line represents Comparison Example 4.

The experiment results of Comparative Experiment 5 will be explained. According to FIG. 23, Comparison Example 4 has a higher front surface brightness in the second direction for light emitted from the prism sheet compared to Comparison Example 3. Specifically, it can be seen that, compared to emitted light obtained by causing light emitted from the light guide plate according to Comparison Example 3 to pass through a prism sheet, emitted light obtained by causing light emitted from the light guide plate according to Comparison Example 4 to pass through a prism sheet contains a relatively larger amount of light in which the propagation direction falls within an angle range of±10° with respect to the front surface direction and contains a relatively smaller amount of light in which the propagation direction falls within an angle range of±20° to±40° with respect to the front surface direction. In other words, emitted light obtained by causing light emitted from the light guide plate according to Comparison Example 4 to pass through a prism sheet is condensed in the front surface direction to a higher extent compared to Comparison Example 3. This is due to the fact that when an opposite surface concave lenticular lens unit is disposed on the entire opposite surface as in Comparison Example 3, light upon which an anisotropic light-condensing effect was imparted by the opposite surface concave lenticular lens unit is less likely to become condensed in the second direction at the prism sheet; thus, front surface brightness is relatively low. Conversely, when a flat section is disposed on the entire opposite surface as in Comparison Example 4, no specific optical effects are imparted on the light at the flat section; thus, the predominant optical effect imparted on the light emitted from the light guide plate is the anisotropic light-condensing effect imparted by the light-exiting surface prism unit. Since this emitted light is likely to become condensed in the second direction at the prism sheet, front surface brightness may become relatively high.

Next, Comparative Experiment 6 was carried out to determine how brightness changed when, as in Comparison Example 4 from Comparative Experiment 5, the entire opposite surface of the light guide plate was a flat section and the vertex angle θv2 of the light-exiting surface unit prisms forming the light-exiting surface prism unit was changed. In Comparative Experiment 6, measurements were taken regarding how the brightness of emitted light, which was obtained by causing the light emitted from the light-exiting surface of the light guide plate to pass through a prism sheet stacked on the light-emission side of the light guide plate, changed as the vertex angle of the light-exiting surface unit prisms forming the light-exiting surface prism unit changed. In this experiment, the light guide plate according to Comparison Example 4 described for

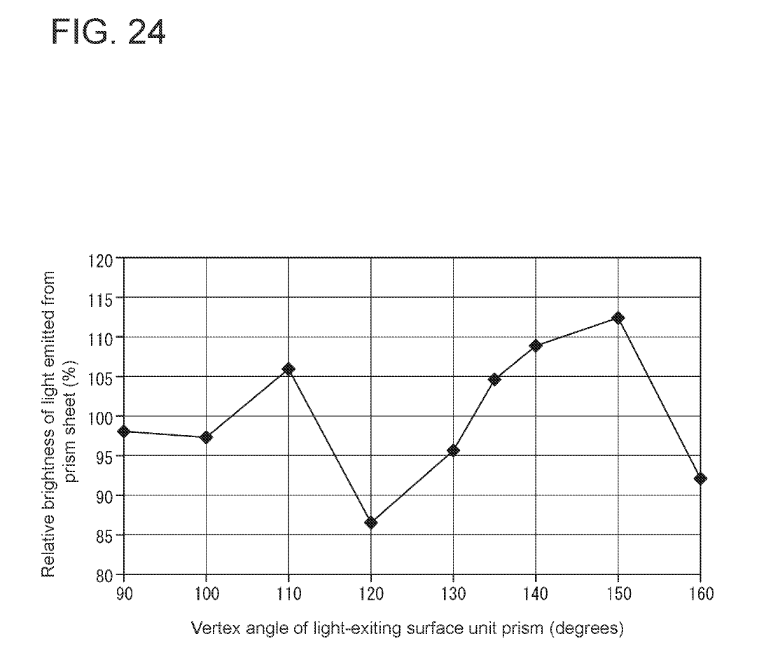

Comparative Experiment 5 was used, and the vertex angle of the light-exiting surface unit prisms forming the light-exiting surface prism unit was changed to various values between 90° and 160°. These results are shown in FIG. 24. In FIG. 24, the horizontal axis is the vertex angle (in degrees) of the light-exiting surface unit prisms, and the vertical axis is the relative brightness (in %) of the light emitted from the prism sheet. The relative brightness of the emitted light indicated by the vertical axis in FIG. 24 is a relative value in which the brightness value of emitted light obtained by causing light emitted from the light guide plate according to Comparison Example 3 for Comparative Experiment 5 to pass through a prism sheet was used as a baseline (100%).

The experiment results of Comparative Experiment 6 will be explained next. From FIG. 24, it can be seen that if the vertex angle of the light-exiting surface unit prisms is set between 102° and 112° or between 132° and 156°, the relative brightness is higher than for Comparison Example 3 of Comparative Experiment 5. More specifically, if the vertex angle of the light-exiting surface unit prisms is set to 110° or between 135° and 155°, the relative brightness is at least 5% higher than for Comparison Example 3. Furthermore, if the vertex angle of the light-exiting surface unit prisms is set to 150°, the highest brightness is achieved and the relative brightness is approximately 13% higher than for Comparison Example 3. When a flat section is disposed on the entire opposite surface of the light guide plate as was done in Comparative Experiment 6, no specific optical effects are imparted on the light at the flat sections; thus, the predominant optical effect imparted on the light emitted from the light guide plate is the anisotropic light-condensing effect imparted by the light-exiting surface prism unit. Therefore, it is preferable that the vertex angle of the light-exiting surface unit prisms forming the light-exiting surface prism unit be 110° or between 135° and 155°, with 140° to 150° being even more preferable.

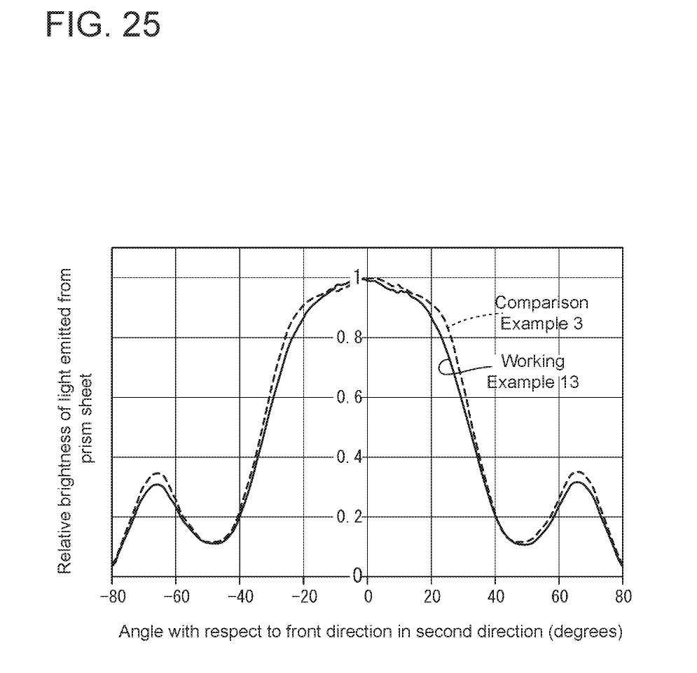

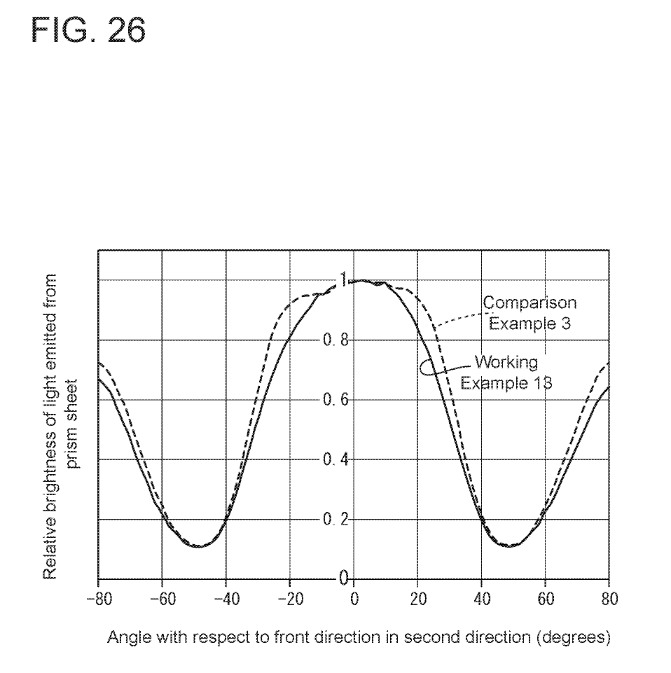

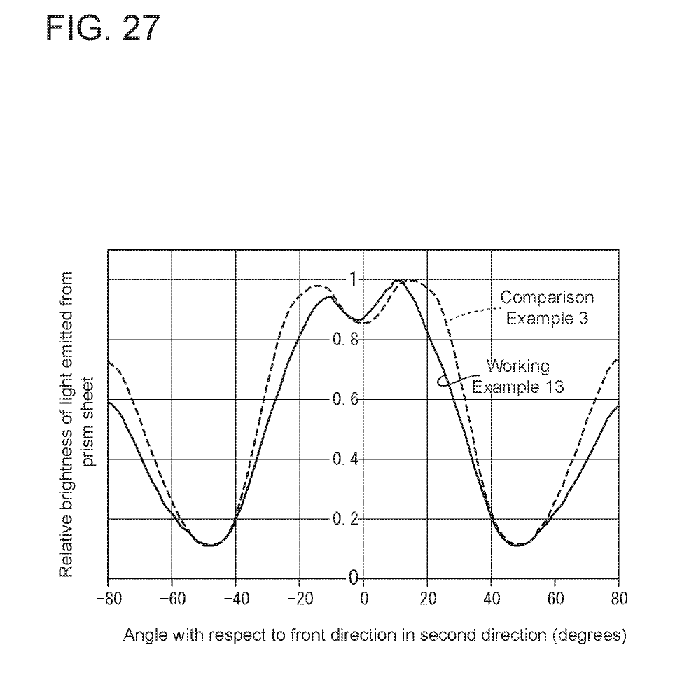

Next, Comparative Experiment 7 was carried out in order to determine how brightness distribution would differ between a case in which the width dimension of the opposite surface concave cylindrical lenses forming the opposite surface concave lenticular lens unit was fixed, and a case in which the width dimension of the opposite surface concave cylindrical lenses was caused to change. In Comparative Experiment 7, Comparison Example 3 was defined as a light guide plate in which the width dimension of the opposite surface concave cylindrical lenses was fixed along the entire length in the first direction, and Working Example 13 was defined as the light guide plate 219 in which the width dimension of the opposite surface concave cylindrical lenses 46a gradually and continuously decreased moving away from the LEDs (light-receiving face 219b) in the first direction. The respective brightness distributions were measured, and the results are shown in FIGS. 25 to 27. The measurement of the brightness distribution was taken at three locations on the respective light guide plates according to Comparison Example 3 and Working Example 13: a location closer to the light-receiving face in the first direction; a central location in the first direction; and a location closer to the opposite end face in the first direction. The measurement results for the location closer to the light-receiving face are shown in FIG. 25, the measurement results for the central location are shown in FIG. 26, and the measurement results for the location closer to the opposite end face are shown in FIG. 27, respectively. The light guide plate 219 according to Working Example 13 has the same configuration as that described above in a previous paragraph for Comparative Experiment 5. The light guide plate according to Comparison Example 3 is identical to that described for Comparative Experiment 5. The vertex angles of the light-exiting surface unit prisms forming the light-exiting surface prism unit disposed on the light-exiting surface of the respective light guide plates according to Comparison Example 3 and Working Example 13 were set to 140°. In FIGS. 25 to 27, the vertical axis represents the relative brightness (no units) of the light emitted from the prism sheet, and the horizontal axis represents the angle (in degrees) in the second direction with respect to the front surface direction. The relative brightness indicated by the vertical axis in FIGS. 25 to 27 is a relative value in which, for the respective light guide plates of Comparison Example 3 and Working Example 13, the brightness value in the front surface direction (an angle of 0°) is used as a baseline (1.0). In FIGS. 25 to 27, the graph indicated by a dashed line represents Comparison Example 3, and the graph indicated by a solid line represents Working Example 13.

The experiment results of Comparative Experiment 7 will be explained next. According to FIGS. 25 to 27, it can be seen that, compared to the light guide plate according to Comparison Example 3, the front surface brightness for the light guide plate 219 according to Working Example 13 is relatively brighter at any of the locations in the first direction. Comparing FIGS. 25 and 26, the front surface brightness of Working Example 13 is higher at the central location in the first direction than at the location closer to the light-receiving face in the first direction. Furthermore, comparing FIGS. 26 and 27, the front surface brightness of Working Example 13 is higher at the location closer to the opposite end face in the first direction than at the central location in the first direction. In other words, on the light guide plate 219 according to Working Example 13, front surface brightness increases moving away from the light-receiving face 219b and approaching the opposite end face 219d, and this trend is inversely proportional to the change in the width dimension of the opposite surface concave cylindrical lenses 46a. Specifically, the width dimension (occupancy ratio in the second direction) of the opposite surface concave cylindrical lenses 46a is largest at the end location near the light-receiving face 219b in the first direction, and is smallest at the end location near the opposite end face 219d in the first direction; thus, as the width dimension decreases, front surface brightness of emitted light obtained by causing light emitted from the light guide plate 219 to pass through the prism sheet 242 tends to increase. Furthermore, it is possible to suitably suppress uneven brightness in the second direction by having the width dimension of the opposite surface concave cylindrical lenses 46a , in which the width dimension changes in the manner described above, be larger near the light-receiving face 219b in the first direction, and it is also possible to increase front surface brightness of light emitted from the prism sheet 242 by having the width dimension be smaller at the central location and near the opposite end face 219d in the first direction, where uneven brightness is fundamentally unlikely to occur. Upon measuring the brightness values of emitted light obtained by causing light emitted from the light guide plate 219 according to Working Example 13 to pass through the prism sheet 242, it was learned that there was an approximately 8% increase in brightness compared to a case in which the light guide plate according to Comparison Example 3 was used.

According to the present embodiment as described above, the present invention includes: the light-exiting surface prism unit 243 that is disposed on the light-exiting surface 219a side of the light guide plate 219 and that is formed of the light-exiting surface unit prism 243a, which extends in the first direction, being arranged in plurality along the second direction; the opposite surface concave lenticular lens unit (opposite surface anisotropic light-condensing part) 46 that is disposed on the opposite surface 219c side of the light guide plate 219 and that is formed of the opposite surface concave cylindrical lens (opposite surface cylindrical lens) 46a, which extends in the first direction, being arranged in plurality along the second direction; the flat sections 47 that are disposed on the opposite surface 219c side of the light guide plate 219 so as to be interposed between the opposite surface concave cylindrical lenses 46a that are adjacent in the second direction, and that is flat along the first direction and the second direction; and the prism sheet (light-emission side anisotropic light-condensing part) 242 that is a light-emission side anisotropic light-condensing part disposed on the light-emission side of the light guide plate 219, and that is formed of the light-emission side unit prism (light-emission side unit condensing member) 242a, which extends along the first direction, being arranged in plurality along the second direction. The opposite surface concave lenticular lens units 46 and the flat sections 47 are provided such that, for the occupancy ratio on the opposite surface 219c in the second direction, the occupancy ratio of the opposite surface concave cylindrical lenses 46a is relatively high and the occupancy ratio of the flat sections 47 is relatively low near the light-receiving face 219b in the first direction, while the occupancy ratio of the opposite surface concave cylindrical lenses 46a is relatively low and the occupancy ratio of the flat sections 47 is relatively high on the side furthest from the light-receiving face 219b. In such a configuration, an anisotropic light-condensing effect is imparted by the opposite surface concave lenticular lens unit 46 on at least a portion of the light that is reflected by the exiting-light reflecting part 241 and then reaches the opposite surface 219c of the light guide plate 219, after which an anisotropic light-condensing effect is imparted by the light-exiting surface prism unit 243 on at least a portion of the light that reaches the light-exiting surface 219a. In other words, since the light-exiting surface prism unit 243 and the opposite surface concave lenticular lens unit 46 are respectively formed of light-exiting surface unit prisms 243a and opposite surface concave cylindrical lenses 46a that extend in the first direction and are arranged in plurality along the second direction, the light emitted from the opposite surface concave cylindrical lenses 46a contains light on which a light-condensing effect is selectively imparted in the second direction, which is the alignment direction of the opposite surface concave cylindrical lenses 46a, and the light emitted from the light-exiting surface unit prisms 243a includes light on which a light-condensing effect is selectively imparted in the second direction, which is the alignment direction of the light-exiting surface unit prisms 243a. In addition, light that is reflected by the reflective sheet 240 and then enters the opposite surface concave cylindrical lenses 46a similarly contains light on which a light-condensing effect is selectively imparted in the second direction. Meanwhile, light that propagates along the first direction within the light guide plate 219 without being reflected by the exiting-light reflecting part 241 is totally reflected by the light-exiting surface prism unit 243 and the opposite surface concave lenticular lens unit 46, and propagates within the light guide plate 219 while being diffused in the second direction. In particular, since the opposite surface concave cylindrical lenses 46a of the opposite surface concave lenticular lens unit 46 are opposite surface concave cylindrical lenses 46a of which the surface thereof has an arc-like shape, the light reflected by the opposite surface concave cylindrical lenses 46a is more likely to be more widely diffused in the second direction.

Furthermore, as a result of the opposite surface concave lenticular lens unit 46 being disposed on the opposite surface 219c side of the light guide plate 219, the gap C is more likely to form between the opposite surface 219c and the reflective sheet 240. Therefore, of the light that is reflected by the exiting-light reflecting part 241 and then emitted from the opposite surface 219c, light on which a light-condensing effect is not imparted by the opposite surface concave lenticular lens unit 46 is more likely to be refracted and then diffused in the second direction when emitted toward the gap C. Light emitted toward the gap C while being diffused in the second direction is more likely to be refracted and diffused in the second direction when the light is reflected by the reflective sheet 240 and then re-enters the opposite surface 219c. In this manner, light on which a light-condensing effect is not imparted by the opposite surface concave lenticular lens unit 46 is more likely to be diffracted when entering and leaving the opposite surface 219c via the gap C; thus, this light is more likely to be further diffused in the second direction. As a result, light is even further well-mixed in the second direction, and uneven brightness is therefore even less likely to occur in the second direction for light emitted from the light-exiting surface 219a.

An anisotropic light-condensing effect is imparted on the light emitted from the light-exiting surface 219a of the light guide plate 219 by the prism sheet 242 disposed on the light-emission side of the light guide plate 219. In other words, since the prism sheet 242 is formed of a light-emission side unit prism 242a, which extends along the first direction, being arranged in plurality along the second direction, a light-condensing effect is selectively imparted in the second direction, which is the alignment direction of the light-emission side unit prisms 242a, on light emitted from the light-emission side unit prisms 242a. While the opposite surface concave lenticular lenses 46a forming the opposite surface concave lenticular lens unit 46 disposed on the opposite surface 219c side of the light guide plate 219 impart an anisotropic light-condensing effect as described above on light reflected by the exiting-light reflecting part 241, the light upon which this anisotropic light-condensing effect has been imparted is unlikely to become condensed in the second direction at the prism sheet 242, and is instead likely to become diffused in the second direction. Meanwhile, the flat sections 47 disposed on the opposite surface 219c side of the light guide plate 219 impart substantially no specific optical effects on the light reflected by the exiting-light reflecting part 241. Thus, the light emitted toward the prism sheet 242 via the flat sections 47 is light upon which the predominantly-imparted effect is the anisotropic light-condensing effect imparted by the light-exiting surface prism unit 243, and as a result, this light is more likely to have a light-condensing effect imparted thereon in the second direction at the prism sheet 242. Therefore, as the occupancy ratio on the opposite surface 219c of the opposite surface concave cylindrical lenses 46a of the opposite surface concave lenticular lens unit 46 becomes larger and the occupancy ratio of the flat sections 47 on the opposite surface 219c becomes smaller, uneven brightness is more likely to be mitigated in the second direction for light emitted from the prism sheet 242, although the brightness also tends to decrease. In contrast, as the occupancy ratio of the flat sections 47 on the opposite surface 219c increases and the occupancy ratio of the opposite surface concave cylindrical lenses 46a on the opposite surface 219c decreases, uneven brightness in the second direction is less likely to be mitigated for light emitted from the prism sheet 242, although brightness tends to increase.

As mentioned above, the opposite surface concave lenticular lens unit 46 and the flat sections 47 are provided such that, for the occupancy ratio in the second direction on the opposite surface 219c, the occupancy ratio of the opposite surface concave cylindrical lenses 46a is relatively high and the occupancy ratio of the flat sections 47 is relatively low near the light-receiving face 219b in the first direction, while the occupancy ratio of the opposite surface concave cylindrical lenses 46a is relatively low and the occupancy ratio of the flat sections 47 is relatively high on the side furthest from the light-receiving face 219b in the first direction. Thus, near the light-receiving face 219b in the first direction, where there is concern that uneven brightness may occur as a result of the LEDs, uneven brightness is unlikely to occur in the second direction for light emitted from the prism sheet 242 as a result of the opposite surface concave lenticular lens unit 46, which has a relatively high occupancy ratio near the light-receiving face 219b, while on the side of the light guide plate 219 furthest from the light-receiving face 219b in the first direction, where uneven brightness due to the LEDs is fundamentally unlikely to occur, the brightness of light emitted from the prism sheet 242 is higher due to the flat sections 47, which have a relatively high occupancy ratio on the side furthest from the light-receiving face 219b. As a result, uneven brightness is mitigated and brightness is increased for light emitted from the prism sheet 242.

### Embodiment 4

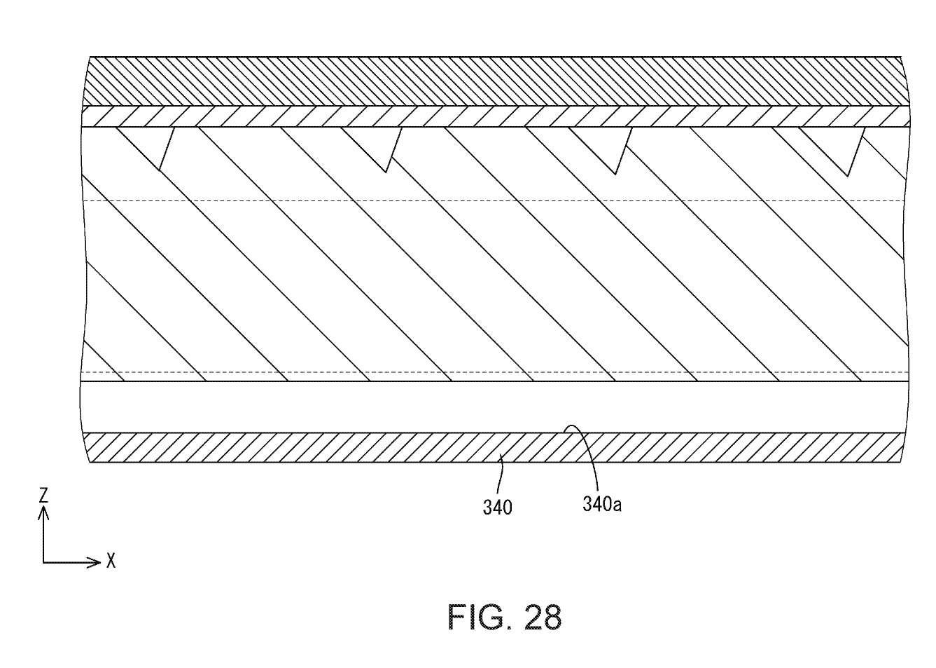

Embodiment 4 of the present invention will be described with reference to FIGS. 28 to 31. Embodiment 4 uses a reflective sheet 340 that has been modified from Embodiment 1. Descriptions of structures, operations, and effects similar to those of Embodiment 1 will be omitted.

As shown in FIG. 28, the reflective sheet 340 according to the present embodiment is configured such that a reflective surface 340a thereof scatter-reflects light. The reflective sheet 340 is a sheet made of a foamed resin material (foamed PET or the like, for example), and the surface thereof has a highly reflective white color. The reflective sheet 340 is able to reflect light at the reflective surface 340a by causing the light to be substantially Lambert-scattered.

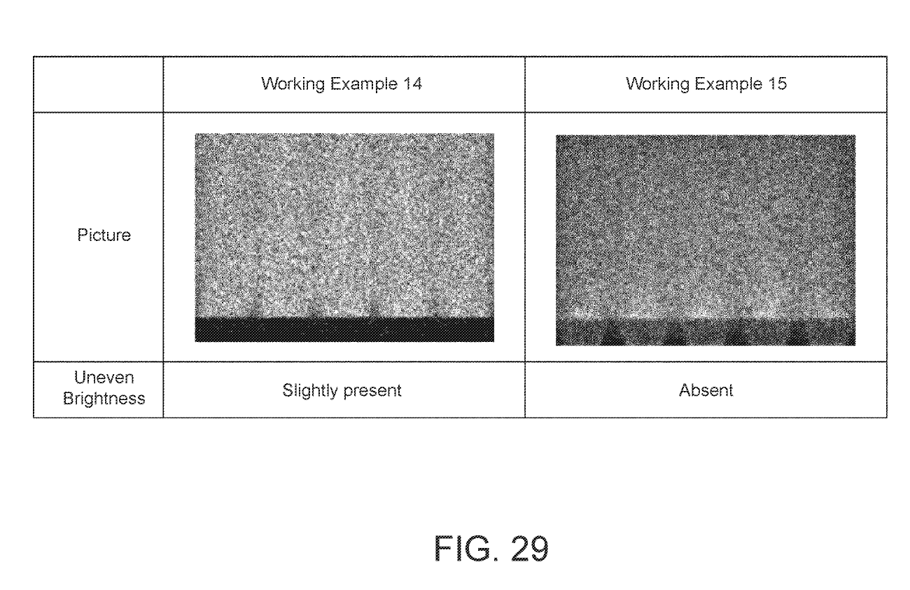

Next, Comparative Experiment 8 was carried out in order to determine whether or not there would be a difference in the degree of uneven brightness between a case in which the reflective surface of the reflective sheet mirror-reflected light and a case in which the reflective surface scatter-reflected light. In Comparative Experiment 8, Working Example 14 was defined as a reflective sheet in which the reflective surface mirror-reflected light, and Working Example 15 was defined as the reflective sheet 340 in which the reflective surface 340a scatter-reflected light. In Comparative Experiment 8, for the respective backlight devices that used the respective reflective sheets according to Working Examples 14 and 15, pictures were taken from the light-exiting surface side when light from the LEDs was caused to enter the light-receiving face of the light guide plate and then exit from the light-exiting surface. In accordance with the pictures, a determination was made on whether or not there was uneven brightness, and these experiment results are shown in the table in FIG. 29. The configuration of the backlight devices used in this experiment was identical to that described in Embodiment 1, other than the respective reflective sheets according to Working Examples 14 and 15. FIG. 29 shows pictures taken from the light-exiting surface side when light was caused to exit from the light-exiting surface of the respective light guide plates according to Working Examples 14 and 15, as well as the determination results regarding uneven brightness that were made based on the pictures. The pictures shown in FIG. 29 specifically captured the portion of the light-exiting surface of the light guide plate that is next to the light-receiving face, and is arranged such that the LEDs are disposed at the bottom of the picture. Looking at the experiment results for Comparative Experiment 8, according to FIG. 29, a small amount of uneven brightness is visible in Working Example 14 compared to Working Example 15, with light sections and dark sections being aligned in the second direction. In Working Example 14, however, the uneven brightness is less visible than in Working Example 1. In this manner, utilizing a scatter-reflective type sheet as the reflective sheet 340 can suitably mitigate uneven brightness.

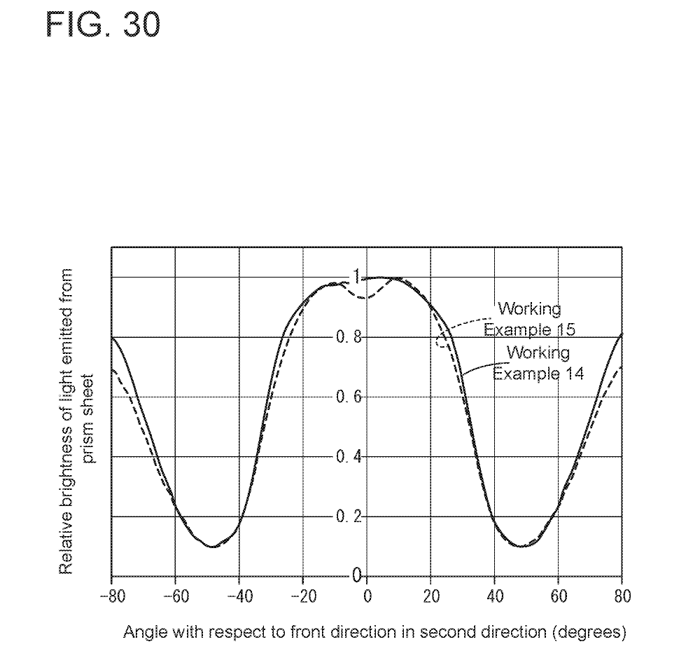

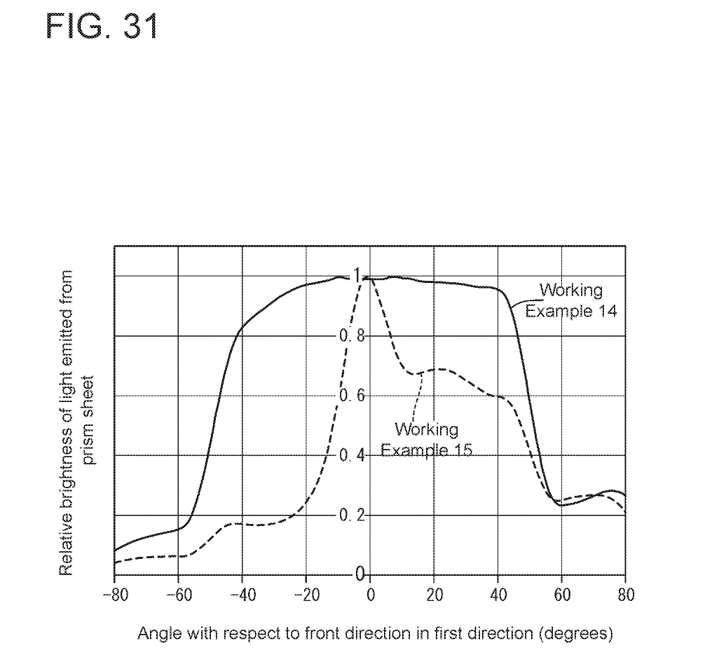

Next, Comparative Experiment 9 was carried out in order to determine whether or not there would be a difference in brightness distribution between a case in which the reflective sheet mirror-reflected light and a case in which the reflective sheet scatter-reflected light. As in Comparative Experiment 8, in Comparative Experiment 9, Working Example 14 was defined as a reflective sheet in which the reflective surface mirror-reflected light, and Working Example 15 was defined as the reflective sheet 340 in which the reflective surface 340a scatter-reflected light. The brightness distribution of the backlight devices that utilized these respective reflective sheets was measured, and these results are shown in FIGS. 30 and 31. The configuration of the backlight devices used in this experiment was identical to that described in Embodiment 1, other than the respective reflective sheets according to Working Examples 14 and 15. Furthermore, in Comparative Experiment 9, the brightness distribution in the second direction and the brightness distribution in the first direction were respectively measured for light emitted from the backlight devices that utilized the respective reflective sheets according to Working Examples 14 and 15. The measurement results for the second direction are shown in FIG. 30, and the measurement results for the first direction are shown in FIG. 31, respectively. Here, “light emitted from the backlight device” is light that is emitted from the prism sheet. In FIG. 30, the vertical axis represents the relative brightness (no units) of the light emitted from the prism sheet, and the horizontal axis represents the angle (in degrees) in the second direction with respect to the front surface direction. In FIG. 31, the vertical axis represents the relative brightness (no units) of the light emitted from the prism sheet, and the horizontal axis represents the angle (in degrees) in the first direction with respect to the front surface direction. The relative brightness indicated by the vertical axis in FIGS. 30 and 31 is a relative value in which, for the respective backlight devices that utilized the respective reflective sheets according to Working Examples 14 and 15, the brightness value in the front surface direction (an angle of 0°) is used as a baseline (1.0). In FIGS. 30 and 31, the graph indicated by a solid line represents Working Example 14, and the graph indicated by a dashed line represents Working Example 15, respectively.

Looking at the experiment results of Comparative Experiment 9, it can be seen that, according to FIG. 30, when the reflective sheet 340 according to Working Example 15 is utilized, light emitted from the prism sheet is diffused at a larger angle range, particularly near the front surface direction in the second direction, compared to a case in which the reflective sheet according to Working Example 14 is utilized. Specifically, compared to light emitted from the prism sheet when the reflective sheet according to Working Example 14 was utilized, light emitted from the prism sheet when the reflective sheet 340 according to Working Example 15 was utilized contained a small but relatively larger amount of light in which the propagation direction in the second direction with respect to the front surface direction fell within an angle range of 0° to±40°. Furthermore, according to FIG. 31, it can be seen that when the reflective sheet 340 according to Working Example 15 is utilized, light emitted from the prism sheet is diffused at a larger angle range, particularly near the front surface direction in the first direction, compared to a case in which the reflective sheet according to Working Example 14 is utilized. Specifically, compared to light emitted from the prism sheet when the reflective sheet according to Working Example 14 was utilized, light emitted from the prism sheet when the reflective sheet 340 according to Working Example 15 was utilized contained a relatively larger amount of light in which the propagation direction in the first direction with respect to the front surface direction fell within an angle range of 0° to±60°, with the peak of the brightness distribution (an angle range of0° to±40°) having a nearly flat shape. When the reflective sheet 340 according to Working Example 15 is utilized in this manner, light emitted from the prism sheet is diffused at a larger angle range, particularly near the front surface direction in the first direction and the second direction, respectively, compared to Working Example 14. As a result, uneven brightness in this emitted light is more suitably prevented. When the reflective sheet according to Working Example 14 is utilized, the front surface brightness in both the first direction and second direction is higher for light emitted from the prism sheet.

### Embodiment 5

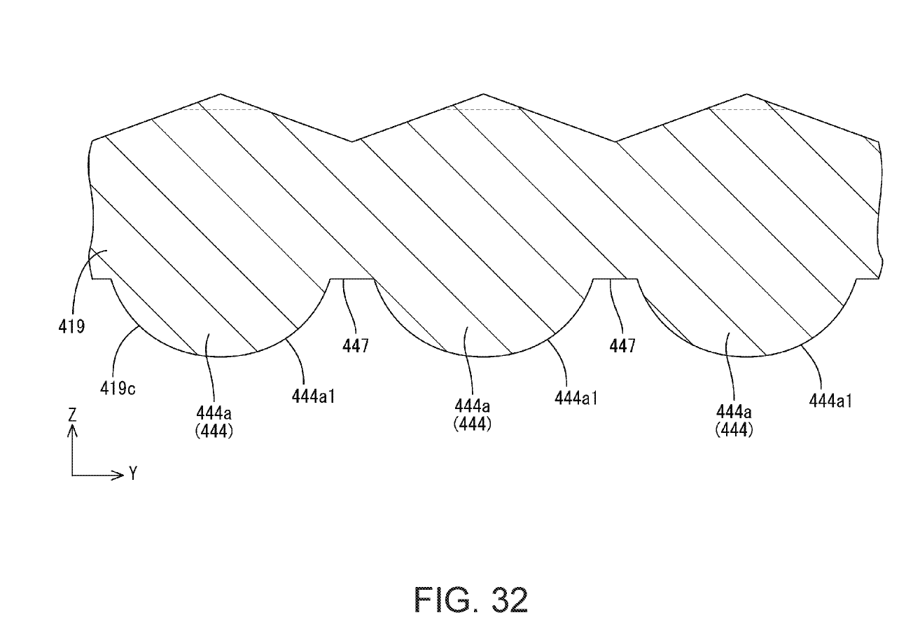

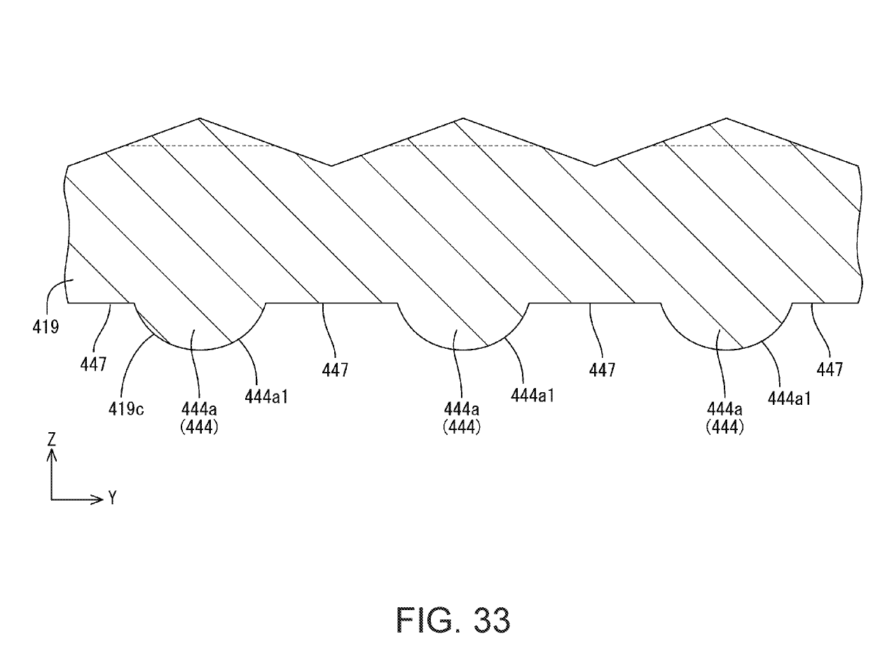

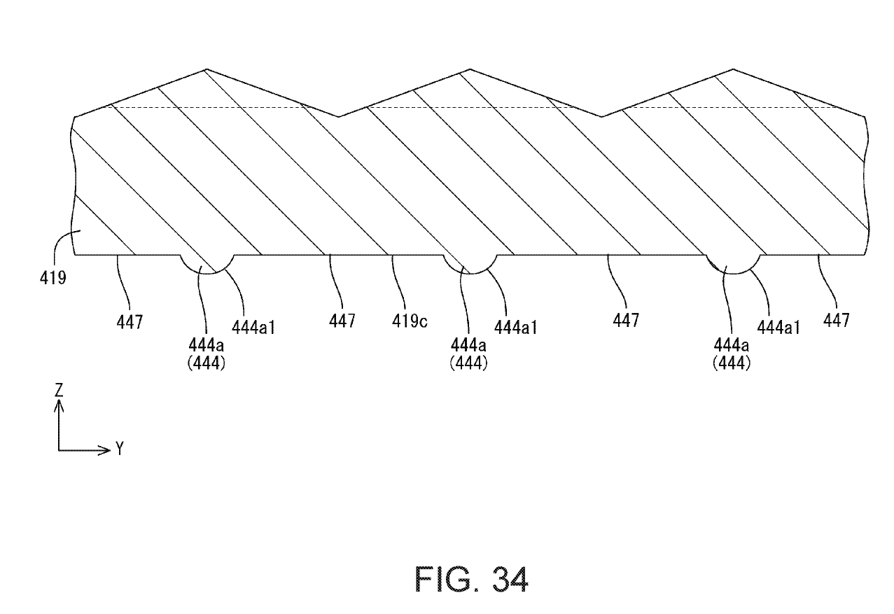

Embodiment 5 of the present invention will be described with reference to FIGS. 32 to 34. In Embodiment 5, an opposite surface convex lenticular lens unit 444 such as that in Embodiment 1 is provided in place of the opposite surface convex lenticular lens unit 46 described in Embodiment 3. Descriptions of structures, operations, and effects similar to those of Embodiments 1 and 3 will be omitted.

As shown in FIGS. 32 to 34, the opposite surface convex lenticular lens unit 444 according to the present embodiment is formed of an opposite surface convex cylindrical lens 444a, which extends along the first direction (X axis direction), being arranged in plurality along the second direction (Y axis direction) on an opposite surface 419c of a light guide plate 419. The opposite surface convex cylindrical lenses 444a are formed such that the width dimension (dimension in the second direction) thereof changes in accordance with the location in the first direction. Specifically, the width dimension, or in other words, the occupancy ratio in the second direction on the opposite surface 419c, of the opposite surface convex cylindrical lenses 444a gradually and continuously decreases moving away from the light-receiving face and approaching the opposite end face in the first direction, and conversely, gradually and continuously increases moving away from the opposite end face and approaching the light-receiving face in the first direction. The occupancy ratio of the opposite surface convex cylindrical lenses 444a is largest at the end (end location) of the light guide plate 419 near the light-receiving face in the first direction, and is approximately 70% to 90% at this location, for example. Conversely, the occupancy ratio of the opposite surface convex cylindrical lenses 444a is smallest at the end of the light guide plate 419 near the opposite end face at approximately 10% to 30%, for example. In the center of the light guide plate 419 in the first direction the occupancy ratio is approximately 50%, for example. Moreover, the opposite surface convex cylindrical lenses 444a are formed such that the height dimension (dimension in the third direction) thereof changes in accordance with the location in the first direction. Specifically, the height dimension, or in other words, the protruding height from the opposite surface 419c, of the opposite surface convex cylindrical lenses 444a gradually and continuously decreases moving away from the light-receiving face and approaching the opposite end face in the first direction, and conversely, gradually and continuously increases moving away from the opposite end face and approaching the light-receiving face in the first direction. In other words, the height dimension of the opposite surface convex cylindrical lenses 444a changes in the same manner as the width dimension in accordance with the location in the first direction. Therefore, the surface area (area of a curved surface 444a1) of the opposite surface convex cylindrical lenses 444a also changes in the same manner as the width dimension and the height dimension in accordance with the location in the first direction.

A flat section 447 that is flat along the first direction (X axis direction) and the second direction (Y axis direction) is formed in a region of the opposite surface 419c of the light guide plate 419 in which the opposite surface convex lenticular lens unit 444 (opposite surface convex cylindrical lenses 444a) is not formed. A plurality of flat sections 447 are disposed so as to be adjacent to the opposite surface convex cylindrical lenses 444a in the second direction. In other words, the opposite surface convex cylindrical lenses 444a and the flat sections 447 are disposed so as to be arranged alternately along the second direction on the opposite surface 419c of the light guide plate 419. Moreover, the flat sections 447 are formed such that the width dimension (dimension in the second direction) thereof changes in accordance with the location in the first direction. Specifically, the width dimension, or in other words, the occupancy ratio in the second direction on the opposite surface 419c, of the flat sections 447 gradually and continuously decreases approaching the light-receiving face and moving away from the opposite end face in the first direction, and conversely, gradually and continuously increases approaching the opposite end face and moving away from the light-receiving face in the first direction. The occupancy ratio of the flat sections 447 is smallest at the end (end location) of the light guide plate 419 near the light-receiving face in the first direction, and is approximately 10% to 30% at this location, for example. Conversely, the occupancy ratio of the flat sections 447 is largest at the end of the light guide plate 419 near the opposite end face in the first direction at approximately 70% to 90%, for example. In the center of the light guide plate 419 in the first direction, the occupancy ratio is approximately 50%, for example.

In this manner, the opposite surface convex lenticular lens unit 444 and the flat sections 447 are provided such that, for the occupancy ratio in the second direction on the opposite surface 419c of the light guide plate 419, the occupancy ratio of the opposite surface convex cylindrical lenses 444a is relatively high and the occupancy ratio of the flat sections 447 is relatively low near the light-receiving face in the first direction, while the occupancy ratio of opposite surface convex cylindrical lenses 444a is relatively low and the occupancy ratio of the flat sections 447 is relatively high on the side furthest from the light-receiving face in the first direction. Thus, near the light-receiving face in the first direction, where there is concern that uneven brightness may occur as a result of the LEDs (not shown), uneven brightness is unlikely to occur in the second direction for light emitted from the prism sheet (not shown) as a result of the opposite surface convex cylindrical lenses 444a, which have a relatively high occupancy ratio near the light-receiving face. Meanwhile, on the side furthest from the light-receiving face in the first direction, where uneven brightness due to the LEDs is fundamentally unlikely to occur, the brightness of light emitted from the prism sheet is higher due to the flat sections 447, which have a relatively high occupancy ratio on the side furthest from the light-receiving face. As a result, uneven brightness is mitigated and brightness is increased for light emitted from the prism sheet.

### Embodiment 6

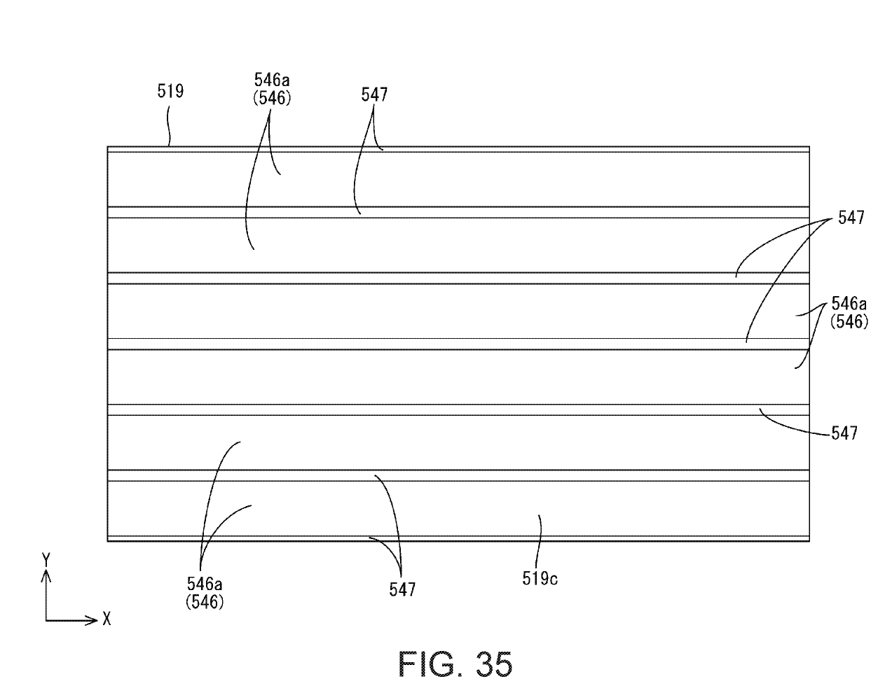

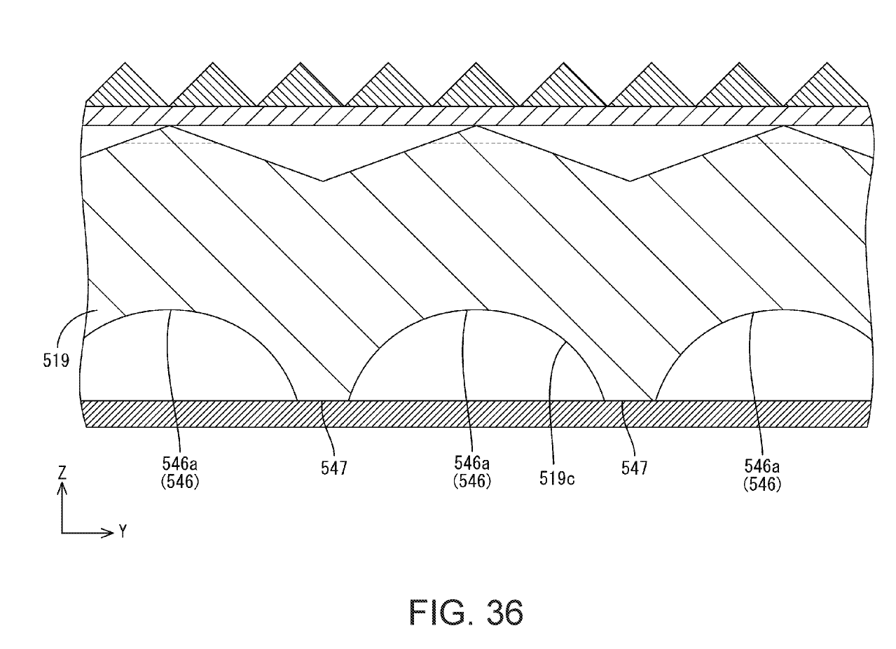

Embodiment 6 of the present invention will be described using FIGS. 35 and 36. In Embodiment 6, an opposite surface concave lenticular lens unit 546 such as that in Embodiment 3 is provided in place of the opposite surface convex lenticular lens unit 44 described in Embodiment 1. Descriptions of structures, operations, and effects similar to those of Embodiments 1 and 3 will be omitted.

As shown in FIGS. 35 and 36, the opposite surface concave lenticular lens unit 546 according to the present embodiment is formed of an opposite surface concave cylindrical lens 546a, which extends along the first direction (X axis direction), being arranged in plurality along the second direction (Y axis direction) on an opposite surface 519c of a light guide plate 519. The width dimension (the dimension in the second direction, the occupancy ratio in the second direction) of the opposite surface concave cylindrical lenses 546a is fixed along the entire length in the first direction. For the plurality of opposite surface concave cylindrical lenses 546a arranged in a row along the second direction, the tangential angles, the width dimensions of the respective bottom surfaces, and the height dimensions are all substantially identical, and the arrangement interval between adjacent opposite surface concave cylindrical lenses 546a is substantially fixed, with equal gaps being provided therebetween. Flat sections 547 that are flat along the first direction (X axis direction) and the second direction (Y axis direction) are formed in regions of the opposite surface 519c of the light guide plate 519 in which the opposite surface concave lenticular lens unit 546 (opposite surface concave cylindrical lenses 546a) is not formed. The width dimension (the dimension in the second direction, the occupancy ratio in the second direction) of the flat section 547 is fixed along the entire length in the first direction, and is smaller than the width dimension of the opposite surface concave cylindrical lenses 546a.

### Other Embodiments

The present invention is not limited to the embodiments shown in the drawings and described above, and the following embodiments are also included in the technical scope of the present invention, for example.

(1) In the respective above-described embodiments, a plurality of reflective units forming an exiting-light reflecting part were arranged in the first direction with equal gaps therebetween (arranged at an even pitch). The present invention also includes a configuration in which a plurality of reflective units are arranged at an uneven pitch in the first direction, however. In such a case, in order to prevent uneven brightness in the first direction, it is preferable to set the arrangement interval between adjacent reflective units so as to gradually narrow moving from the light-receiving face of the light guide plate toward the opposite end face side of the light guide plate in the first direction.

(2) It is possible in the configuration described above in (1) (a configuration in which a plurality of reflective units are arranged at an uneven pitch) to fix the height dimension of the plurality of reflective units aligned along the first direction.

(3) In the respective above-described embodiments, the height dimension of the reflective units forming the exiting-light reflecting part was smaller than the height dimension of the light-exiting surface unit prisms forming the light-exiting surface prism unit. However, it is also possible to set the height dimension of the reflective units to be approximately the same as the height dimension of the light-exiting surface unit prisms, for example. Furthermore, it is also possible to make the height dimension of the reflective units larger than the height dimension of the light-exiting surface unit prisms. In such a case, the reflective units are configured so as to continuously extend along the entire length of the light guide plate in the second direction.

(4) It is possible to appropriately modify the specific cross-sectional shape of the reflective units forming the exiting-light reflecting part so as to be different from that in the respective above-mentioned embodiments. It is possible to make the cross-sectional shape of the reflective units to be a right triangle or an isosceles triangle, for example. In addition, it is possible to appropriately modify the respective specific angles at the respective tops of the reflective units having a triangular cross-sectional shape. Moreover, it is possible to appropriately modify the specific values for the height dimension, width dimension, arrangement interval in the first direction, and the like for the reflective units forming the exiting-light reflecting part.

(5) In the respective above-described embodiments, the cross-sectional shape of the light-exiting surface unit prisms forming the light-exiting surface prism unit was that of an isosceles triangle. However, it is possible to have the cross-sectional shape of the light-exiting surface unit prisms be that of a scalene triangle, right triangle, or the like in which the lengths of all of the sides are different, for example.

(6) In Embodiment 2, the cross-sectional shape of the opposite surface unit prisms forming the opposite surface prism unit was that of an isosceles triangle. However, it is possible to have the cross-sectional shape of the opposite surface unit prisms be that of a scalene triangle, right triangle, or the like in which the lengths of all of the sides are different, for example.

(7) It is possible to appropriately modify the specific values for the vertex angle, height dimension, width dimension, arrangement interval in the second direction, and the like for the light-exiting surface unit prisms forming the light-exiting surface prism unit so as to be different from the respective above-described embodiments. Similarly, it is possible to appropriately modify the specific values for the vertex angle, height dimension, width dimension, arrangement interval in the second direction, and the like for the light-exiting surface unit prisms forming the light-exiting surface prism unit described in Embodiment 2. Similarly, it is possible to appropriately modify the specific values for the vertex angle, height dimension, width dimension, arrangement interval in the second direction, and the like for the light-emission surface unit prisms forming the prism sheet.

(6) It is possible to appropriately modify the specific values for the tangential angle, height dimension, width dimension, arrangement interval in the second direction, and the like for the opposite surface convex cylindrical lenses forming the opposite surface convex lenticular lens unit or the opposite surface concave cylindrical lenses forming the opposite surface concave lenticular lens unit so as to be different from the respective above-mentioned embodiments (excluding Embodiment 2).

(7) In the respective above-described embodiments, the light-exiting surface prism unit provided on the light-exiting surface of the light guide plate was formed of light-exiting surface unit prisms that had a triangular cross-sectional shape. However, in place of such a light-exiting surface prism unit, a light-exiting surface convex lenticular lens unit formed of a plurality of light-exiting surface convex cylindrical lenses that have a substantially semicircular column shape in which the axial direction thereof matches the first direction (X axis direction) may be provided on the light-exiting surface of the light guide plate as a “light-exiting surface anisotropic light-condensing part.” Furthermore, a light-exiting surface concave lenticular lens unit formed of a plurality of light-exiting surface concave cylindrical lenses that have a groove-like shape in which the axial direction thereof corresponds to the first direction may be provided on the light-exiting surface of the light guide plate as a “light-exiting surface anisotropic light-condensing part.”

(8) In the respective above-described embodiments, the exiting-light reflecting part and the light-exiting surface prism unit were integrally provided on the light-exiting surface of the light guide plate. However, it is also possible to use a configuration in which the exiting-light reflecting part and the light-exiting surface prism unit are provided separately from the light guide plate, and the separate exiting-light reflecting part and light-exiting surface prism unit are disposed so as to overlap the light-exiting surface of the light guide plate from above. In such a case, it is preferable that the refractive index of the material forming the separate exiting-light reflecting part and light-exiting surface prism unit be the same as the refractive index of the material forming the light guide plate. Furthermore, it is preferable that the material forming the separate exiting-light reflecting part and light-exiting surface prism unit be the same as the material forming the light guide plate.

(9) In the respective above-described embodiments, an opposite surface convex lenticular lens unit, opposite surface concave lenticular lens unit, or opposite surface prism unit was integrally provided on the light-exiting surface of the light guide plate. However, it is also possible to use a configuration in which the opposite surface convex lenticular lens unit, opposite surface concave lenticular lens unit, or opposite surface prism unit is provided separately from the light guide plate, and the separate opposite surface convex lenticular lens unit, opposite surface concave lenticular lens unit, or opposite surface prism unit is disposed so as to overlap the opposite surface of the light guide plate from below. In such a case, it is preferable that the refractive index of the material forming the separate opposite surface convex lenticular lens unit, opposite surface concave lenticular lens unit, or opposite surface prism unit be the same as the refractive index of the material forming the light guide plate. Furthermore, it is preferable that the material forming the separate opposite surface convex lenticular lens unit, opposite surface concave lenticular lens unit, or opposite surface prism unit be the same as the material forming the light guide plate.

(10) In the above-described Embodiments 3 and 5, flat sections and opposite surface concave cylindrical lenses or opposite surface convex cylindrical lenses were aligned alternately in a repeating manner along the second direction. However, it is also possible to use a configuration in which a plurality of opposite surface concave cylindrical lenses or opposite surface convex cylindrical lenses are continuously aligned along the second direction, and flat sections are sandwiched between a plurality of opposite surface concave cylindrical lens groups or opposite surface concave cylindrical lens groups that are adjacent in the second direction.

(11) It is possible to appropriately modify the specific values of the occupancy ratio in the second direction for the opposite surface concave cylindrical lenses or opposite surface convex cylindrical lenses on the opposite surface of the light guide plate to values other than those in the above-described Embodiments 3 and 5. It is possible to set the occupancy ratio at the light-receiving face end in the first direction to approximately 100%, and set the occupancy ratio at the opposite end face end in the first direction to approximately 0%, for example. Alternatively, it is possible to set the occupancy ratio at the light-receiving face end in the first direction to between 90% and 100% or between 50% and 70%, and set the occupancy ratio at the opposite end face end in the first direction to between 0% and 10% or between 30% and 50%. In addition, for the occupancy ratio in the second direction at the center in the first direction on the opposite surface of the light guide plate, the occupancy ratio of the opposite surface concave cylindrical lenses or opposite surface convex cylindrical lenses and the occupancy ratio of the flat sections may be different from each other.

(12) It is possible to appropriately modify the specific values of the occupancy ratio in the second direction of the flat sections on the opposite surface of the light guide plate to values other than those in the above-described Embodiments 3 and 5. It is possible to set the occupancy ratio at the light-receiving face end in the first direction to approximately 0%, and set the occupancy ratio at the opposite end face end in the first direction to approximately 100%, for example. Alternatively, it is possible to set the occupancy ratio at the light-receiving face end in the first direction to between 0% and 10% or between 30% and 50%, and set the occupancy ratio at the opposite end face end in the first direction to between 90% and 100% or between 50% and 70%.

(13) In the above-described Embodiments 3, 5, and 6, flat sections were provided on the opposite surface of the light guide plate. However, it is also possible to provide flat sections on the light-exiting surface of the light guide plate in the configurations described in the respective embodiments. In such a case, the flat sections may be disposed so as to be interposed between a plurality of light-exiting surface unit prisms that form a light-exiting surface prism unit and are aligned along the second direction.

(14) In the configurations described above in Embodiments 1 and 2, it is also possible to provide flat sections on the opposite surface of the light guide plate in a similar manner as in Embodiments 3, 5, and 6. In such a case, the flat sections may be disposed so as to be interposed between a plurality of opposite surface convex cylindrical lenses or opposite surface unit prisms that form an opposite surface convex lenticular lens unit or opposite surface prism unit and that are aligned along the second direction.

(15) It is also possible to apply the reflective sheet described in Embodiment 4 in the backlight devices described in Embodiments 2, 3, 5, and 6.

(16) As a modification example of Embodiment 6, an opposite surface convex lenticular lens unit similar to that of Embodiment 1 may be provided on the opposite surface of the light guide plate.

(17) As a modification example of Embodiment 6, the flat sections provided on the opposite surface of the light guide plate may be removed, and, as in Embodiment 1, only an opposite surface concave lenticular lens unit may be provided on the opposite surface.

(18) In the respective above-described embodiments, it is also possible to omit the light-exiting surface prism unit. Similarly, it is also possible to omit the opposite surface convex lenticular lens unit, opposite surface concave lenticular lens unit, or opposite surface prism unit. Furthermore, it is also possible to omit the prism sheet.

(19) In the respective above-described embodiments, a configuration was used in which the optical sheet was formed of only one prism sheet, but it is also possible to add another type of optical sheet (a diffusion sheet, a reflective polarizing sheet, or the like, for example). Furthermore, it is also possible to use a plurality of prism sheets.

(20) In the respective above-described embodiments, a configuration was used in which one LED substrate was disposed along the light-receiving face of the light guide plate. However, the present invention also includes a configuration in which two or more LED substrates are arranged along the light-receiving face of the light guide plate.

(21) In the respective above-described embodiments, one short-side end face of the light guide plate was a light-receiving face and the LED substrate was disposed so as to face the light-receiving face. However, the present invention also includes a configuration in which one long-side end face of the light guide plate is the light-receiving face, and the LED substrate is disposed so as to face this light-receiving face. In such a case, the extension direction of the light-emission side unit prisms, the light-exiting surface unit prisms, and the opposite surface convex lenticular lens unit (opposite surface concave lenticular lens unit, opposite surface prism unit) may be caused to correspond to the short-side direction of the light guide plate, and the width direction (alignment direction) of the light-emission side unit prisms, the light-exiting surface unit prisms, and the opposite surface convex lenticular lens unit (opposite surface concave lenticular lens unit, opposite surface prism unit) may be caused to correspond to the long-side direction of the light guide plate.

(22) In addition to the configuration in (21), the present invention also includes a configuration in which a pair short-side end faces of the light guide plate are respectively light-receiving faces and a pair of LED substrates are respectively disposed so as to face the respective light-receiving faces, and a configuration in which a pair of long-side end faces of the light guide plate are respectively light-receiving faces and a pair of LED substrates are respectively disposed so as to face the respective light-receiving faces.

(23) In the respective above-described embodiments, the light guide plate had a rectangular shape, but the light guide plate may also have a square shape. In addition, the light guide plate does not necessarily need to have a perfect rectangular shape, and may be configured such that a portion of the peripheral edges has been removed.

(24) In the respective above-described embodiments, top-view type LEDs were used. However, the present invention can also be applied to a configuration that utilizes side-view type LEDs in which a side face adjacent to the mounting surface for the LED substrate is a light-emitting surface.

(25) In the respective above-described embodiments, a configuration in which the touch panel pattern on the touch panel was a projection-type capacitive touch panel pattern was used as an example. Alternatively, the present invention can also be applied to a surface capacitive type, a resistive film type, or an electromagnetic induction type touch panel pattern, or the like.

(26) A configuration in which a parallax barrier panel (a switching liquid crystal panel) that has a parallax barrier pattern for displaying three dimensional images (3D images) to a viewer by separating, via parallax, images to be displayed on the display surface of the liquid crystal panel may be used instead of the touch panel described in the respective above-mentioned embodiments, for example. In addition, it is also possible to combine the above-described parallax barrier panel and touch panel.

(27) It is also possible to form a touch panel pattern on the parallax barrier panel described in (26) so as to have the parallax barrier panel double as a touch panel.

(28) In the respective above-described embodiments, an example was used in which the screen size of the liquid crystal panel utilized in the liquid crystal display device was approximately 5 inches. The specific screen size of the liquid crystal panel may be appropriately modified to a value other than 5 inches, however.

(29) In the respective above-described embodiments, an example was used in which the colored portions of the color filter in the liquid crystal panel were the three colors R, G, and B, but it is also possible for there to be four or more colored portions.

(30) In the respective above-described embodiments, LEDs were used as the light source, but another type of light source such as an organic EL element may also be used.

(31) In the respective above-described embodiments, the frame was made of metal. The frame may also be made of a synthetic resin, however.

(32) In the respective above-described embodiments, the cover panel was made of tempered glass that had been chemically strengthened. However, tempered glass that has been strengthened by air cooling (physical strengthening) may also be used.

(33) In the respective above-described embodiments, the cover panel was made of tempered glass. However, an ordinary glass material that has not been tempered (non-tempered glass) or a synthetic resin material may also be used.

(34) In the respective above-described embodiments, a cover panel was used in the liquid crystal display device. The cover panel may be omitted, however. Similarly, it is also possible to omit the touch panel. In addition, other respective constituting members of the liquid crystal display device may be appropriately omitted as necessary.

(35) In the respective above-described embodiments, a TFT was used as a switching element in the liquid crystal display device. However, the present invention can also be applied to a liquid crystal display device that utilizes a switching element other than a TFT (such as a thin film diode [TFD]), and can also be applied to a liquid crystal display device that performs black-white display in addition to a liquid crystal display device that performs color display.

### DESCRIPTION OF REFERENCE CHARACTERS

10 liquid crystal display device (display device)

11 liquid crystal panel (display panel)

12 backlight device (illumination device)

17 LED (light source)

19, 119, 219, 419, 519 light guide plate

19a, 119a, 219a light-exiting surface

19b, 219b light-receiving face

19c, 119c, 219c, 419c opposite surface

40, 140, 240, 340 reflective sheet (reflective member)

40a, 240a, 340a reflective surface

41, 141, 241 exiting-light reflecting part

41a reflective unit

41aS separated reflective unit

42, 142, 242 prism sheet (light-emission side anisotropic light-condensing part)

42a, 142a, 242a light-emission side unit prism (light-emission side unit condensing member)

43, 143, 243 light-exiting surface prism unit (light-exiting surface anisotropic light-condensing part)

43a, 143a, 243a light-exiting surface unit prism (light-exiting surface light-condensing unit)

43a2 top

44, 444 opposite surface convex lenticular lens unit (opposite surface anisotropic light-condensing part)

44a, 444a opposite surface convex cylindrical lens (opposite surface light-condensing unit, opposite surface cylindrical lens)

45 opposite surface prism unit (opposite surface anisotropic light-condensing part)

45a opposite surface unit prism (opposite surface light-condensing unit)

46, 546 opposite surface concave lenticular lens unit (opposite surface anisotropic light-condensing part)

46a, 546a opposite surface concave cylindrical lens (opposite surface light-condensing unit, opposite surface cylindrical lens)

47, 447, 547 flat section

θv2 vertex angle of light-exiting surface unit prism 43a

θv3 vertex angle of opposite surface unit prism 45a

C gap

1. An illumination device, comprising:
a light source;
a light guide plate having a rectangular plate-like shape, at least one of a pair of end faces that are among peripheral end faces of the light guide plate and that are on opposite sides of the light guide plate being a light-receiving face that receives light emitted from said light source, one surface of the light guide plate being a light-exiting surface that emits light, and another surface of the light guide plate being an opposite surface; and
a reflective member including a reflective surface that is disposed so as to face the opposite surface of the light guide plate and that reflects light,
wherein the light guide plate has an exiting-light reflecting part for facilitating emission of light from the light-exiting surface by reflecting light that propagates within the light guide plate, the exiting-light reflecting part being disposed on a side of the light-exiting surface of the light guide plate and being formed of reflective units arranged in a plurality with gaps therebetween along a first direction that is along a pair of end faces that are among the peripheral end faces of the light guide plate, are on opposite sides of the light guide plate, and that do not include the light-receiving face, the reflective units extending along a second direction along the pair of end faces that are among the peripheral end faces of the light guide plate and that include the light-receiving face.

2. The illumination device according to claim 1, wherein the light guide plate has an opposite surface anisotropic light-condensing part that is disposed on a side of the opposite surface of the light guide plate and is formed of opposite surface light-condensing parts that extend along the first direction and are arranged in a plurality along the second direction.

3. The illumination device according to claim 1, wherein the light guide plate further has a light-exiting surface anisotropic light-condensing part that is disposed on the side of the light-exiting surface of the light guide plate and is formed of light-exiting surface light-condensing parts that extend along the first direction and are arranged in a plurality along the second direction.

4. The illumination device according to claim 3, wherein each of the reflective units of the exiting-light reflecting part is formed of a plurality of separate reflective unit segments that are arranged intermittently along the second direction with gaps therebetween.

5. The illumination device according to claim 4, wherein each of the reflective units of the exiting-light reflecting part is formed by cutouts formed along the second direction by partially removing top parts of the light-exiting surface light-condensing parts forming the light-exiting surface anisotropic light-condensing part.

6. The illumination device according to claim 1,
wherein the light guide plate has:
a light-exiting surface anisotropic light-condensing part that is disposed on the side of the light-exiting surface of the light guide plate and is formed of light-exiting surface light-condensing parts that extend along the first direction and are arranged in a plurality along the second direction; and
an opposite surface anisotropic light-condensing part that is disposed on a side of the opposite surface of the light guide plate and is formed of opposite surface light-condensing parts that extend along the first direction and are arranged in a plurality along the second direction, and
wherein the opposite surface light-condensing parts of the opposite surface anisotropic light-condensing part are opposite surface cylindrical lenses in which a surface thereof has an arc-like shape, while the light-exiting surface light-condensing parts of the light-exiting surface anisotropic light-condensing part are light-exiting surface unit prisms that have a substantially triangular cross-sectional shape and in which a vertex angle thereof is between 100° and 150°.

7. The illumination device according to claim 6, wherein the vertex angle of the light-exiting surface light-condensing parts of the light-exiting surface anisotropic light-condensing part is between 135° and 150°.

8. The illumination device according to claim 6, wherein the vertex angle of the light-exiting surface light-condensing parts of the light-exiting surface anisotropic light-condensing part is between 140° and 150°.

9. The illumination device according to claim 1,
wherein the light guide plate has:
a light-exiting surface anisotropic light-condensing part that is disposed on the side of the light-exiting surface of the light guide plate and is formed of a light-exiting surface light-condensing parts that extend along the first direction and are arranged in a plurality along the second direction; and
an opposite surface anisotropic light-condensing part that is disposed on a side of the opposite surface of the light guide plate and is formed of opposite surface light-condensing parts that extend along the first direction and are arranged in plurality along the second direction, and
wherein the light-exiting surface light-condensing parts and the opposite surface light-condensing parts of the light-exiting surface anisotropic light-condensing part and the opposite surface anisotropic light-condensing part, respectively, are light-exiting surface unit prisms and opposite surface unit prisms, respectively, that have a substantially triangular cross-sectional shape and in which vertex angles thereof are between 100° and 150°.

10. The illumination device according to claim 9, wherein the vertex angle of the light-exiting surface unit prisms of the light-exiting surface anisotropic light-condensing part is relatively larger than the vertex angle of the opposite surface unit prisms, an angle range of the vertex angle of the light-exiting surface unit prisms being 130° to 150° while the vertex angle of the opposite surface unit prisms is between 100° and 140°.

11. The illumination device according to claim 10, wherein, in the opposite surface light-condensing parts, the vertex angle of the opposite surface unit prisms is between 110° and 130°.

12. The illumination device according to claim 1, further comprising a light-emission side anisotropic light-condensing sheet that is disposed on a light-emission side of the light guide plate and is formed of a light-emission side light-condensing parts that extend along the first direction and are arranged in plurality along the second direction.

13. The illumination device according to claim 1,
wherein the light guide plate has:
a light-exiting surface anisotropic light-condensing part that is disposed on the side of the light-exiting surface of the light guide plate and is formed of light-exiting surface unit prisms that extend along the first direction and are arranged in a plurality along the second direction;
an opposite surface anisotropic light-condensing part that is disposed on a side of the opposite surface of the light guide plate and is formed of opposite surface cylindrical lenses that extend along the first direction and are arranged in a plurality along the second direction; and
flat sections that are disposed on the side of the opposite surface of the light guide plate so as to be interposed between the opposite surface cylindrical lenses that are adjacent in the second direction, said flat sections being flat along the first direction and the second direction,
wherein the illumination device further comprises a light-emission side anisotropic light-condensing sheet that is disposed on a light-emission side of the light guide plate and is formed of a light-emission side light-condensing parts that extend along the first direction and are arranged in a plurality along the second direction, and
wherein the opposite surface anisotropic light-condensing part and the flat sections are provided such that, with respect to occupancy ratios as defined along the second direction on the opposite surface, the occupancy ratio of the opposite surface cylindrical lenses is relatively high and the occupancy ratio of the flat sections is relatively low on a side of the light guide plate near the light-receiving face in the first direction, while the occupancy ratio of the opposite surface light-condensing parts is relatively low and the occupancy ratio of the flat sections is relatively high on a side of the light guide plate furthest from the light-receiving face in the first direction.

14. The illumination device according to claim 1, wherein the reflective member is configured such that the reflective surface reflects and diffuses light.

15. A display device, comprising:
the illumination device according to claim 1; and
a display panel that performs display by utilizing light from said illumination device.
